(19) United States
(12) Patent Application Publication
(10) Pub. No.: US 2026/0123604 A1
(43) Pub. Date: May 7, 2026

(54) MODULAR SMART PET FEEDER

(71) Applicant: Piotr Westfalewicz, Austin, TX (US)

(72) Inventor: Piotr Westfalewicz, Austin, TX (US)

(21) Appl. No.: 18/940,750

(22) Filed: Nov. 7, 2024

(51) Int. Cl. A01K 5/02; A01K 11/00

(52) U.S. Cl. CPC A01K 5/0291; A01K 5/0225; A01K 5/025; A01K 5/0283; A01K 11/006

(57) ABSTRACT

Disclosed herein are various embodiments relating generally to an apparatus for automatically feeding pets, which may be remotely controlled or monitored, which provides predictive maintenance capability for critical components of the apparatus so that failures that could deprive a pet from food can be avoided, and which includes optional “plug-and-play” connectable modules that provide additional functionality and relay important metrics concerning a pet's physical wellbeing or the condition or status of the various modules, as well as provide entertainment for the pet in a stylish manner.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

### 1. Field of the Invention

The present invention is in the technical field of animal feeders. More particularly, the preferred embodiments of the present invention relate generally to pet feeders. More particularly, the preferred embodiments of the present invention relate generally to automatic pet feeders. More particularly, the preferred embodiments of the present invention relate generally to automatic pet feeders, which are modular. More particularly, the preferred embodiments of the present invention relate generally to modular automatic pet feeders with multiple optional connectable modules for custom configurations. More particularly, the preferred embodiments of the present invention relate generally to smart modular automatic pet feeders, which use computer processors to coordinate and manage multiple optional connectable modules. More particularly, the preferred embodiments of the present invention relate generally to smart modular automatic pet feeders, which use predictive maintenance systems in order to prevent failures and to ensure continuous pet feeding while a pet owner is away and to improve the health of the pet.

### 2. Description of the Related Art

Pet owners desire maintaining the health of their pets, including ensuring that their pets eat appropriate portions at regular intervals. Pet owners who travel or are away from their pets during feeding times can impact a pet's feeding schedule. Providing a pet with additional food while the owner is away for longer periods of time may technically sustain the pet; however, such strategies can lead to binge eating that may affect the pet's health. In addition, owners of multiple pets encounter problems when each pet has different dietary restrictions. Some pets may overeat, while other pets may undereat or be finicky and require additional stimulus to encourage eating. There is a need to provide an automatic pet feeder, which allows for customizable configurations that suit the particular needs of pets and the desires and budgets of pet owners, which allows for managed pet feeding to improve the health of one or more pets, and which predicts failures before they occur so that the failure may be prevented in order to provide continual feeding while a pet owner is away.

The broad concept of pet feeders is generally known. However, most of these pet feeders are not automatic, modular, or smart.

Automatic pet feeders that store pet food are known as well. However, these automatic pet feeders are not modular or customizable and do not use predictive maintenance systems to prevent failures.

Additionally, pet feeders that detect food levels are known; however, these pet feeders are not modular or customizable and do not use predictive maintenance systems to prevent failures.

In addition, automatic pet feeders with openable lids are known; however, these automatic pet feeders are not modular or customizable and do not use predictive maintenance systems to prevent failures.

Also, automatic pet feeders with programable schedules are known. However, these automatic pet feeders are not modular or customizable so that other features may be added and do not use predictive maintenance systems to prevent failures.

Furthermore, pet feeders with a pet detection system, such as an RFID system, are known; however, these pet feeders these automatic pet feeders are not modular or customizable and do not use predictive maintenance systems to prevent failures.

Automatic pet feeder with food delivery systems, such as an auger, propellor, or conveyor belt, are known as well. However, these automatic pet feeders do not offer optional modular food delivery systems that allows users to choose different types of food delivery systems to use with a feeder. In addition, these automatic pet feeders do not use predictive maintenance systems to prevent failures.

Additionally, pet feeders with LED lights are known; however, these pet feeders usually use LED lights as indicators for human operators, and not pets, and do not provide animated lights that simulate spinning and increase the simulated spinning speed as a feeding time approaches in order to encourage a pet to eat. In addition, these automatic pet feeders do not use predictive maintenance systems to prevent failures.

Also, pet feeders with weight scales and pet feeders that weigh pets are known; however, these pet feeders do not have modules that fit together in a compact and useful manner or are customizable and connectable to other optional modules. In addition, these pet feeders do not use predictive maintenance systems to prevent failures.

Pet feeders that have internet connectivity are also known; however, these pet feeders do not have modules that fit together in a compact and useful manner or are customizable and connectable to other optional modules. In addition, these pet feeders do not use predictive maintenance systems to prevent failures.

Additionally, pet feeders that use cameras are known; however; however, these pet feeders these pet feeders are not modular or customizable and do not use predictive maintenance systems to prevent failures.

Further, pet feeders that order pet food are known these pet feeders do not have modules that fit together in a compact and useful manner or are customizable and connectable to other optional modules. In addition, these pet feeders do not use predictive maintenance systems to predict when to order food, including taking into account procurement and delivery time or to prevent failures.

Moreover, modular pet feeders are known. However, these modular pet feeders do not fit together in a compact and useful manner or provide predictive maintenance systems, which may prevent failures.

While automatic pet feeders and modular pet feeders exist, these feeders do not perform predictive maintenance, and are susceptible to failing, which could cause a pet to starve if the owner is away for an extended period during a failure. Thus there is a need to provide a pet feeder, which can automatically feed one or more pets optimal portions appropriate for each pet in order to maintain their health based on contemporarily-measured metrics of each pet, such as their weight or feeding frequency, and allows or restricts access to food as needed, which provides a remote monitoring for reporting measured metrics or ordering food or parts, which is modularly expandable to suit the optional needs of different pet owners and/or the feeding habits of different pets, which is customizable and provides personalized decorations or ornamentation, and which can perform predictive maintenance to ensure continual functionality of various modules to ensure that feeding is always available when a pet owner is absent, while also providing a stylish presentation with customizable personalization and entertainment that encourages a pet to eat.

### SUMMARY OF THE INVENTION

The Modular Smart Pet Feeder invention was developed in part to provide a modular, customizable, automatic apparatus for feeding pets in manner that improves their health by measuring various metrics and controlling the pet's feeding. In broad embodiment, the Modular Smart Pet Feeder invention relates to an apparatus for automatically feeding pets, which may be remotely controlled or monitored through a website or app, or the like, which provides predictive maintenance capability for critical components of the apparatus so that failures that could deprive a pet from food can be avoided, and which includes optional “plug-and-play” connectable modules that provide additional functionality and relay important metrics concerning a pet's physical wellbeing or the condition or status of the various modules, as well as provide entertainment for the pet in a stylish manner.

In one embodiment, the Modular Smart Pet Feeder invention is an automated modular apparatus for storing and dispensing pet food, said apparatus comprising: a memory stored in non-transitory computer-readable medium, said memory comprising: metric data, said metric data comprising information entered into said memory by a user and/or measured by a connectable module connected to said apparatus and entered into said memory; and module data, said module data comprising the status of said connectable modules connected to said apparatus; a main controller, said main controller being capable of accessing and interacting with said memory, including sending and receiving said metric data and said module data, and comprising: one or more processors; a connector system, said connector system being controllable by and capable of communicating with said main controller, including sending and receiving said metric data and said module data, said connector system being capable of connecting said connectable modules to said controller; a timing system, said timing system being controllable by and capable of communicating with said main controller, including sending and receiving said metric data and said module data and providing time data to said main controller as said metric data; and said connectable modules, said connectable modules being capable of connecting to said connector system in various combinations, or not at all; said connectable modules comprising a module controller, which is controllable by and capable of communicating with said main controller, including sending and receiving said metric data and said module data; and comprising: a pet food storage compartment, said pet food storage compartment comprising: a bin, said bin being capable of storing said pet food; and an access door, said access door being capable of accessing said bin in order to fill said bin with said pet food; a food dispensing mechanism, said food dispensing mechanism being controllable by and capable of communicating with said main controller, including sending and receiving said metric data and said module data, and capable of dispensing said pet food from said pet food storage compartment on demand, by a programmable schedule using said timing system, or based on said metric data; wherein said metric data is used by said apparatus to recommend or control feeding times and amounts or to restrict feeding for a pet in order to improve its health. Metric data and module data may also be considered to be system data in other embodiments.

In the most preferred embodiment, the Modular Smart Pet Feeder invention is an automated modular apparatus for storing and dispensing pet food, said apparatus comprising: a memory stored in non-transitory computer-readable medium, said memory comprising: system data, said system data comprising one or more of the following: user information entered into said memory by a user, controller information measured by a main controller, connector information measured by a connector system, module information measured by a connectable module, and the status of said connectable modules connected to said apparatus; said main controller, said main controller being capable of accessing and interacting with said memory, including sending and receiving said system data, and comprising: one or more processors; said connector system, said connector system being controllable by and optionally capable of communicating with said main controller, including sending and receiving said system data, said connector system being capable of connecting said connectable modules to said controller; and said connectable modules, said connectable modules being capable of connecting to said connector system in various combinations, or not at all; said connectable modules optionally comprising a module controller, which is controllable by and capable of communicating with said main controller, including sending and receiving said system data; and comprising: a pet food storage compartment, said pet food storage compartment comprising: a bin, said bin being capable of storing said pet food; and an access door, said access door being capable of accessing said bin in order to fill said bin with said pet food; a food dispensing mechanism, said food dispensing mechanism being controllable by and capable of communicating with said main controller, including sending and receiving said system data, and capable of dispensing said pet food from said pet food storage compartment on demand, by a programmable schedule, or based on said system data; wherein said system data is used by said apparatus to recommend or control feeding times and amounts or to restrict feeding for a pet.

In other preferred embodiments, the present invention has an integrated pet food storage compartment and an integrated food dispensing mechanism. In this embodiment, the Modular Smart Pet Feeder invention is an automated modular apparatus for storing and dispensing pet food, said apparatus comprising: a memory stored in a non-transitory computer-readable medium, said memory comprising: system data, said system data comprising one or more of the following: user information entered into said memory by a user, controller information measured by a main controller, connector information measured by a connector system, module information measured by a connectable module, and the status of said connectable modules connected to said apparatus; said main controller, said main controller being capable of accessing and interacting with said memory, including sending and receiving said system data, and comprising: one or more processors; a pet food storage compartment, said pet food storage compartment comprising: a bin, said bin being capable of storing said pet food; and an access door, said access door being capable of accessing said bin in order to fill said bin with said pet food; a food dispensing mechanism, said food dispensing mechanism being controllable by and capable of communicating with said main controller, including sending and receiving said system data, and capable of dispensing said pet food from said pet food storage compartment on demand, by a programmable schedule, or based on said system data; said connector system, said connector system being controllable by and optionally capable of communicating with said main controller, including sending and receiving said system data, said connector system being capable of connecting said connectable modules to said controller; and said connectable modules, said connectable modules being capable of connecting to said connector system in various combinations, or not at all; said connectable modules optionally comprising a module controller, which is controllable by and capable of communicating with said main controller, including sending and receiving said system data; wherein said system data is used by said apparatus to recommend or control feeding times and amounts or to restrict feeding for a pet.

Other embodiments of the present invention, include an apparatus for storing and dispensing pet food, said apparatus comprising: a memory stored in non-transitory computer-readable medium, said memory comprising: system data, said system data comprising: information entered into said memory by a user and/or stored in said memory, and; a controller, said controller being capable of accessing and interacting with said memory, and comprising: one or more processors; a pet food storage compartment, said pet food storage compartment comprising: a bin, said bin being capable of storing said pet food; and an access door, said access door being capable of accessing said bin in order to fill said bin with said pet food; a food dispensing mechanism, said food dispensing mechanism being controllable by and capable of communicating with said main controller, including sending and receiving said system data, and capable of dispensing said pet food from said pet food storage compartment on demand or by a programmable schedule, or based on said system data; and a light ring, said light ring being controllable by and capable of communicating with said controller, and comprising: an array of LED lights, said array being mounted in a ring around said apparatus; wherein said system data is used by said apparatus to recommend or control feeding times and amounts or to restrict feeding for a pet. This version of the present invention may include LED lights that illuminate in a sequence to simulate a spinning effect or pattern, which appears to speed up as a feeding time approaches. Further, this version may include LED lights that comprise a customizable pattern, which changes as said feeding time approaches.

In addition, some versions of the present invention, including the above-mentioned embodiments, comprise internet connectivity and/or wireless connectivity, or the like. Some embodiments of the present invention use a pet food storage compartment module, which is controllable by and capable of communicating with the main controller, including sending and receiving system data, and uses a pet food level sensor that is capable of measuring the amount of pet food in the pet food storage compartment and communicating that amount to the main controller or a user. Other versions of the present invention use a module, which comprises a feeding bowl that is capable of receiving pet food from a food dispensing mechanism, and is controllable by and capable of communicating with the main controller, including sending and receiving system data. Alternate embodiments of the present invention use connectable modules, which further comprise a feeding bowl that is capable of receiving pet food from a food dispensing mechanism, which is controllable by and capable of communicating with the main controller, including sending and receiving system data, and comprising a lid, that is capable of being opened and closed using the main controller on demand, by a programmable schedule using the timing system, or based on system data. Other versions of the present invention use a feeding bowl further comprising a food weight scale that is capable of measuring the weight of pet food in the feeding bowl. Still other versions use UV light to sterilize a feeding bowl. The present invention may also use a connectable module, which comprises a light ring that is controllable by and capable of communicating with the main controller, including sending and receiving system data, and comprising an array of LED lights that are mounted in a ring around the apparatus, wherein the LED lights of the array illuminate in a sequence to simulate a spinning effect or pattern or comprise a customizable pattern, which changes as a feeding time approaches. Other versions include light fixtures, which may comprise a customizable pattern, or the like, that may change as feeding time approaches. An additional connectable module of the present invention comprises a pet weight scale that is controllable by and capable of communicating with the main controller, including sending and receiving system data, and being capable of weighing a pet's weight while the pet feeds from the apparatus and communicating the pet's weight to the main controller as system data. Furthermore, the present invention may use a connectable module, which comprises a barrier to prevent other pets from accessing the apparatus while one pet is feeding or comprise an LED barrier, which is controllable by and capable of communicating with the main controller, including sending and receiving system data, and being capable of displaying customizable ornamentation, decorations, and animations. The barrier and the LED barrier may comprise one or more side walls, a top cover, a tunnel, an all-around cover with a door, a combination of these barriers, or the like. In addition, other embodiments of the present invention use a connectable module comprising a display screen that is controllable by and capable of communicating with the main controller, including sending and receiving system data, and being capable of displaying the system data. Moreover, other version of the present invention may use a connectable module comprising an RFID system, which is controllable by and capable of communicating with the main controller, including sending and receiving system data, and which is capable of communicating identification data with unique identifying information for a pet to the main controller as system data. The RFID system comprises an RFID tag, which is capable of being worn by a pet and communicating identification data to an RFID reader, and an RFID reader. The RFID system is also capable of being triggered when a pet is weighed by a pet weight scale in order to save energy. Alternatively, embodiments of the present invention may use connectable modules, which comprise a near field communication system that controllable by and capable of communicating with the main controller, including sending and receiving system data, and is capable of communicating identification data with unique identifying information for the pet to the main controller as system data. This near field communication system comprises a near field tag, which is capable of being worn by a pet, and communicating the identification data to a near field reader, and the near field reader. The near field communication system is also capable of being triggered when a pet is weighed by a pet weight scale in order to save energy. Additional customizable modules of the present invention include cameras, speakers, microphones, timing systems, or the like. Moreover, other versions of the present invention use connectable modules, which comprise a pet detection system that is capable of detecting and identifying a pet in order to allow or restrict feeding time and amounts for different pets, using a pet weight scale, an RFID system, a near field communication systems, a camera, a microphone, or the like. Still other embodiments use connectable modules with environmental sensors, such as temperature humidity, air quality, and/or pressure sensors, or the like. Versions of the present invention also may use generic connectable modules, including generic non-electric modules, for adding additional features or further customization, or the like. More preferred embodiments of the present invention comprise a predictive maintenance system, which is controllable by and capable of communicating with the main controller and the connectable modules, including sending and receiving system data, and being capable of monitoring the system data, wherein system data are used for a prediction of when the apparatus, or portion thereof, or one or more connectable modules, need maintenance (such as refilling an empty food container) or replacement and communicates the prediction to the user. The predictive maintenance system may also communicate the prediction to a web site or app, or the like. Embodiments of the present invention may also comprise an ordering module, which is capable of ordering pet food, connectable modules, or a part of the apparatus, based on a prediction by the predictive maintenance system, and communicating that ordering to the main controller as system data. In some embodiments ordering occurs using computing resources external to the apparatus, such as one or more external servers, cloud-based computing, or the like. Another preferred embodiment of the present invention uses a predictive maintenance system for a plurality of Modular Smart Pet Feeders, comprising: a server that is capable of communicating with the plurality of Modular Smart Pet Feeders and their respective connectable modules, including sending and receiving system data, and being capable of monitoring system data; wherein the predictive maintenance system: compares system data of the plurality of Modular Smart Pet Feeders, or portion thereof, or their respective connectable modules in order to identify units with outliers, aberrations, anomalies, irregularities, or the like; and predicts which of the plurality of Modular Smart Pet Feeders, or portion thereof, or their respective connectable modules, need maintenance or replacement. Ultimately, the predictive maintenance systems predict a failure so that corrective action may be performed before the failure occurs in order to ensure continual functionality of the Modular Smart Pet and its various modules to guarantee that feeding is always available when a pet owner is away. Regarding the modular nature of the Modular Smart Pet Feeder, computer processing is required, and computing elements can be located in any module. Modules can be connected using only physical connections. They may also be wirelessly connected directly to each other or wirelessly through the cloud. They may also be connected through electrical connections, such as using ethernet cables, USB cables, custom headers with POGO pins, PCI-express, I2C, SPI, or just two cables for power delivery, or a combination of the preceding electrical connections, or the like. The modules may also be connection in various combinations, such as using physical connections and wireless connections together, using physical connections and electrical connections together, or using physical connections, electrical connections, and wireless connections together. Modules can be connected to a hub, or base module, directly, or to each other. Modules also can discover themselves, similar to computers in an intranet network. Modules can also communicate directly to each other. For example, a module sensing a pet's weight may send signals directly to RFID reader module to read the pet's collar. Modules can also communicate through the main hub or base module. For example, a module, which senses a pet on pet scale, sends information to the main hub or base module, and the main hub or base module requests an RFID reading. In the most basic embodiment, the base module only has a processor; however, it is not limited to those components because it can have wireless communication built in, or LED lights module built in. In sum, the Modular Smart Pet Feeder invention provides a highly functional and data-driven device, which automatically feeds a pet or multiple pets, which monitors the health and feeding activity of the pets, as well as, monitoring its own the health, and which is capable of using numerous optional connectable modules for improved functionality and ornamentation.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive. These embodiments are not intended to limit the scope of the present invention.

### BRIEF DESCRIPTION OF THE DRAWING

Illustrative and preferred embodiments of the present invention are shown in the accompanying drawings in which:

FIG. 1 is a front perspective view of a base feeder module 100 of the present invention.

FIG. 2 is a bottom perspective view of an apparatus of FIG. 1.

FIG. 3 is a front view of an apparatus of FIG. 1.

FIG. 4 is a left side view of an apparatus of FIG. 1.

FIG. 5 is a right side view of an apparatus of FIG. 1.

FIG. 6 is a rear view of an apparatus of FIG. 1.

FIG. 7 is a top view of an apparatus of FIG. 1.

FIG. 8 is a bottom view of an apparatus of FIG. 1.

FIG. 9 is a left side cut away view of an apparatus of FIG. 1.

FIG. 10 is a right side cut away view of an apparatus of FIG. 1.

FIG. 11 is a front cut away view of an apparatus of FIG. 1.

FIG. 12 is a rear cut away view of an apparatus of FIG. 1.

FIG. 13 is an exploded perspective view of an apparatus of FIG. 1.

FIG. 14 is an exploded front view of an apparatus of FIG. 1.

FIG. 15 is an exploded left side view of an apparatus of FIG. 1.

FIG. 16 is a front perspective view of a rotating depending mechanism module 200 of the present invention.

FIG. 17 is a bottom perspective view of an apparatus of FIG. 16.

FIG. 18 is a front view of an apparatus of FIG. 16.

FIG. 19 is a left side view of an apparatus of FIG. 16.

FIG. 20 is a right side view of an apparatus of FIG. 16.

FIG. 21 is a top view of an apparatus of FIG. 16.

FIG. 22 is a bottom view of an apparatus of FIG. 16.

FIG. 23 is an exploded perspective view of an apparatus of FIG. 16.

FIG. 24 is a front perspective view of an apparatus of FIG. 16 mounted in an apparatus of FIG. 1.

FIG. 25 is a front perspective view of an auger depending mechanism module 300 of the present invention.

FIG. 26 is a bottom perspective view of an apparatus of FIG. 25.

FIG. 27 is a front view of an apparatus of FIG. 25.

FIG. 28 is a left side view of an apparatus of FIG. 25.

FIG. 29 is a top view of an apparatus of FIG. 25.

FIG. 30 is a bottom view of an apparatus of FIG. 25.

FIG. 31 is an exploded perspective view of an apparatus of FIG. 25.

FIG. 32 is a front perspective view of an apparatus of FIG. 25 mounted in an apparatus of FIG. 1.

FIG. 33 is a front perspective view of a food container module 400 of the present invention.

FIG. 34 is a bottom perspective view of an apparatus of FIG. 33.

FIG. 35 is a front view of an apparatus of FIG. 33.

FIG. 36 is a left side view of an apparatus of FIG. 33.

FIG. 37 is a top view of an apparatus of FIG. 33.

FIG. 38 is a bottom view of an apparatus of FIG. 33.

FIG. 39 is an exploded perspective view of an apparatus of FIG. 33.

FIG. 40 is a front perspective view of an apparatus of FIG. 33 mounted on an apparatus of FIG. 1.

FIG. 41 is a front perspective view of a simple food container module 500 of the present invention.

FIG. 42 is a bottom perspective view of an apparatus of FIG. 41.

FIG. 43 is a front view of an apparatus of FIG. 41.

FIG. 44 is a left side view of an apparatus of FIG. 41.

FIG. 45 is a top view of an apparatus of FIG. 41.

FIG. 46 is a bottom view of an apparatus of FIG. 41.

FIG. 47 is an exploded perspective view of an apparatus of FIG. 41.

FIG. 48 is a front perspective view of an apparatus of FIG. 41 mounted on an apparatus of FIG. 1.

FIG. 49 is a front perspective view of an LED ring module 600 of the present invention.

FIG. 50 is a bottom perspective view of an apparatus of FIG. 49.

FIG. 51 is a front view of an apparatus of FIG. 49.

FIG. 52 is a left side view of an apparatus of FIG. 49.

FIG. 53 is a top view of an apparatus of FIG. 49.

FIG. 54 is a bottom view of an apparatus of FIG. 49.

FIG. 55 is an exploded perspective view of an apparatus of FIG. 49.

FIG. 56 is a front perspective view of an apparatus of FIG. 49 mounted on an apparatus of FIG. 1.

FIG. 57 is a front perspective view of a food bowl module 700 of the present invention.

FIG. 58 is a rear perspective view of an apparatus of FIG. 57.

FIG. 59 is a front bottom perspective view of an apparatus of FIG. 57.

FIG. 60 is a rear bottom perspective view of an apparatus of FIG. 57.

FIG. 61 is a front view of an apparatus of FIG. 57.

FIG. 62 is a left side view of an apparatus of FIG. 57.

FIG. 63 is a rear view of an apparatus of FIG. 57.

FIG. 64 is a top view of an apparatus of FIG. 57.

FIG. 65 is a bottom view of an apparatus of FIG. 57.

FIG. 66 is an exploded perspective view of an apparatus of FIG. 57.

FIG. 67 is a front perspective view of an apparatus of FIG. 49 mounted on an apparatus of FIG. 1.

FIG. 68 is a front perspective view of a simple food bowl module 800 of the present invention.

FIG. 69 is a bottom perspective view of an apparatus of FIG. 68.

FIG. 70 is a front view of an apparatus of FIG. 68.

FIG. 71 is a left side view of an apparatus of FIG. 68.

FIG. 72 is a top view of an apparatus of FIG. 68.

FIG. 73 is a bottom view of an apparatus of FIG. 68.

FIG. 74 is an exploded perspective view of an apparatus of FIG. 68.

FIG. 75 is a front perspective view of an apparatus of FIG. 68 mounted on an apparatus of FIG. 1.

FIG. 76 is a front perspective view of a weight scale module 900 of the present invention.

FIG. 77 is a bottom perspective view of an apparatus of FIG. 76.

FIG. 78 is a front view of an apparatus of FIG. 76.

FIG. 79 is a left side view of an apparatus of FIG. 76.

FIG. 80 is a top view of an apparatus of FIG. 76.

FIG. 81 is a bottom view of an apparatus of FIG. 76.

FIG. 82 is an exploded perspective view of an apparatus of FIG. 76.

FIG. 83 is a front perspective view of an apparatus of FIG. 76 mounted on an apparatus of FIG. 57, which is mounted on an apparatus of FIG. 1.

FIG. 84 is a front perspective view of a side wall module 1000 of the present invention.

FIG. 85 is a bottom perspective view of an apparatus of FIG. 84.

FIG. 86 is a rear perspective view of an apparatus of FIG. 84.

FIG. 87 is a left side view of an apparatus of FIG. 84.

FIG. 88 is a front view of an apparatus of FIG. 84.

FIG. 89 is a rear view of an apparatus of FIG. 84.

FIG. 90 is a top view of an apparatus of FIG. 84.

FIG. 91 is a bottom view of an apparatus of FIG. 84.

FIG. 92 is an exploded perspective view of an apparatus of FIG. 84.

FIG. 93 is a front perspective view of an apparatus of FIG. 84 mounted an apparatus of FIG. 1.

FIG. 94 is a bottom perspective view of an apparatus of FIG. 84 mounted on an apparatus of FIG. 1.

FIG. 95 is a front perspective view of an RFID reader module 1100 of the present invention.

FIG. 96 is a bottom perspective view of an apparatus of FIG. 95.

FIG. 97 is a front view of an apparatus of FIG. 95.

FIG. 98 is a left side view of an apparatus of FIG. 95.

FIG. 99 is a top view of an apparatus of FIG. 95.

FIG. 100 is a bottom view of an apparatus of FIG. 95.

FIG. 101 is an exploded perspective view of an apparatus of FIG. 95.

FIG. 102 is a front perspective view of an apparatus of FIG. 95 mounted on an apparatus of FIG. 76, which is mounted on an apparatus of FIG. 57, which is mounted on an apparatus of FIG. 1.

FIG. 103 is a front perspective view of a camera module 1200 of the present invention.

FIG. 104 is a bottom perspective view of an apparatus of FIG. 103.

FIG. 105 is a front view of an apparatus of FIG. 103.

FIG. 106 is a left side view of an apparatus of FIG. 103.

FIG. 107 is a top view of an apparatus of FIG. 103.

FIG. 108 is a bottom view of an apparatus of FIG. 103.

FIG. 109 is an exploded perspective view of an apparatus of FIG. 103.

FIG. 110 is a front perspective view of an apparatus of FIG. 103 mounted on an apparatus of FIG. 1.

FIG. 111 is a front perspective view of a battery module 1300 of the present invention.

FIG. 112 is a bottom perspective view of an apparatus of FIG. 111.

FIG. 113 is a front view of an apparatus of FIG. 111.

FIG. 114 is a left side view of an apparatus of FIG. 111.

FIG. 115 is a top view of an apparatus of FIG. 111.

FIG. 116 is a bottom view of an apparatus of FIG. 111.

FIG. 117 is an exploded perspective view of an apparatus of FIG. 111.

FIG. 118 is a bottom perspective view of an apparatus of FIG. 111 mounted on an apparatus of FIG. 1.

FIG. 119 is a front perspective view of a speaker module 1400 of the present invention.

FIG. 120 is a bottom perspective view of an apparatus of FIG. 119.

FIG. 121 is a front view of an apparatus of FIG. 119.

FIG. 122 is a left side view of an apparatus of FIG. 119.

FIG. 123 is a top view of an apparatus of FIG. 119.

FIG. 124 is a bottom view of an apparatus of FIG. 119.

FIG. 125 is an exploded perspective view of an apparatus of FIG. 119.

FIG. 126 is a bottom perspective view of an apparatus of FIG. 119 mounted on an apparatus of FIG. 1.

FIG. 127 is a front perspective view of a generic module 1500 of the present invention.

FIG. 128 is a bottom perspective view of an apparatus of FIG. 127.

FIG. 129 is a front view of an apparatus of FIG. 127.

FIG. 130 is a left side view of an apparatus of FIG. 127.

FIG. 131 is a top view of an apparatus of FIG. 127.

FIG. 132 is a bottom view of an apparatus of FIG. 127.

FIG. 133 is an exploded perspective view of an apparatus of FIG. 127.

FIG. 134 is a bottom perspective view of an apparatus of FIG. 127 mounted on an apparatus of FIG. 1.

FIG. 135 is a front perspective view of a configuration of combined modules with an apparatus of FIG. 33, an apparatus of FIG. 49, an apparatus of FIG. 16, an apparatus of FIG. 57, an apparatus of FIG. 84, an apparatus of FIG. 103, an apparatus of FIG. 111, an apparatus of FIG. 119, and two apparatuses of FIG. 127, which are mounted on an apparatus of FIG. 1; an apparatus of FIG. 76, which is mounted on the apparatus of FIG. 57; and an apparatus of FIG. 95, which is mounted on the apparatus of FIG. 76.

FIG. 136 is a left side view of a configuration of FIG. 135.

FIG. 137 is a right side view of a configuration of FIG. 135.

FIG. 138 is an exploded perspective view of a configuration of FIG. 135.

FIG. 139 is a diagram of a modular smart pet feeder flowchart 1600 of the present invention.

FIG. 140 is a diagram of a pet feeder module flow chart 1700 of the present invention.

### DETAILED DESCRIPTION OF THE PREFERRED EMBODIMENTS

For the purpose of illustration, the present invention is shown in the preferred embodiments of Modular Smart Pet Feeder with a base feeder module, dispensing modules, and food container modules. In broad embodiment, the present invention comprises an apparatus for automatically feeding pets, which may be remotely controlled or monitored through a website or app, or the like, which provides predictive maintenance capability for critical components of the apparatus so that failures that could deprive a pet from food can be avoided, and which includes optional “plug-and-play” connectable modules that provide additional functionality and relay important metrics concerning a pet's physical wellbeing or the condition or status of the various modules, as well as provide entertainment for the pet in a stylish manner. Additional embodiments show optional modules with different functionalities and esthetics, which allow the present invention to be arranged in various customizable configurations. In general, operations of disclosed processes may be performed in an arbitrary order, unless otherwise provided in the claims. These embodiments are not intended to limit the scope of the present invention.

A detailed description of one or more examples is provided below along with accompanying figures. The detailed description is provided in connection with such examples, but is not limited to any particular example. The scope is limited only by the claims, and numerous alternatives, modifications, and equivalents thereof. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

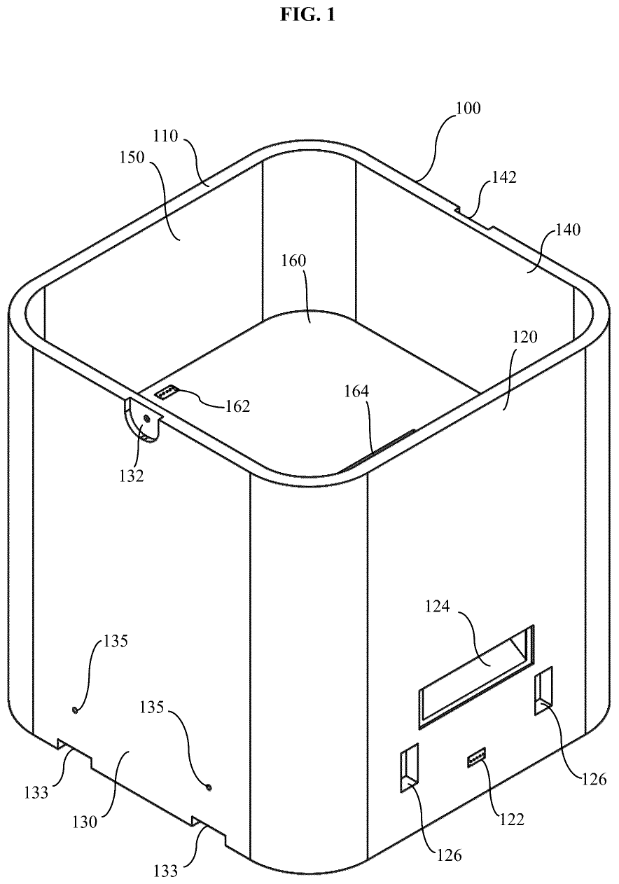

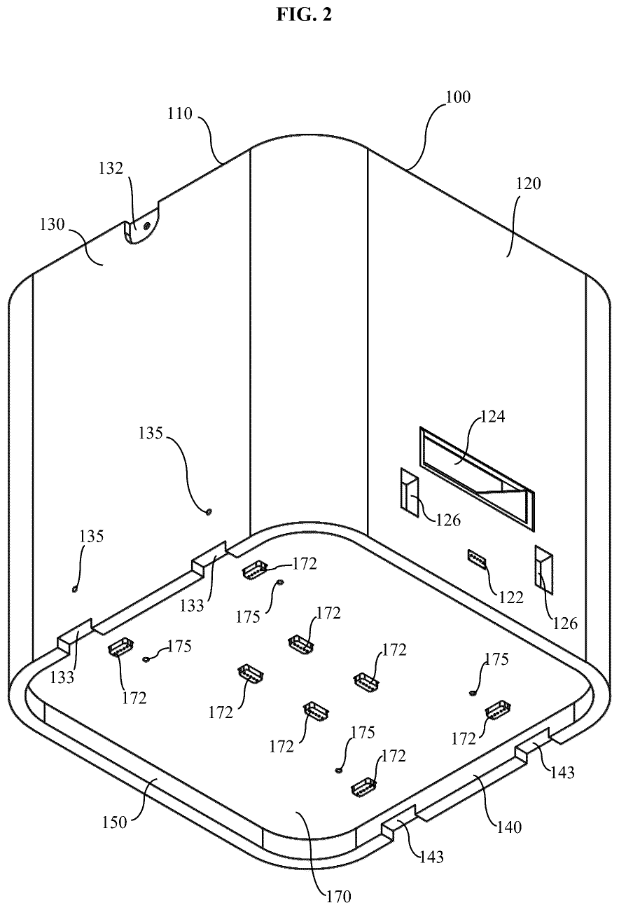

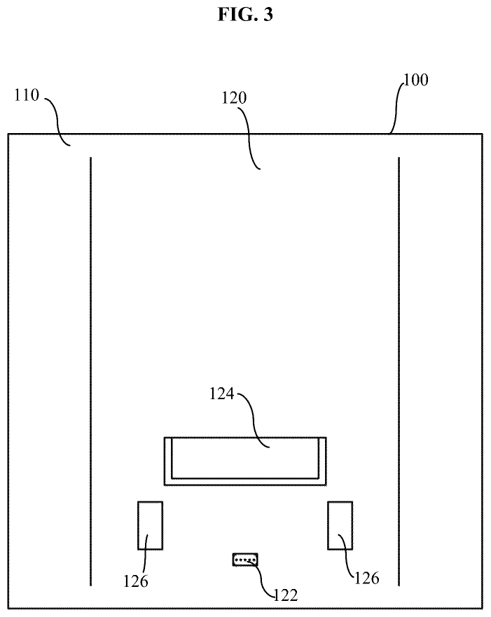

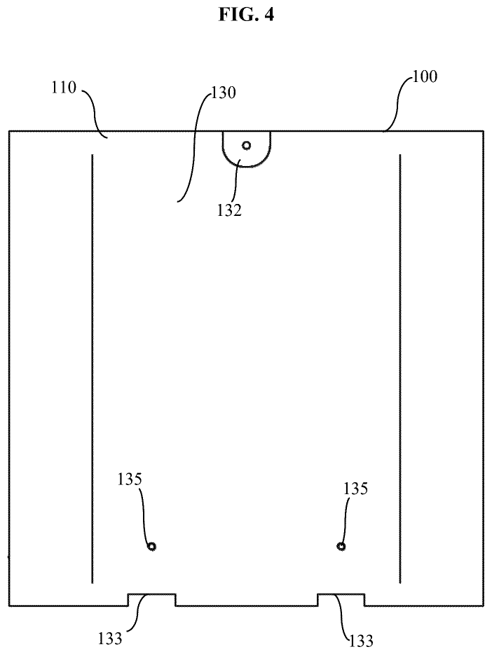

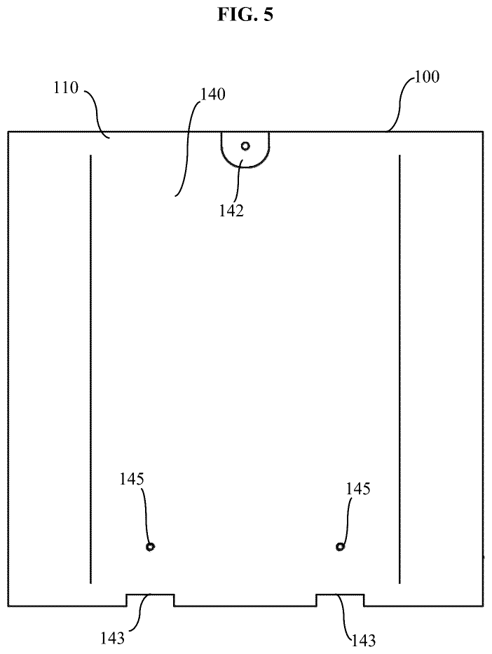

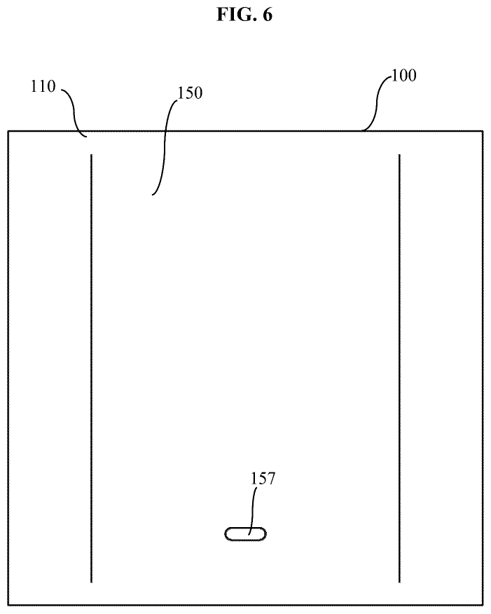

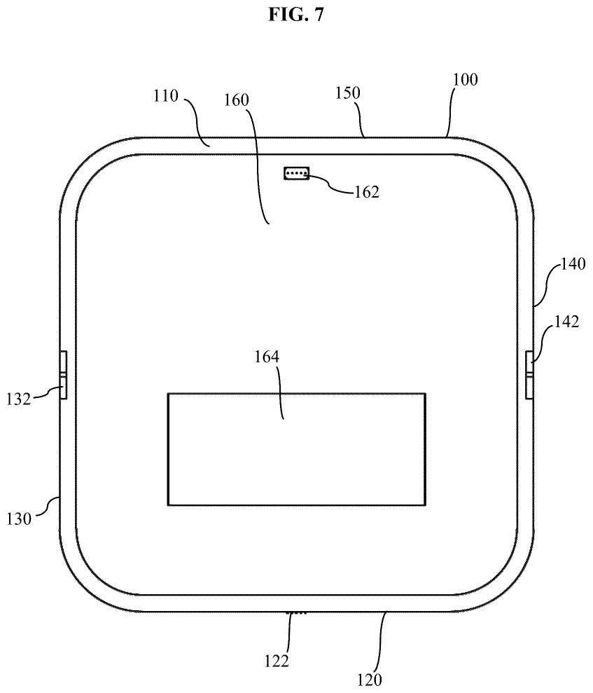

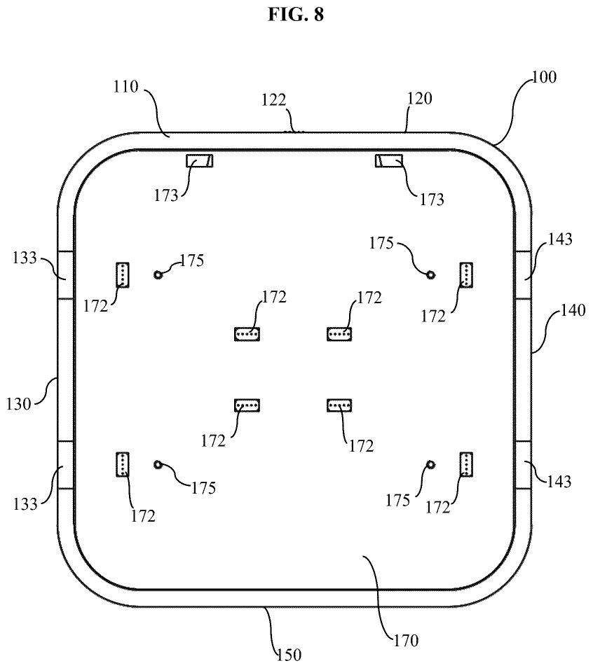

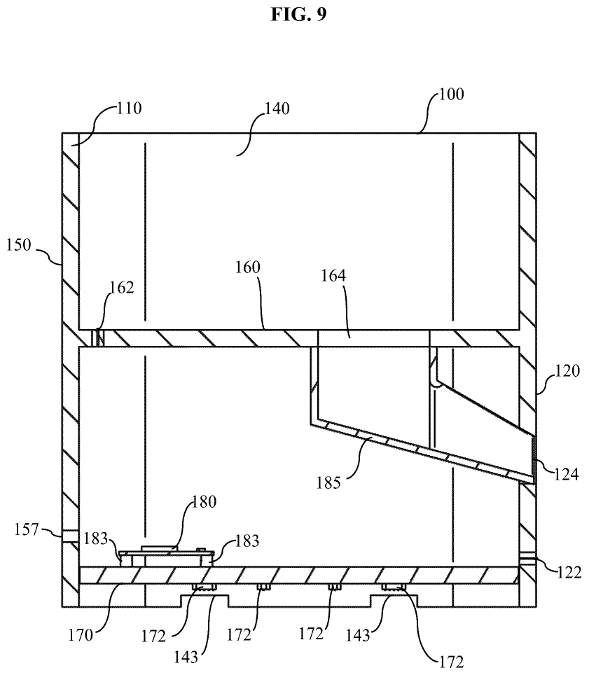

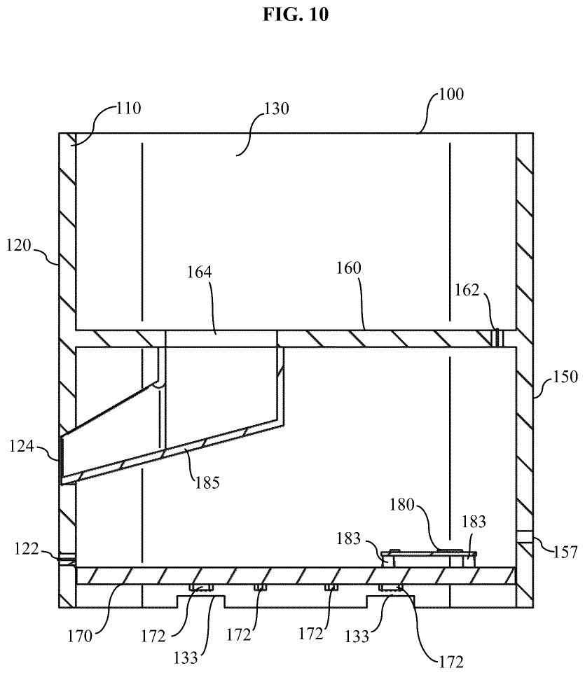

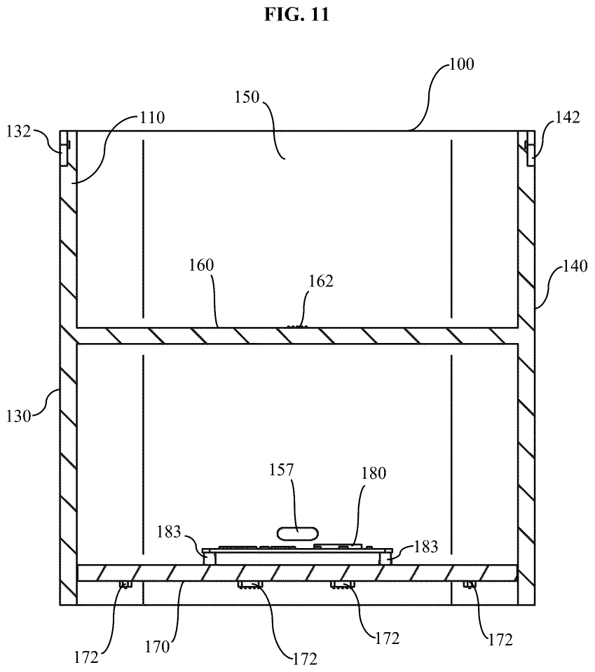

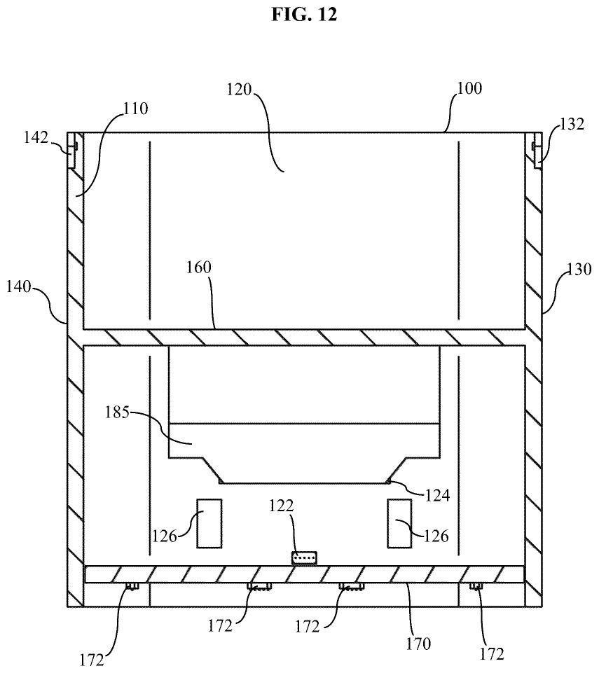

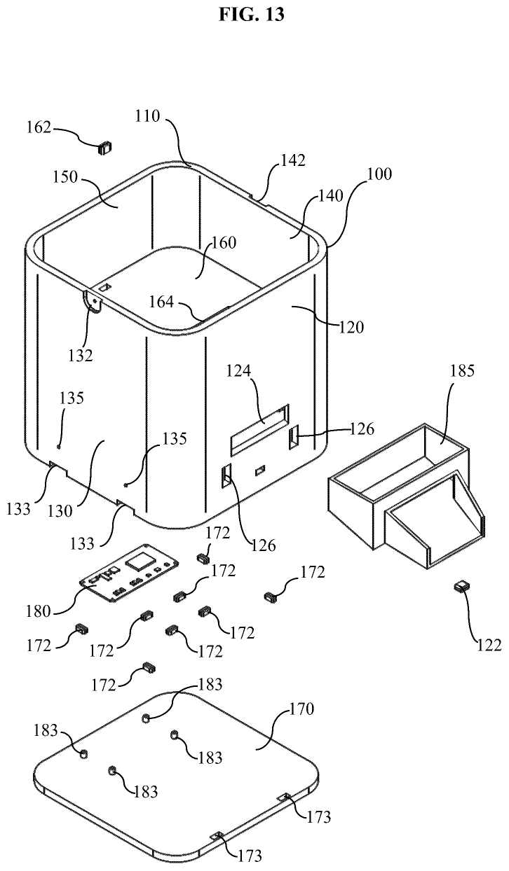

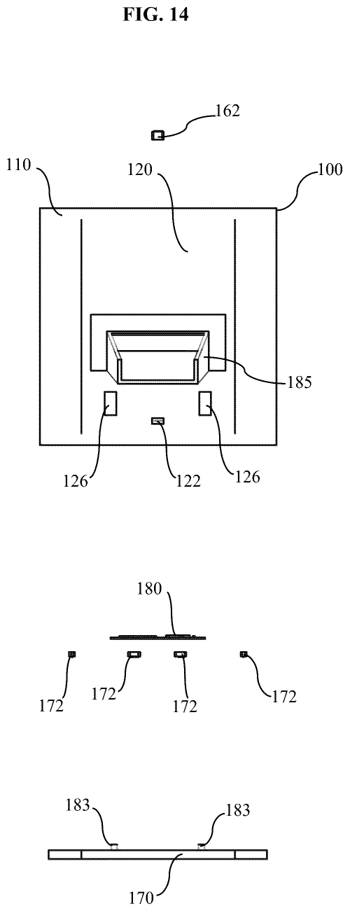

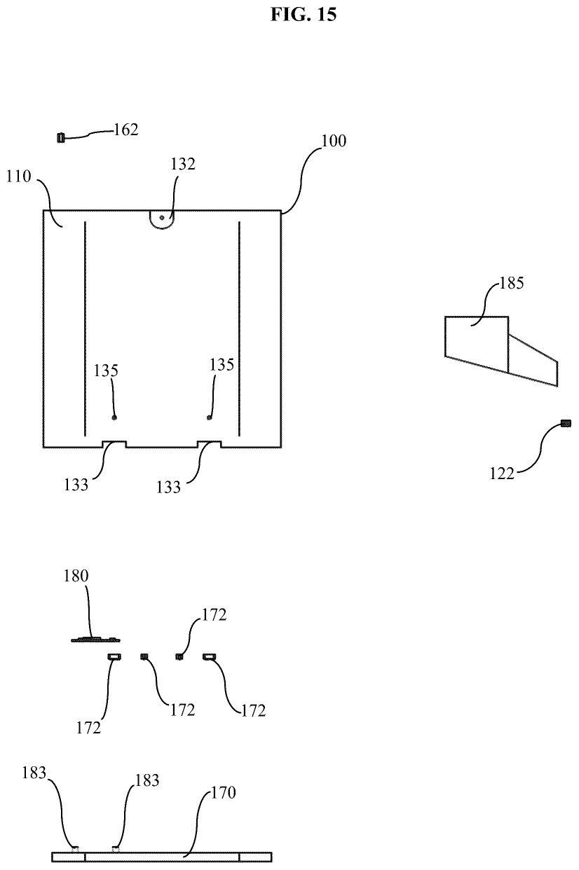

Referring now to the most preferred embodiment of the present invention, FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, and FIG. 15, illustrate a base feeder module 100 of a Modular Smart Pet Feeder. FIG. 1 shows a front perspective view of a base feeder module 100. FIG. 2 depicts a bottom perspective view of a base feeder module 100. FIG. 3 illustrates a front view of a base feeder module 100. FIG. 4 displays a left side view of a base feeder module 100. FIG. 5 shows a right side view of a base feeder module 100. FIG. 6 depicts a rear view of a base feeder module 100. FIG. 7 illustrates a top view of a base feeder module 100. FIG. 8 displays a bottom view of a base feeder module 100. FIG. 9 shows a left side cut away view of a base feeder module 100. FIG. 10 demonstrates a right side cut away view of a base feeder module 100. FIG. 11 illustrates a front cut away view of a base feeder module 100. FIG. 12 displays a rear cut away view of a base feeder module 100. FIG. 13 shows an exploded perspective view of a base feeder module 100. FIG. 14 depicts an exploded front view of a base feeder module 100. FIG. 15 illustrates an exploded left side view of a base feeder module 100. The base feeder module 100 is a required module for the Modular Smart Pet Feeder, and all other modules either connect to the base feeder module 100 or connect to another module connected to the base feeder module.

In further detail, still referring to the invention of FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, and FIG. 15, a base feeder module 100 comprises a base feeder body 110, a base feeder bottom side 170, a base feeder food ramp 185, and a base feeder controller 180. The base feeder body 110 comprises a base feeder front side 120, a base feeder left side 130, a base feeder right side 140, a base feeder rear side 150, and a base feeder middle panel 160, which are joined together as a single unit. The base feeder front side 120 of the base feeder body 110 of the base feeder module 100 comprises a base feeder front connector 122, a base feeder front aperture 124, and base feeder front mount receivers 126. The base feeder front connector 122 comprises an electronic connector for providing power to and communicating with modules connected to the base feeder front side 120, such as a food bowl module 700 or a simple food bowl module 800, as described below, and is controllable by and communicates with the base feeder controller 180. The base feeder front aperture 124 comprises an opening in the base feeder front side 120, which allows food to be dispensed out of the base feeder module 100. The base feeder front mount receivers 126 comprise openings in the base feeder front side 120 for receiving mounts, which physically secure modules to the base feeder module 100, such as a food bowl module 700 using the food bowl rear hooks 756 or a simple food bowl module 800 using the simple food bowl rear hooks 856, as described below. The base feeder left side 130 of the base feeder body 110 of the base feeder module 100 comprises a base feeder left top mount receiver 132, base feeder left bottom mount receivers 133, and base feeder left attachment points 135. The base feeder left top mount receiver 132 comprises an indentation with an attachment point for receiving mounting hardware from other modules, which may be mounted on top of the base feeder module 100, such as a food container module 400 using the food container left fastener 436, a simple food container module 500 using the simple food container left fastener 536, or an LED ring module 600 using the LED ring left fastener 636, as described below. The base feeder left bottom mount receivers 133 comprise indentations at the bottom of the base feeder left side 130 for receiving mounts, which physically secure modules to the base feeder left side 130 of the base feeder module 100, such as a side wall module 1000 using the side wall right mount 1046 and side wall right mount fastener 1045, as described below. The base feeder left attachment points 135 comprise holes for receiving fasteners in order to physically mount other modules to the base feeder left side 130 of the base feeder module 100, such as a side wall module 1000 using the side wall left mount fastener 1035, as described below. The base feeder right side 140 of the base feeder body 110 of the base feeder module 100 comprises a base feeder right top mount receiver 142, base feeder right bottom mount receivers 143, and base feeder right attachment points 145. The base feeder right top mount receiver 142 comprises and indentation with an attachment point for receiving mounting hardware from other modules, which may be mounted on top of the base feeder module 100, such as a food container module 400 using the food container right fastener 446, a simple food container module 500 using the simple food container right fastener 546, or the LED ring module 600 using the LED ring right fastener 646, as described below. The base feeder right bottom mount receivers 143 comprise indentations at the bottom of the base feeder right side 140 for receiving mounts, which physically secure modules to the base feeder right side 140 of the base feeder module 100, such as a camera module 1200 using the camera base 1236 and camera bottom fastener 1235, as described below. The base feeder right attachment points 145 comprise holes for receiving fasteners in order to physically mount other modules to the base feeder right side 140 of the base feeder module 100, such as a camera module 1200 using the camera right fastener 1245, as described below. The base feeder rear side 150 of the base feeder body 110 of the base feeder module 100 comprises a base feeder rear connector 157, which allows the base feeder module 100 to connect to a power supply. The base feeder middle panel 160 of the base feeder body 110 is a horizonal panel located within the base feeder module 100 and provides support for modules, which are mounted inside the base feeder module 100, such as a rotating dispenser module 200 or an auger dispenser module 300, as described below. The base feeder middle panel 160 also provides an interior space for concealing the electronics for the base feeder module 100. The base feeder middle panel 160 of the base feeder body 110 of the base feeder module 100 comprises a base feeder middle connector 162 and a base feeder middle aperture 164. The base feeder middle connector 162 comprises an electronic connector for providing power to and communicating with modules mounted within the base feeder module 100, such as a rotating dispenser module 200 or an auger dispenser module 300, as described below, and is controllable by and communicates with the base feeder controller 180. The base feeder middle aperture 164 comprises an opening in the base feeder middle panel 160, which allows food to be dispensed out of a dispensing module, such as a rotating dispenser module 200 or an auger dispenser module 300 as described below, down through the base feeder middle aperture 164, onto the base feeder feed ramp 185, and out the base feeder front aperture 124. The base feeder bottom side 170 is a horizontal panel that attaches to the bottom of the of the base feeder body 110, which also allows various modules to be attached and connected to the base feeder module 100. The base feeder bottom side 170 comprises one or more base feeder bottom connectors 172, base feeder bottom mount receivers 173, and one or more base feeder attachment points 175. The base feeder bottom connectors 172 comprise electronic connectors for providing power to and communicating with modules mounted on the base feeder bottom side 170 of the base feeder module 100, such as a side wall module 1000 using the side wall right connector 1042, a camera module 1200 using the camera connector 1232, a battery module 1300 using the battery top connector 1392, a speaker module 1400 using the speaker top connector 1492, or various other modules as represented by a generic module 1500 using the generic top connector 1592, as described below, and are controllable by and communicate with the base feeder controller 180. The base feeder bottom mount receivers 173 comprise openings in top of the base feeder bottom side 170 for receiving mounts, which physically secure modules to the base feeder module 100, such as a food bowl module 700 using the food bowl rear hooks 756 or a simple food bowl module 800 using the simple food bowl rear hooks 856, as described below. The base feeder attachment points 175 comprise holes for receiving fasteners in order to physically mount other modules to the underside of the base feeder bottom side 170 of the base feeder module 100, such as a side wall module 1000 using the side wall right mount 1046 and side wall right mount fastener 1045 and/or a camera module 1200 using the camera base 1236 and camera bottom fastener 1235, as described below. The base feeder feed ramp 185 of the base feeder module 100 attaches to the underside of the base feeder middle panel 160 and comprises a chamber with an angled floor. The base feeder feed ramp 185 received food through the base feeder middle aperture 164 of the base feeder middle panel 160 and directs the food to the base feeder front aperture 124 where it is dispensed for feeding a pet. The base feeder controller 180 comprises a printed circuit board (PCB) with a memory and one or more processors for controlling, managing, and monitoring the base feeder module 100 as well as various modules, which may be attached to the base feeder module 100 and may also comprise wireless connectivity, Bluetooth, Near Field Communication (NFC), internet connectivity, network connectivity, or the like. The base feeder controller 180 is also capable of monitoring the functional parameters of various components of the base feeder module 100, as well as those of various connected modules, for preventive and predictive maintenance and reporting data, which may be displayed in an app, webpage, computer program, or the like. The base feeder controller connectors 183 comprise feet, which connect the base feeder controller 180 to the base feeder bottom side 170 of the base feeder module 100. In some embodiments of the present invention, a base feeder module 100 also includes an integrated pet food storage compartment and an integrated food dispensing mechanism, which are all joined together as a single unit.

The construction details of the invention as shown in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, and FIG. 15, are as follows. The base feeder module 100 comprises a base feeder body 110, a base feeder bottom side 170, a base feeder food ramp 185, and a base feeder controller 180. The base feeder body 110 comprises a base feeder front side 120, a base feeder left side 130, a base feeder right side 140, a base feeder rear side 150, and a base feeder middle panel 160, which are joined together as a single unit. The base feeder front side 120 comprises metal, steel, copper, plastic, high density plastic, silicone, PVC, fiber glass, carbon fiber, composite material, wood, galvanized steel, stainless steel, aluminum, brass, gold, silver, copper, or other like material. The base feeder front connector 122 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The base feeder front aperture 124 comprises an opening in the base feeder front side 120, or the like. The base feeder front mount receivers 126 comprises openings in the base feeder front side 120, or the like. The base feeder left side 130 comprises metal, steel, copper, plastic, high density plastic, silicone, PVC, fiber glass, carbon fiber, composite material, wood, galvanized steel, stainless steel, aluminum, brass, gold, silver, copper, or other like material. The base feeder left top mount receiver 132 comprises an indentation with a hole for receiving a fastener, or the like. The base feeder left bottom mount receivers 133 comprise openings in the base feeder left side 130, or the like. The base feeder left attachment points 135 comprises holes for receiving a fastener, or the like. The base feeder right side 140 comprises metal, steel, copper, plastic, high density plastic, silicone, PVC, fiber glass, carbon fiber, composite material, wood, galvanized steel, stainless steel, aluminum, brass, gold, silver, copper, or other like material. The base feeder right top mount receiver 142 comprises an indentation with a hole for receiving a fastener, or the like. The base feeder right bottom mount receivers 143 comprise openings in the base feeder right side 140, or the like. The base feeder right attachment points 145 comprises holes for receiving a fastener, or the like. The base feeder rear side 150 comprises metal, steel, copper, plastic, high density plastic, silicone, PVC, fiber glass, carbon fiber, composite material, wood, galvanized steel, stainless steel, aluminum, brass, gold, silver, copper, or other like material. The base feeder rear connector 157 comprises an electrical power connector comprising electronics, metal, steel, copper, plastic, high density plastic, silicone, PVC, fiber glass, carbon fiber, composite material, galvanized steel, stainless steel, aluminum, brass, gold, silver, copper, or other like material. The base feeder middle panel 160 comprises metal, steel, copper, plastic, high density plastic, silicone, PVC, fiber glass, carbon fiber, composite material, wood, galvanized steel, stainless steel, aluminum, brass, gold, silver, copper, or other like material. The base feeder middle connector 162 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The base feeder middle aperture 164 comprises an opening in the base feeder middle panel 160, or the like. The base feeder bottom side 170 comprises metal, steel, copper, plastic, high density plastic, silicone, PVC, fiber glass, carbon fiber, composite material, wood, galvanized steel, stainless steel, aluminum, brass, gold, silver, copper, or other like material. The base feeder bottom connectors 172 comprise electrical connectors comprising electronics, metal, steel, copper, plastic, high density plastic, silicone, PVC, fiber glass, carbon fiber, composite material, galvanized steel, stainless steel, aluminum, brass, gold, silver, copper, or other like material. The base feeder bottom mount receivers 173 comprise indentations in base feeder bottom side 170, or the like. The base feeder attachment points 175 comprise holes for receiving a fastener, or the like. The base feeder controller 180 comprises a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The base feeder controller connectors 183 comprises feet, which attach the base feeder controller 180 to the base feeder bottom side 170, comprising electrical connectors, metal, steel, copper, plastic, rubber, high density plastic, silicone, PVC, fiber glass, carbon fiber, composite material, wood, galvanized steel, stainless steel, aluminum, brass, gold, silver, copper, or other like material. The base feeder food ramp 185 comprises a UV safe material, metal, steel, copper, plastic, high density plastic, silicone, PVC, fiber glass, carbon fiber, composite material, wood, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

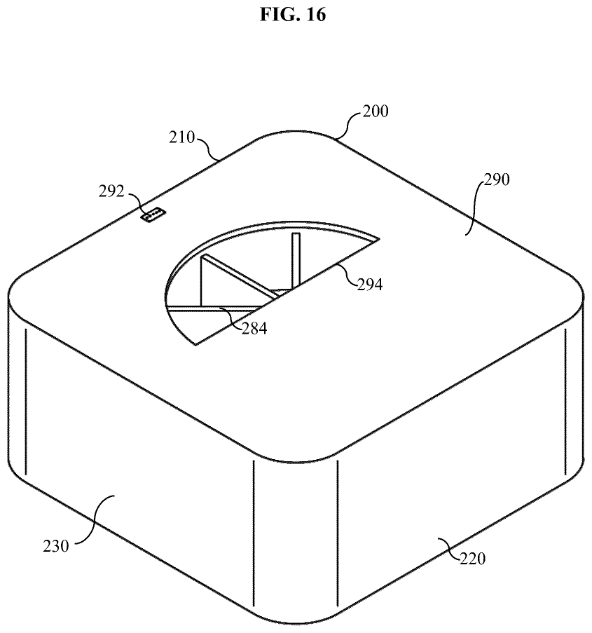

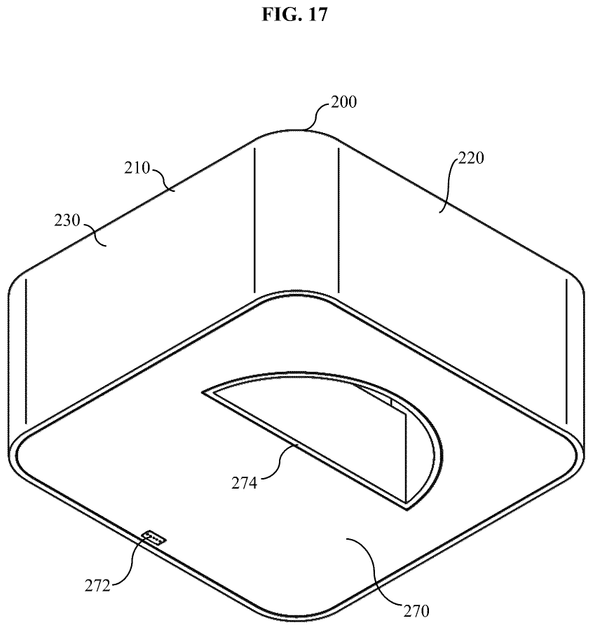

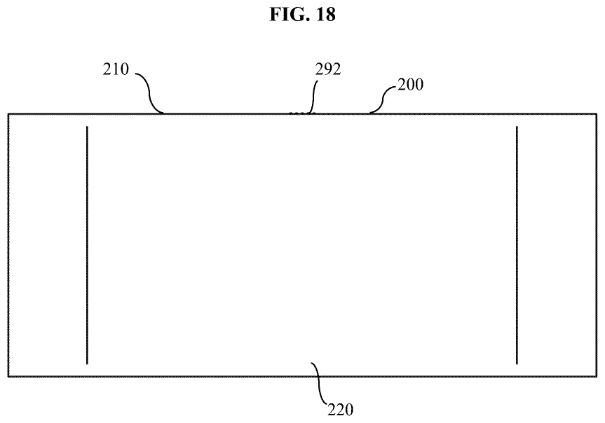

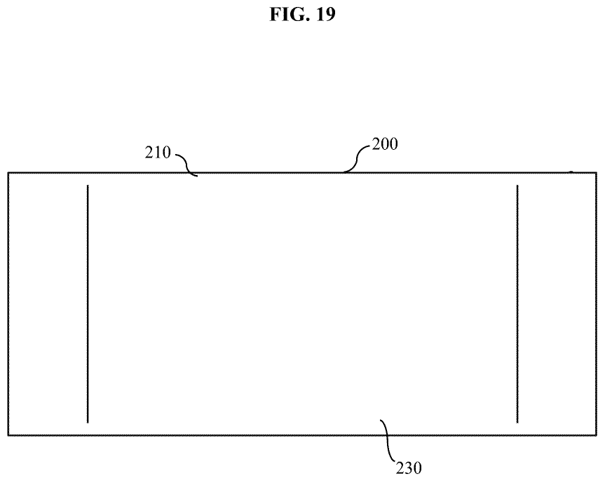

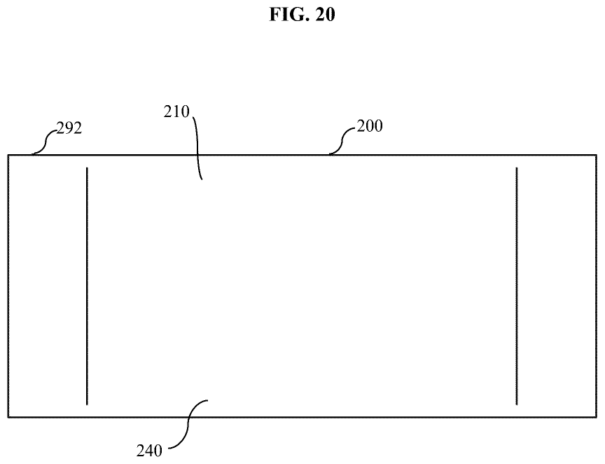

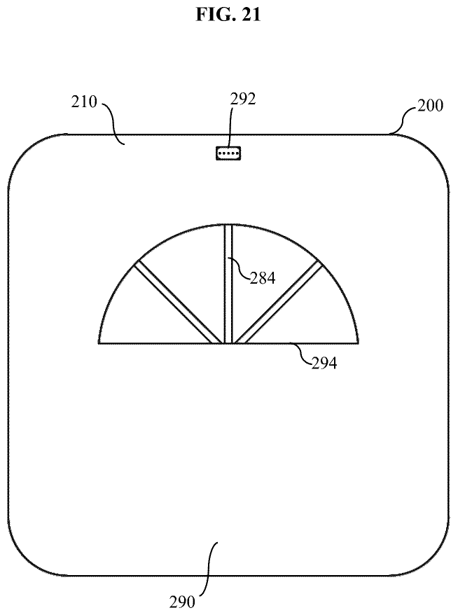

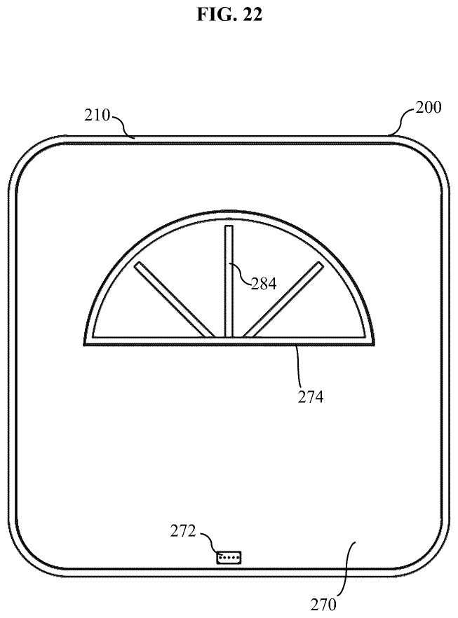

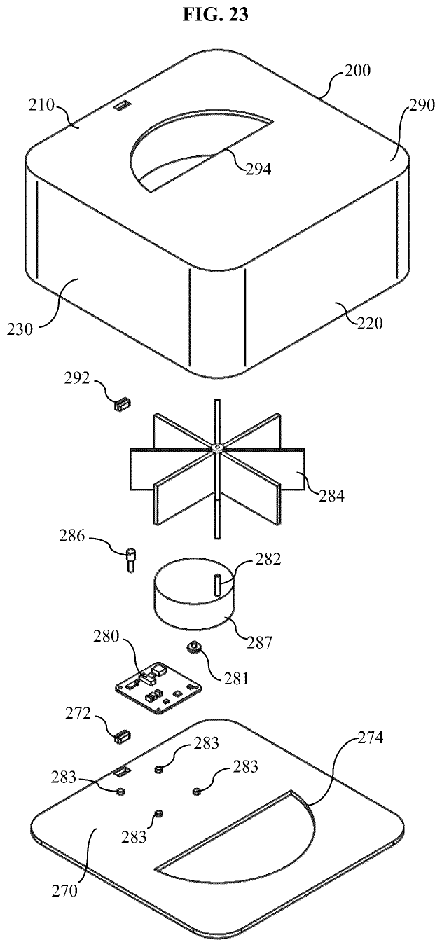

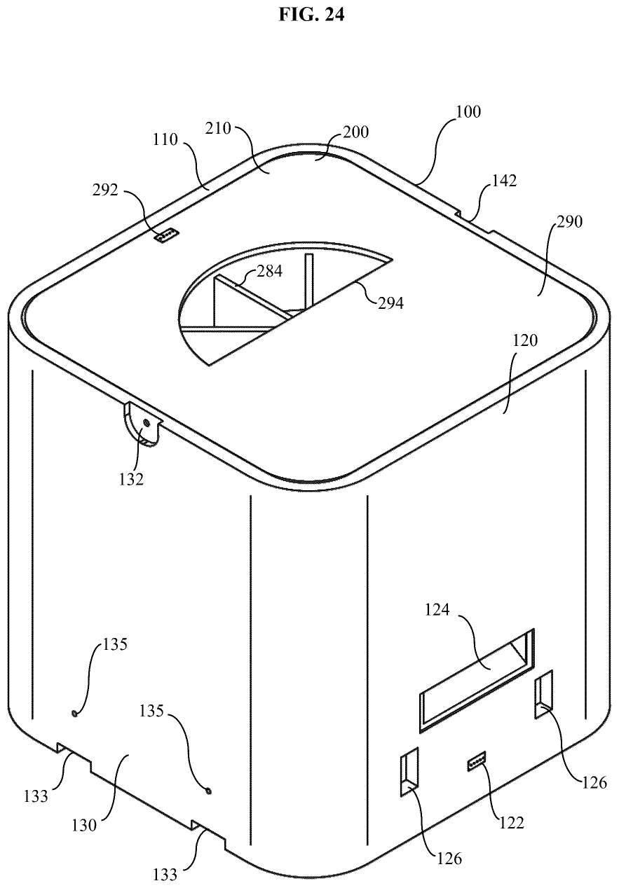

Referring now to another preferred embodiment of the present invention, FIG. 16, FIG. 17, FIG. 18, FIG. 19, FIG. 20, FIG. 21, FIG. 22, FIG. 23, and FIG. 24, illustrate a rotating dispensing mechanism module 200, which is a module that may be mounted inside a base feeder module 100 of a Modular Smart Pet Feeder. FIG. 16 displays a front perspective view of a rotating dispensing mechanism module 200. FIG. 17 demonstrates a bottom perspective view of a rotating dispensing mechanism module 200. FIG. 18 depicts a front view of a rotating dispensing mechanism module 200. FIG. 19 illustrates a left side view of a rotating dispensing mechanism module 200. FIG. 20 displays a right side view of a rotating dispensing mechanism module 200. FIG. 21 shows a top view of a rotating dispensing mechanism module 200. FIG. 22 depicts a bottom view of a rotating dispensing mechanism module 200. FIG. 23 illustrates an exploded perspective view of a rotating dispensing mechanism module 200. FIG. 24 displays a front perspective view of a rotating dispensing mechanism module 200 mounted in a base feeder module 100. A food dispensing mechanism is a required module for an operating Modular Smart Pet Feeder. Due to the modular nature of the Modular Smart Pet Feeder, various modular food dispensing mechanism may be used in a base feeder module 100, and the rotating dispensing mechanism module 200 is one type of these modules with food dispensing mechanisms.

In further detail, still referring to the invention of FIG. 16, FIG. 17, FIG. 18, FIG. 19, FIG. 20, FIG. 21, FIG. 22, FIG. 23, and FIG. 24, a rotating dispenser module 200 comprises a rotating dispenser body 210, a rotating dispenser bottom side 270, rotating dispenser ribs 284 on a rotating dispenser axle 282, a rotating dispenser motor 287, a rotating dispenser position sensor 281, a rotating dispenser temperature sensor 286, and a rotating dispenser controller 280. The rotating dispenser body 210 comprises a rotating dispenser front side 220, a rotating dispenser left side 230, a rotating dispenser right side 240, a rotating dispenser rear side 250, and a rotating dispenser top side 290, which are joined together as a single unit, which functions as a cover for the internal mechanisms of the rotating dispenser module 200. The rotating dispenser bottom side 270 attaches to the bottom of the rotating dispenser body 210 and comprises a rotating dispenser bottom connector 272 and a rotating dispenser bottom aperture 274. The rotating dispenser bottom connector 272 comprises an electronic connector for receiving power from the base feeder module 100 using the base feeder middle connector 162 and transferring it to the rotating dispenser module 200 and/or other modules, which may be connected to the rotating dispenser module 200 and for facilitating electronic communications between the base feeder module 100 and the rotating dispenser module 200 as well as any other modules, which may be connected to the rotating dispenser module 200, such as a food container module 400 or an LED ring module 600, as described below. The rotating dispenser bottom connector 272 is controllable by and communicates with the rotating dispenser controller 280 and/or the base feeder controller 180 of the base feeder module 100. The rotating dispenser bottom aperture 274 comprises an opening in the rotating dispenser bottom side 270, which allows food to be dispensed out the rotating dispenser module 200, down through the base feeder middle aperture 164 of the base feeder middle panel 160 of the base feeder module 100, onto the base feeder feed ramp 185 of the base feeder module 100, and out the base feeder front aperture 124 of the base feeder module 100. The rotating dispenser top side 290 comprises a rotating dispenser top connector 292 and a rotating dispenser top aperture 294. The rotating dispenser top connector 292 comprises an electronic connector for transferring power from the rotating dispenser module 200 to other modules, which may be connected to the rotating dispenser module 200, and for facilitating electronic communications between the rotating dispenser module 200 and any other modules, which may be connected to the rotating dispenser module 200, such as a food container module 400 using the food container bottom connector 472 or an LED ring module 600 using the LED ring connector 692, as described below. The rotating dispenser top connector 292 is controllable by and communicates with the rotating dispenser controller 280 and/or the base feeder controller 180 of the base feeder module 100. The rotating dispenser top aperture 294 comprises an opening in the rotating dispenser top side 290, which receives food from a mounted food container module, such as a food container module 400 or a simple food container module 500 as described below (or receives food passing through an LED ring module 600), into the interior of the rotating dispenser module 200. The rotating dispenser top aperture 294 and the rotating dispenser bottom aperture 274 are offset from each other. Inside the rotating dispenser module 200, rotating dispenser ribs 284 are mounted on a rotating dispenser axle 282, which is in turn mounted on a rotating dispenser motor 287, which is controlled by a rotating dispenser controller 280. The rotating dispenser controller 280 comprises a printed circuit board (PCB) with a memory and one or more processors for controlling, managing, and monitoring the rotating dispenser module 200 as well as various modules, which may be attached to the rotating dispenser module 200, and for communicating with the base feeder module 100. The rotating dispenser controller 280 may also comprise wireless connectivity, Bluetooth, Near Field Communication (NFC), internet connectivity, network connectivity, or the like. The rotating dispenser controller 280 is also capable of monitoring the functional parameters of various components of the rotating dispenser module 200, such as by monitoring the rotating dispenser position sensor 281 and/or the rotating dispenser temperature sensor 286, as well as being capable of monitoring the functional parameters of various connected modules or communicating those parameters to the base feeder module 100 for monitoring, in order to facilitate preventive and predictive maintenance and report data, which may be displayed in an app, webpage, computer program, or the like. The rotating dispenser position sensor 281 measures the position of the rotating dispenser motor 287 and the rotating dispenser ribs 284 in order to monitor functionality and provide predictive and preventative maintenance. The rotating dispenser axle 282 is mounted on the rotating dispenser motor 287 and comprises a rigid shaft. The rotating dispenser controller connectors 283 connect the rotating dispenser controller 280 to the rotating dispenser bottom side 270. The rotating dispenser ribs 284 are mounted on the rotating dispenser axle 282, rotate horizontally, and comprise a plurality of vertical paddles arranged like a horizontal wheel. The rotating dispenser temperature sensor 286 measures the temperature of the rotating dispenser motor 287 in order to monitor functionality and provide predictive and preventative maintenance, such as by predicting a motor failure before it occurs so that the motor may be replaced before failure to insure continuous operation of the Modular Smart Pet Feeder. The rotating dispenser motor 287 is controllable by and communicates with the rotating dispenser controller 280 and/or the base feeder controller 180 of the base feeder module 100; is capable of rotating the rotating dispenser axle 282, which in turn rotates the rotating dispenser ribs 284; and comprises an electric motor or the like. During operation, when a feeding period occurs, the rotating dispenser controller 280 receives a signal to dispense food from the base feeder controller 180 of the base feeder module 100. Next, the rotating dispenser controller 280 activates the rotating dispenser motor 287, which rotates the mounted rotating dispenser axle 282, which in turn rotates the rotating dispenser ribs 284. When the rotating dispenser ribs 284 rotate, food that enters the rotating dispenser module 200 from a mounted food container module, such as the food container module 400 or the simple food container module 500 as described below, through the rotating dispenser top aperture 294 of the rotating dispenser top side 290 of the rotating dispenser module 200, is pushed to the rotating dispenser bottom aperture 274 where it falls through the base feeder middle aperture 164 of the base feeder middle panel 160 of the base feeder module 100, onto the base feeder feed ramp 185 of the base feeder module 100, and out the base feeder front aperture 124 of the base feeder module 100 in order to feed a pet. In some embodiments of the present invention, a rotating dispenser module 200 is integrated into the base feeder module 100 along with a pet food storage compartment, which are all joined together as a single unit.

The construction details of the invention as shown in FIG. 16, FIG. 17, FIG. 18, FIG. 19, FIG. 20, FIG. 21, FIG. 22, FIG. 23, and FIG. 24, are as follows. The rotating dispenser module 200 comprises a rotating dispenser body 210, a rotating dispenser bottom side 270, rotating dispenser ribs 284 on a rotating dispenser axle 282, a rotating dispenser motor 287, a rotating dispenser position sensor 281, a rotating dispenser temperature sensor 286, and a rotating dispenser controller 280. The rotating dispenser body 210 comprises a rotating dispenser front side 220, a rotating dispenser left side 230, a rotating dispenser right side 240, a rotating dispenser rear side 250, and a rotating dispenser top side 290, which are joined together as a single unit. The rotating dispenser front side 220 comprises metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser left side 230 comprises metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser right side 240 comprises metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser rear side 250 comprises metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser bottom side 270 comprises metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser bottom connector 272 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The rotating dispenser bottom aperture 274 comprises an opening in the rotating dispenser bottom side 270. The rotating dispenser controller 280 comprises a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The rotating dispenser position sensor 281 comprises a sensor for measuring the position of a motor, or the like. The rotating dispenser axle 282 comprises a rigid shaft comprising metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser controller connectors 283 comprise feet, which attach the rotating dispenser controller 280 to the rotating dispenser bottom side 270, comprising electrical connectors, metal, steel, copper, plastic, rubber, high density plastic, silicone, PVC, fiber glass, carbon fiber, composite material, wood, galvanized steel, stainless steel, aluminum, brass, gold, silver, copper, or other like material. The rotating dispenser ribs 284 comprise a plurality of vertical paddles arranged like a horizontal wheel, which comprise metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser temperature sensor 286 comprises a sensor for measuring temperature, or the like. The rotating dispenser motor 287 comprises an electric motor, or the like. The rotating dispenser top side 290 comprises metal, steel, copper, plastic, high density plastic, silicone, PVC, fiber glass, carbon fiber, composite material, wood, galvanized steel, stainless steel, aluminum, brass, gold, silver, copper, or other like material. The rotating dispenser top connector 292 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The rotating dispenser top aperture 294 comprises an opening in the rotating dispenser top side 290. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

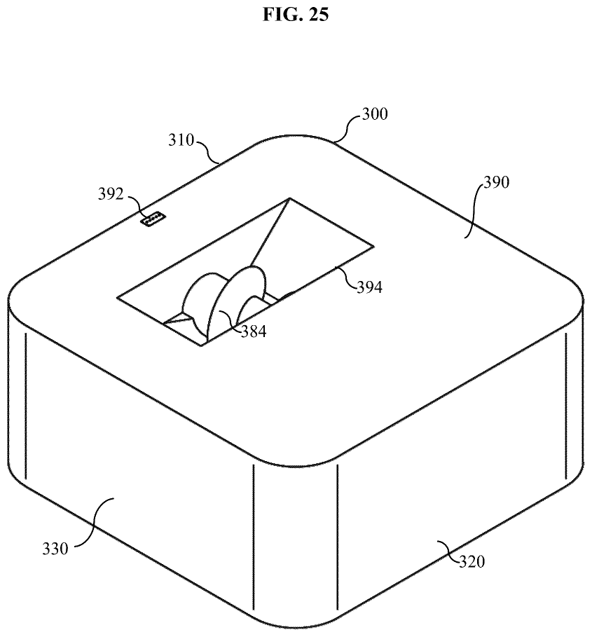

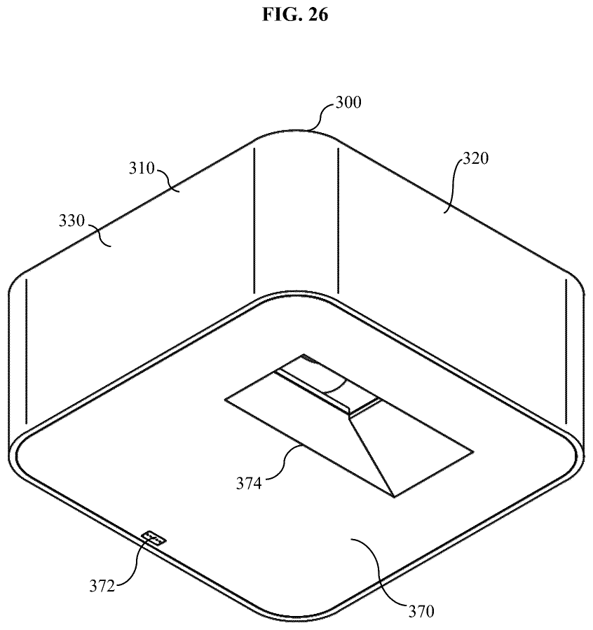

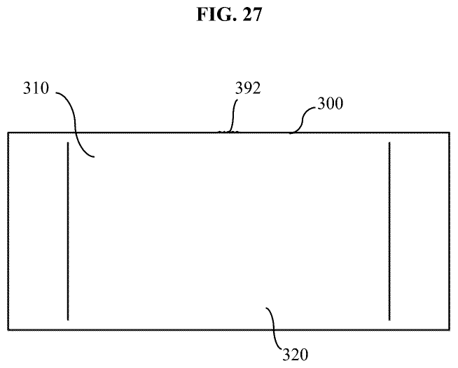

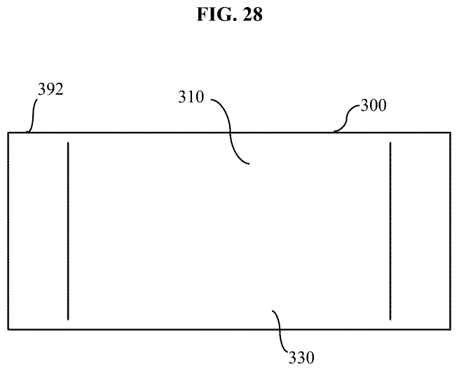

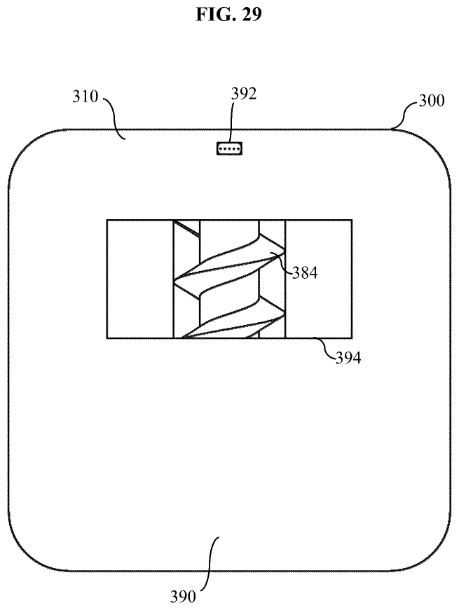

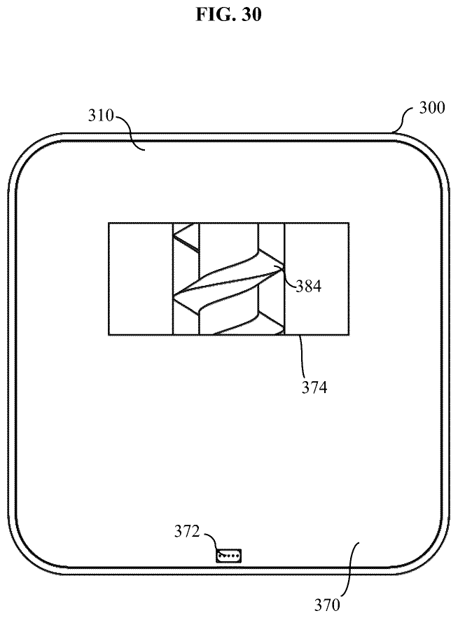

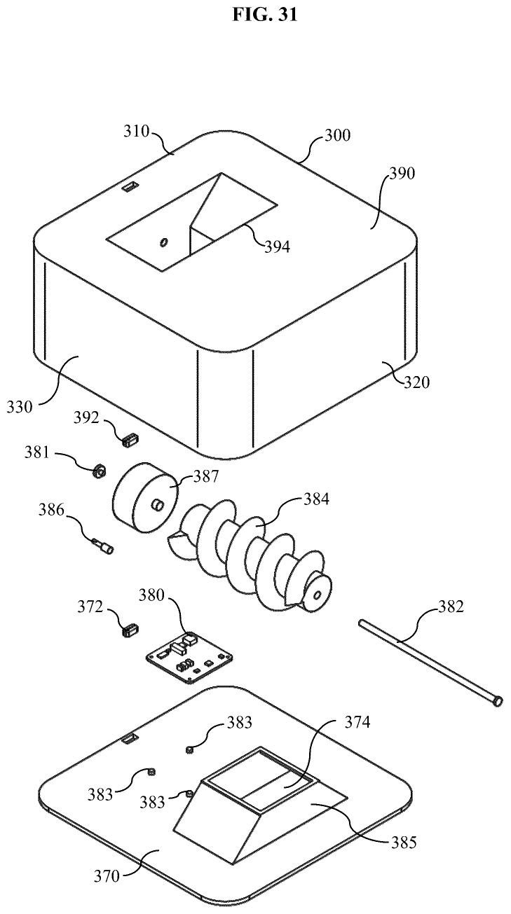

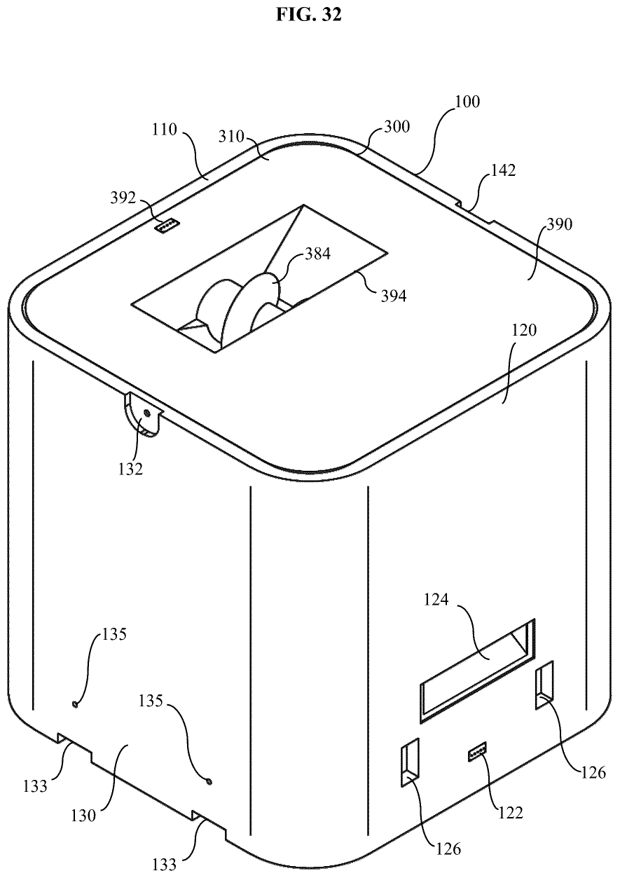

Referring now to another preferred embodiment of the present invention, FIG. 25, FIG. 26, FIG. 27, FIG. 28, FIG. 29, FIG. 30, FIG. 31, and FIG. 32, illustrate an auger dispensing mechanism module 300, which is a module that may be mounted inside a base feeder module 100 of a Modular Smart Pet Feeder. FIG. 25 depicts a front perspective view of an auger dispensing mechanism module 300. FIG. 26 illustrates a bottom perspective view of an auger dispensing mechanism module 300. FIG. 27 displays a front view of an auger dispensing mechanism module 300. FIG. 28 shows a left side view of an auger dispensing mechanism module 300. FIG. 29 depicts a top view of an auger dispensing mechanism module 300. FIG. 30 illustrates a bottom view of an auger dispensing mechanism module 300. FIG. 31 displays an exploded perspective view of an auger dispensing mechanism module 300. FIG. 32 shows a front perspective view of an auger dispensing mechanism module 300 mounted in a base feeder module 100. A food dispensing mechanism is a required module for an operating Modular Smart Pet Feeder. Due to the modular nature of the Modular Smart Pet Feeder, various modular food dispensing mechanism may be used in a base feeder module 100, and the auger dispensing mechanism module 300 is one type of these modules with food dispensing mechanisms.

In further detail, still referring to the invention of FIG. 25, FIG. 26, FIG. 27, FIG. 28, FIG. 29, FIG. 30, FIG. 31, and FIG. 32, an auger dispenser module 300 comprises an auger dispenser body 310, an auger dispenser bottom side 370, auger dispenser auger 384 on an auger dispenser axle 382, an auger dispenser motor 387, an auger dispenser position sensor 381, an auger dispenser temperature sensor 386, and an auger dispenser controller 380. The auger dispenser body 310 comprises an auger dispenser front side 320, an auger dispenser left side 330, an auger dispenser right side 340, an auger dispenser rear side 350, and an auger dispenser top side 390, which are joined together as a single unit, which functions as a cover for the internal mechanisms of the auger dispenser module 300. The auger dispenser bottom side 370 attaches to the bottom of the auger dispenser body 310 and comprises an auger dispenser bottom connector 372 and an auger dispenser bottom aperture 374. The auger dispenser bottom connector 372 comprises an electronic connector for receiving power from the base feeder module 100 using the base feeder middle connector 162 and transferring it to the auger dispenser module 300 and/or other modules, which may be connected to the auger dispenser module 300, and for facilitating electronic communications between the base feeder module 100 and the auger dispenser module 300 as well as any other modules, which may be connected to the auger dispenser module 300, such as a food container module 400 or an LED ring module 600, as described below. The auger dispenser bottom connector 372 is controllable by and communicates with the auger dispenser controller 380 and/or the base feeder controller 180 of the base feeder module 100. The auger dispenser bottom aperture 374 comprises an opening in the auger dispenser bottom side 370, which allows food to be dispensed out the auger dispenser module 300, down through the base feeder middle aperture 164 of the base feeder middle panel 160 of the base feeder module 100, onto the base feeder feed ramp 185 of the base feeder module 100, and out the base feeder front aperture 124 of the base feeder module 100. The auger dispenser top side 390 comprises an auger dispenser top connector 392 and an auger dispenser top aperture 394. The auger dispenser top connector 392 comprises an electronic connector for transferring power from the auger dispenser module 300 to other modules, which may be connected to the auger dispenser module 300, and for facilitating electronic communications between the auger dispenser module 300 and any other modules, which may be connected to the auger dispenser module 300, such as a food container module 400 using the food container bottom connector 472 or an LED ring module 600 using the LED ring connector 692, as described below. The auger dispenser top connector 392 is controllable by and communicates with the auger dispenser controller 380 and/or the base feeder controller 180 of the base feeder module 100. The auger dispenser top aperture 394 comprises an opening in the auger dispenser top side 390, which receives food from a mounted food container module, such as a food container module 400 or a simple food container module 500 as described below (or receives food passing through an LED ring module 600), into the interior of the auger dispenser module 300. The auger dispenser top aperture 394 and the auger dispenser bottom aperture 374 are offset from each other. Inside the auger dispenser module 300, auger dispenser auger 384 is mounted on an auger dispenser axle 382, which is in turn mounted on an auger dispenser motor 387 that is controlled by an auger dispenser controller 380. The auger dispenser controller 380 comprises a printed circuit board (PCB) with a memory and one or more processors for controlling, managing, and monitoring the auger dispenser module 300 as well as various modules, which may be attached to the auger dispenser module 300, and for communicating with the base feeder module 100. The auger dispenser controller 380 may also comprise wireless connectivity, Bluetooth, Near Field Communication (NFC), internet connectivity, network connectivity, or the like. The auger dispenser controller 380 is also capable of monitoring the functional parameters of various components of the auger dispenser module 300, such as by monitoring the auger dispenser position sensor 381 and/or the auger dispenser temperature sensor 386, as well as being capable of monitoring the functional parameters of various connected modules or communicating those parameters to the base feeder module 100 for monitoring, in order to facilitate preventive and predictive maintenance and report data, which may be displayed in an app, webpage, computer program, or the like. The auger dispenser position sensor 381 measures the position of the auger dispenser motor 387 and the auger dispenser auger 384 in order to monitor functionality and provide predictive and preventative maintenance. The auger dispenser axle 382 is mounted horizontally through the auger dispenser motor 387 and comprises a rigid shaft. The auger dispenser controller connectors 383 connect the auger dispenser controller 380 to the auger dispenser bottom side 370. The auger dispenser auger 384 is mounted on the auger dispenser axle 382 and comprises a horizontal screw. The auger dispenser temperature sensor 386 measures the temperature of the auger dispenser motor 387 in order to monitor functionality and provide predictive and preventative maintenance, such as by predicting a motor failure before it occurs so that the motor may be replaced before failure to insure continuous operation of the Modular Smart Pet Feeder. The auger dispenser motor 387 is mounted horizontally; is controllable by and communicates with the auger dispenser controller 380 and/or the base feeder controller 180 of the base feeder module 100; is capable of rotating the auger dispenser axle 382, which in turn rotates the auger dispenser auger 384; and comprises an electric motor or the like. During operation, when a feeding period occurs, the auger dispenser controller 380 receives a signal to dispense food from the base feeder controller 180 of the base feeder module 100. Next, the auger dispenser controller 380 activates the auger dispenser motor 387, which rotates the mounted auger dispenser axle 382, which in turn rotates the auger dispenser auger 384. When the auger dispenser auger 384 rotates, food that enters the auger dispenser module 300 from a mounted food container module, such as the food container module 400 or the simple food container module 500 as described below, through the auger dispenser top aperture 394 of the auger dispenser top side 390 of the auger dispenser module 300, is pushed to the auger dispenser bottom aperture 374 where it falls through the base feeder middle aperture 164 of the base feeder middle panel 160 of the base feeder module 100, onto the base feeder feed ramp 185 of the base feeder module 100, and out the base feeder front aperture 124 of the base feeder module 100 in order to feed a pet. In some embodiments of the present invention, an auger dispenser module 300 is integrated into the base feeder module 100 along with a pet food storage compartment, which are all joined together as a single unit.

The construction details of the invention as shown in FIG. 25, FIG. 26, FIG. 27, FIG. 28, FIG. 29, FIG. 30, FIG. 31, and FIG. 32, are as follows. The auger dispenser module 300 comprises an auger dispenser body 310, an auger dispenser bottom side 370, auger dispenser auger 384 on an auger dispenser axle 382, an auger dispenser motor 387, an auger dispenser position sensor 381, an auger dispenser temperature sensor 386, and an auger dispenser controller 380. The auger dispenser body 310 comprises an auger dispenser front side 320, an auger dispenser left side 330, an auger dispenser right side 340, an auger dispenser rear side 350, and an auger dispenser top side 390, which are joined together as a single unit. The auger dispenser front side 320 comprises metal, steel, copper, plastic, high density plastic, silicone, PVC, fiber glass, carbon fiber, composite material, wood, galvanized steel, stainless steel, aluminum, brass, gold, silver, copper, or other like material. The auger dispenser left side 330 comprises metal, steel, copper, plastic, high density plastic, silicone, PVC, fiber glass, carbon fiber, composite material, wood, galvanized steel, stainless steel, aluminum, brass, gold, silver, copper, or other like material. The auger dispenser right side 340 comprises metal, steel, copper, plastic, high density plastic, silicone, PVC, fiber glass, carbon fiber, composite material, wood, galvanized steel, stainless steel, aluminum, brass, gold, silver, copper, or other like material. The auger dispenser rear side 350 comprises metal, steel, copper, plastic, high density plastic, silicone, PVC, fiber glass, carbon fiber, composite material, wood, galvanized steel, stainless steel, aluminum, brass, gold, silver, copper, or other like material. The auger dispenser bottom side 370 comprises metal, steel, copper, plastic, high density plastic, silicone, PVC, fiber glass, carbon fiber, composite material, wood, galvanized steel, stainless steel, aluminum, brass, gold, silver, copper, or other like material. The auger dispenser bottom connector 372 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The auger dispenser bottom aperture 374 comprises an opening in the auger dispenser bottom side 370, or the like. The auger dispenser controller 380 comprises a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The auger dispenser position sensor 381 comprises a sensor for measuring the position of a motor, or the like. The auger dispenser axle 382 comprises a rigid shaft comprising metal, steel, copper, plastic, high density plastic, silicone, PVC, fiber glass, carbon fiber, composite material, wood, galvanized steel, stainless steel, aluminum, brass, gold, silver, copper, or other like material. The auger dispenser controller connectors 383 comprises feet, which attach the auger dispenser controller 380 to the auger dispenser bottom side 370, comprising electrical connectors, metal, steel, copper, plastic, rubber, high density plastic, silicone, PVC, fiber glass, carbon fiber, composite material, wood, galvanized steel, stainless steel, aluminum, brass, gold, silver, copper, or other like material. The auger dispenser auger 384 comprises a screw comprising metal, steel, copper, plastic, high density plastic, silicone, PVC, fiber glass, carbon fiber, composite material, wood, galvanized steel, stainless steel, aluminum, brass, gold, silver, copper, or other like material. The auger dispenser temperature sensor 386 comprises a sensor for measuring temperature, or the like. The auger dispenser motor 387 comprises an electric motor, or the like. The auger dispenser top side 390 comprises metal, steel, copper, plastic, high density plastic, silicone, PVC, fiber glass, carbon fiber, composite material, wood, galvanized steel, stainless steel, aluminum, brass, gold, silver, copper, or other like material. The auger dispenser top connector 392 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The auger dispenser top aperture 394 comprises an opening in the auger dispenser top side 390, or the like. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

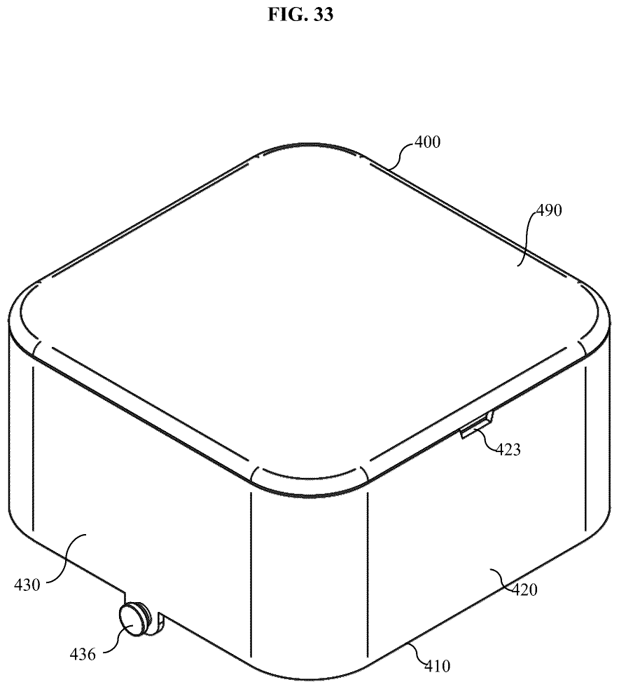

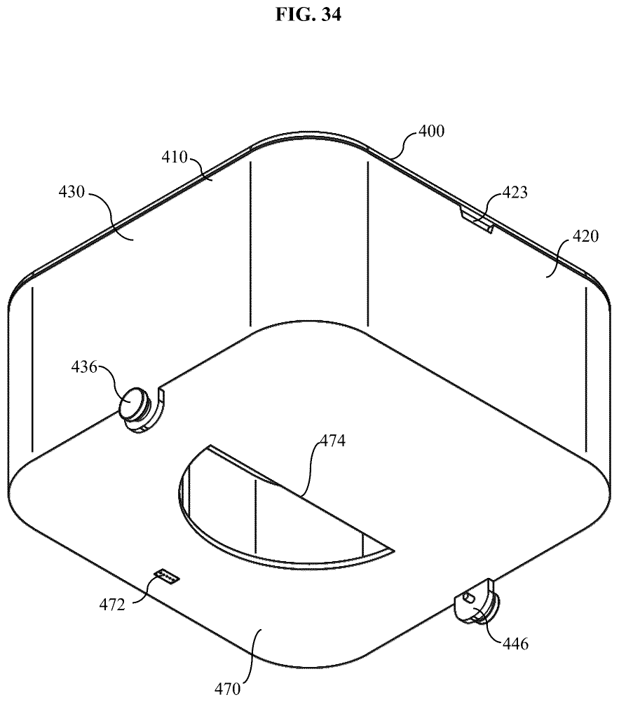

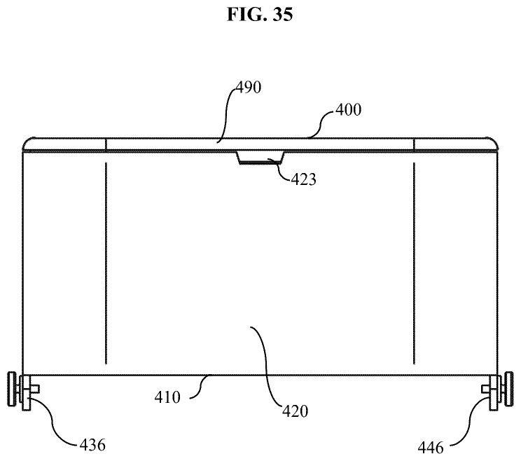

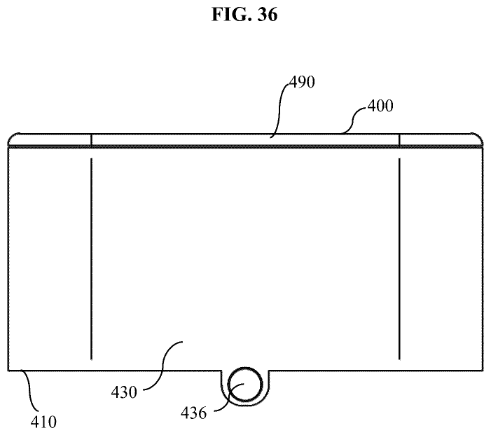

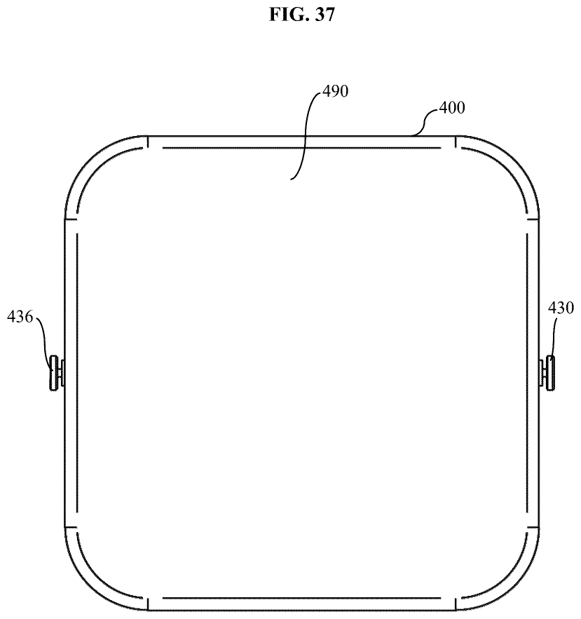

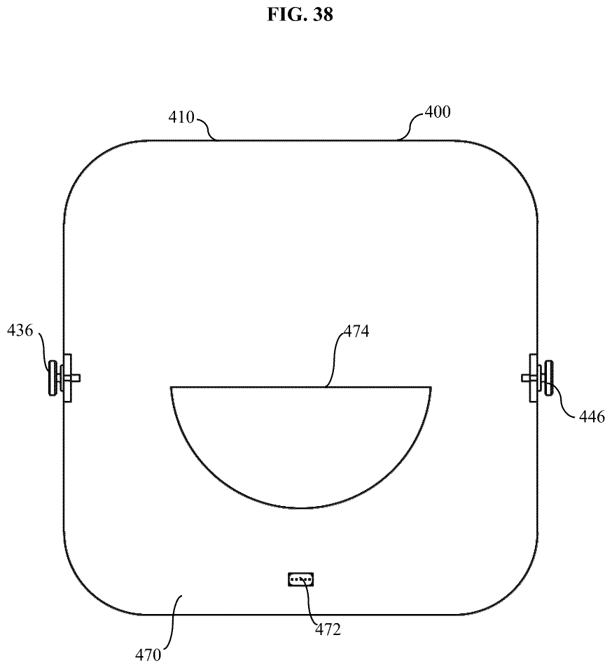

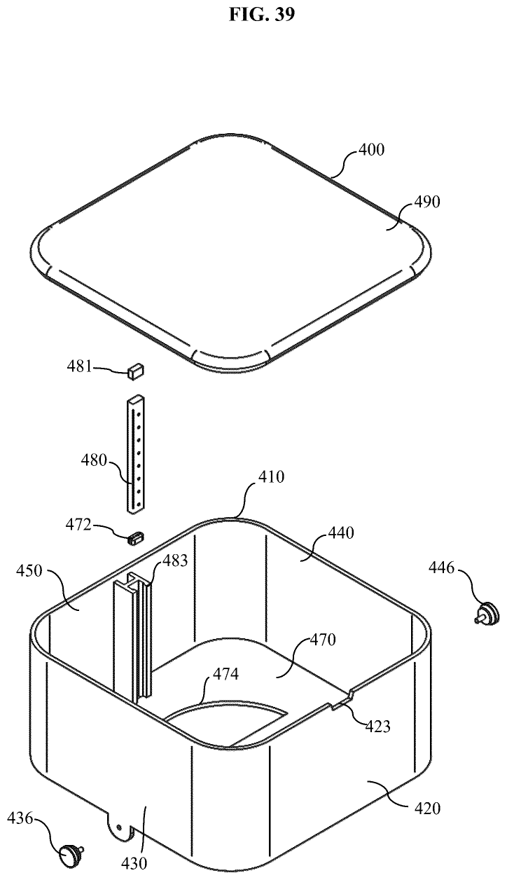

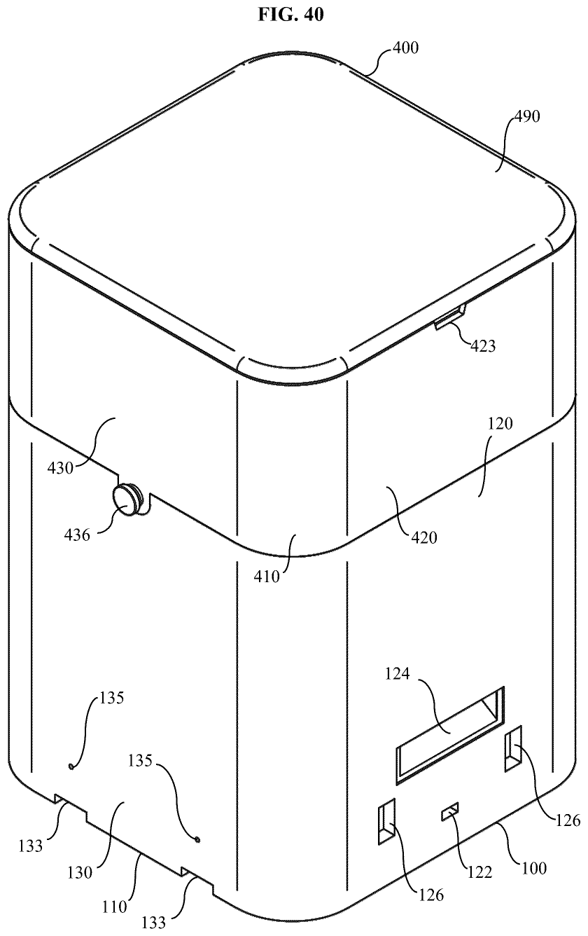

Referring now to another preferred embodiment of the present invention, FIG. 33, FIG. 34, FIG. 35, FIG. 36, FIG. 37, FIG. 38, FIG. 39, and FIG. 40, display a food container module 400, which is a module that may be mounted in top of a base feeder module 100 of a Modular Smart Pet Feeder. FIG. 33 depicts a front perspective view of a food container module 400. FIG. 34 demonstrates a bottom perspective view of a food container module 400. FIG. 35 displays a front view of a food container module 400. FIG. 36 shows a left side view of a food container module 400. FIG. 37 depicts a top view of a food container module 400. FIG. 38 illustrates a bottom view of a food container module 400. FIG. 39 displays an exploded perspective view of a food container module 400. FIG. 40 shows a front perspective view of a food container module 400. A food container is a required module for an operating Modular Smart Pet Feeder. Due to the modular nature of the Modular Smart Pet Feeder, various modular food containers may be used with a base feeder module 100, and the food container module 400 is one type of these modules with a food container.

In further detail, still referring to the invention of FIG. 33, FIG. 34, FIG. 35, FIG. 36, FIG. 37, FIG. 38, FIG. 39, and FIG. 40, a food container module 400 comprises a food container body 410, a food container lid 490, a food container level sensor 480, and a food container lid sensor 481. The food container body 410 comprises a food container front side 420, a food container left side 430, a food container right side 440, a food container rear side 450, and a food container bottom side 470, which are joined together as a single unit, which functions as a storage container for pet food. The food container front side 420 comprises a food container front slot 423, which allow the food container lid 490 to be gripped and lifted in order to fill the food container module 400 with pet food. The food container left side 430 comprises a food container left fastener 436, which depends from the bottom of the food container left side 430 and which allows the food container module 400 to be physically attached to the top of the base feeder module 100 using the base feeder left top mount receiver 132. The food container right side 440 comprises a food container right fastener 446, which depends from the bottom of the food container right side 440 and which allows the food container module 400 to be physically attached to the top of the base feeder module 100 using the base feeder right top mount receiver 142. The food container rear side 450 comprises a food container sensor mount 483 in the interior of the food container body 410 to which the food container level sensor 480 and the food container lid sensor 481 are mounted. The food container bottom side 470 comprises a food container bottom connector 472 and a food container bottom aperture 474. The container bottom connector 472 of the food container bottom side 470 of the food container module 400 comprises an electronic connector for receiving power from a module mounted in or on the base feeder module 100, such as the rotating dispenser module 200 using the rotating dispenser top connector 292 or the auger dispenser module 300 using the auger dispenser top connector 392, as described above, or the LED ring module 600 using the LED ring connector 692, as described below, and for facilitating electronic communications between the food container module 400 and the base feeder module 100, as well as any other modules, which may be connected to the base feeder module 100 including modules mounted between the food container module 400 and the base feeder module 100. The food container bottom aperture 474 comprises an opening in the food container bottom side 470, which allows food to fall into a food dispensing module mounted in the base feeder module 100, such as into the rotating dispenser top aperture 294 of the rotating dispenser module 200 or the auger dispenser top aperture 394 of the auger dispenser module 300, as described above, or into the LED ring top aperture 694 of the LED ring module 600, as described below. The food container bottom connector 472 is controllable by and communicates with the base feeder module 100. The food container lid 490 fits on top of the food container body 410 to prevent access to the stored pet food, is removable or openable to allow the food container module 400 to be refilled with pet food, and comprises a fitted panel. The inside of the food container body 410 of the food container module 400 comprises a food container level sensor 480, a food container lid sensor 481, and a food container sensor mount 483. The food container level sensor 480 comprises an electronic meter, which measures the level of pet food within the food container module 400 and relays the information through the food container bottom connector 472 and to the base feeder controller 180 of the base feeder module 100, where the data is used for predictive and preventative maintenance and statistical reporting. Using the food container level sensor 480, the rate of food consumption can be measured and used to order more food before the food runs out or to automatically order more food through the internet as food supplies dwindle. The food container lid sensor 481 comprises an electronic meter, which measures whether the food container lid 490 is firmly closed and relays the information through the food container bottom connector 472 and to the base feeder controller 180 of the base feeder module 100, where the data is used for predictive and preventative maintenance and statistical reporting, such as the frequency of opening or alarming when the lid is unexpectedly opened, or the like. The food container level sensor 480 and the food container lid sensor 481 are mounted on the food container sensor mount 483, which comprises a protrusion on the food container rear side 450 in the interior of the food container body 410. During operation, a user lifts the food container lid 490, fills the food container body 410 with pet food, and then places the food container lid 490 back onto the food container body 410. As the food is dispensed and consumed by the pet, the food container level sensor 480 measures the changing level of food inside the food container module 400 using the food container level sensor 480. As the food level in the food container module 400 diminishes, the food container level sensor 480 sends a signal to the base feeder controller 180 of the base feeder module 100 or to an external app, webpage, computer program, or the like, indicating that a food shortage is predicted, and the owner is notified that more food needs to be added to the food container module 400. The food container module 400 also keeps track of the total amount of food consumed since the last time pet food was ordered and is capable of automatically placing an online food order to make sure that the pet has a continuous supply of food. Food ordering may be predictive based on historical data collected by the Modular Smart Pet Feeder regarding how much a pet ate in the past and how much of food is left in the feeder as measured by the food container level sensor 480. The predictive maintenance system of the Modular Smart Pet Feeder, or a cloud-based system, estimates when the food will run out and then orders more food with delivery, taking into account the procurement and shipping time. In some embodiments of the present invention, ordering of food (or other parts) occurs using computing resources external to the Modular Smart Pet Feeder, such as one or more external servers, cloud-based computing, or the like. Modular variations of the food container module 400 include a version with a larger food container, a version with a translucent food container, and a version with a food container with two or more compartments for different types of pet food, which are mixed together by the dispensing mechanism. In some embodiments of the present invention, a food container module 400 is integrated into the base feeder module 100 along with a food dispensing mechanism, which are all joined together as a single unit.

The construction details of the invention as shown in FIG. 33, FIG. 34, FIG. 35, FIG. 36, FIG. 37, FIG. 38, FIG. 39, and FIG. 40, are as follows. The food container module 400 comprises a food container body 410, a food container lid 490, a food container level sensor 480, and a food container lid sensor 481. The food container body 410 comprises a food container front side 420, a food container left side 430, a food container right side 440, a food container rear side 450, and a food container bottom side 470, which are joined together as a single unit. The food container front side 420 comprises metal, steel, copper, plastic, high density plastic, silicone, PVC, fiber glass, carbon fiber, composite material, wood, galvanized steel, stainless steel, aluminum, brass, gold, silver, copper, or other like material. The food container front slot 423 comprises an indentation or handle in the food container lid 490, or the like, which allows a user to grip and lift the food container lid 490. The food container left side 430 comprises metal, steel, copper, plastic, high density plastic, silicone, PVC, fiber glass, carbon fiber, composite material, wood, galvanized steel, stainless steel, aluminum, brass, gold, silver, copper, or other like material. The food container left fastener 436 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The food container right side 440 comprises metal, steel, copper, plastic, high density plastic, silicone, PVC, fiber glass, carbon fiber, composite material, wood, galvanized steel, stainless steel, aluminum, brass, gold, silver, copper, or other like material. The food container right fastener 446 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The food container rear side 450 comprises metal, steel, copper, plastic, high density plastic, silicone, PVC, fiber glass, carbon fiber, composite material, wood, galvanized steel, stainless steel, aluminum, brass, gold, silver, copper, or other like material. The food container bottom side 470 comprises metal, steel, copper, plastic, high density plastic, silicone, PVC, fiber glass, carbon fiber, composite material, wood, galvanized steel, stainless steel, aluminum, brass, gold, silver, copper, or other like material. The food container bottom connector 472 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The food container bottom aperture 474 comprises an opening in the food container bottom side 470, or the like. The food container level sensor 480 comprises a sensor for measuring the level of food in the food container module 400, such as a light sensor, ambient light sensor, laser sensor, IR sensor, ultrasonic distance sensor, capacitive sensor, or the like and may also comprise a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The food container lid sensor 481 comprises a sensor for measuring whether the food container lid 490 is on the food container module 400, such as a light sensor, ambient light sensor, laser sensor, IR sensor, ultrasonic distance sensor, miniature snap-action switch, pressure switch, capacitive sensor, or the like. The food container sensor mounts 483 comprises a mount for the food container level sensor 480 and the food container lid sensor 481, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The food container lid 490 comprises metal, steel, copper, plastic, high density plastic, silicone, PVC, fiber glass, carbon fiber, composite material, wood, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

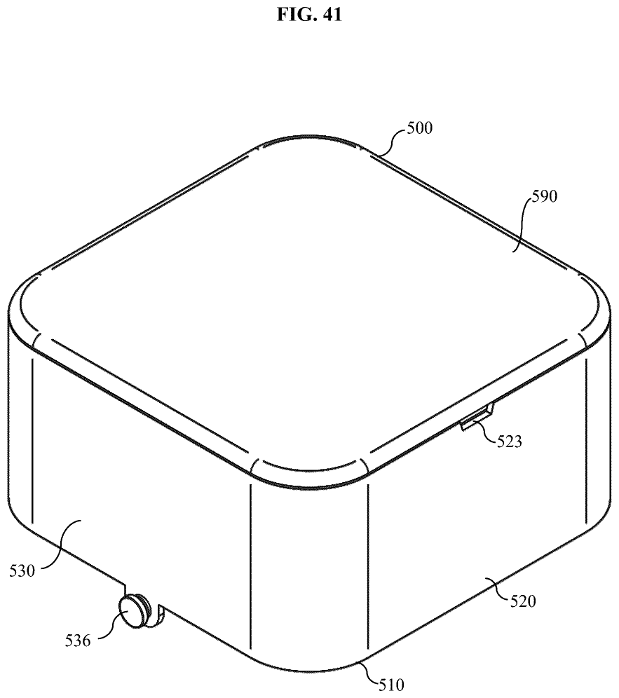

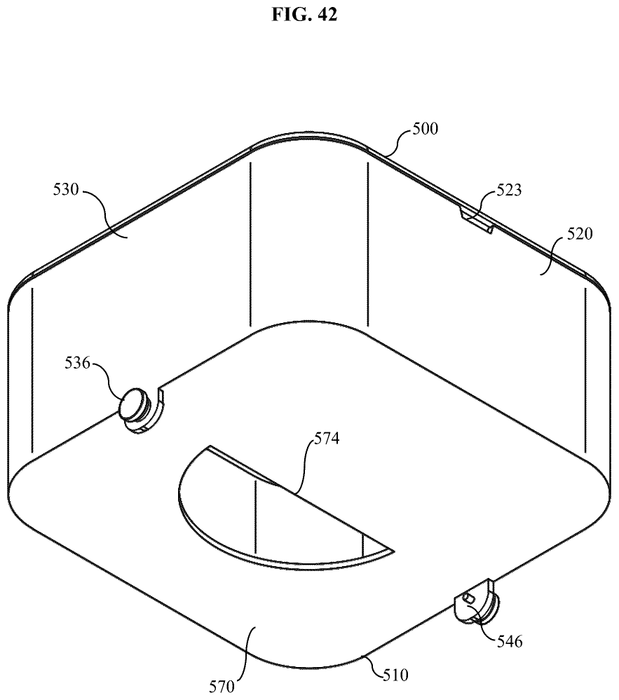

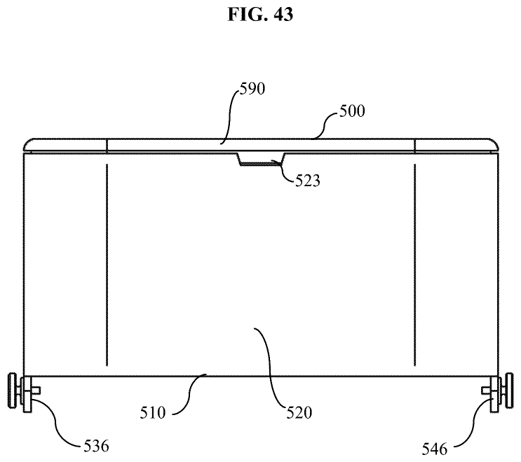

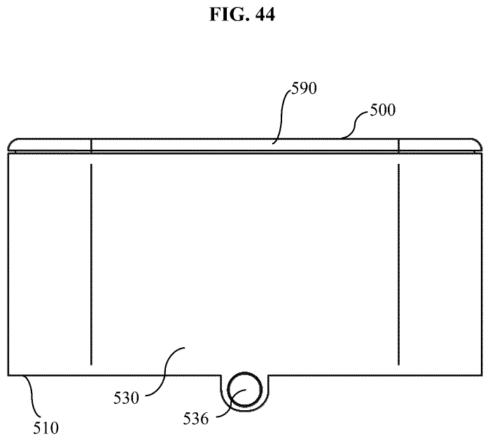

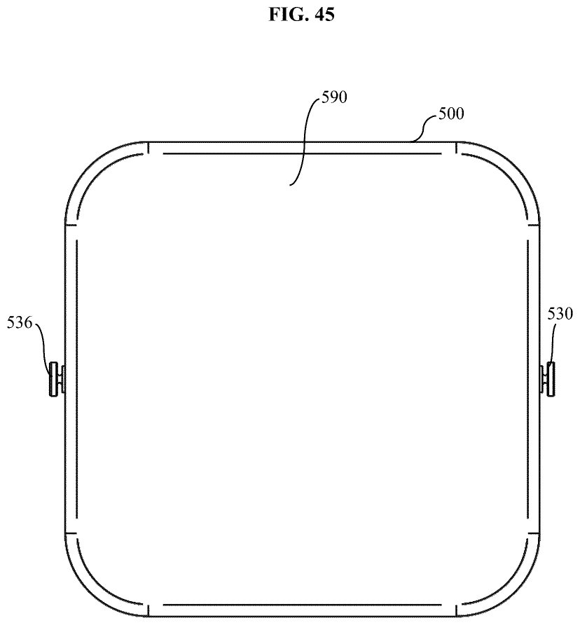

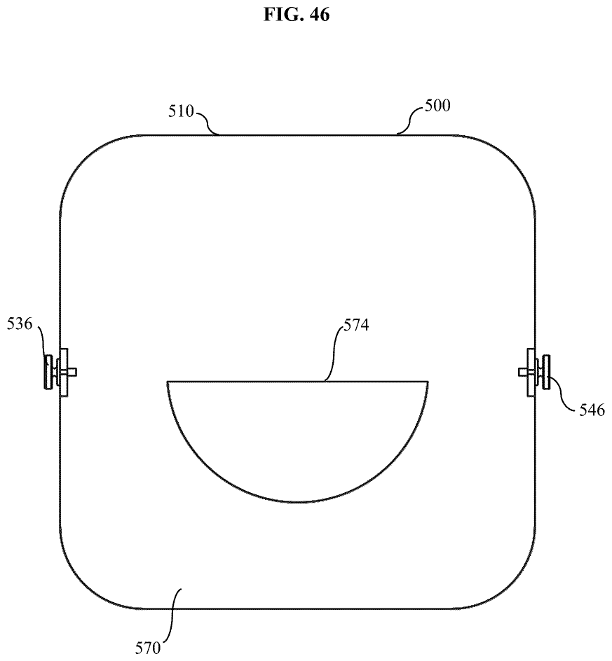

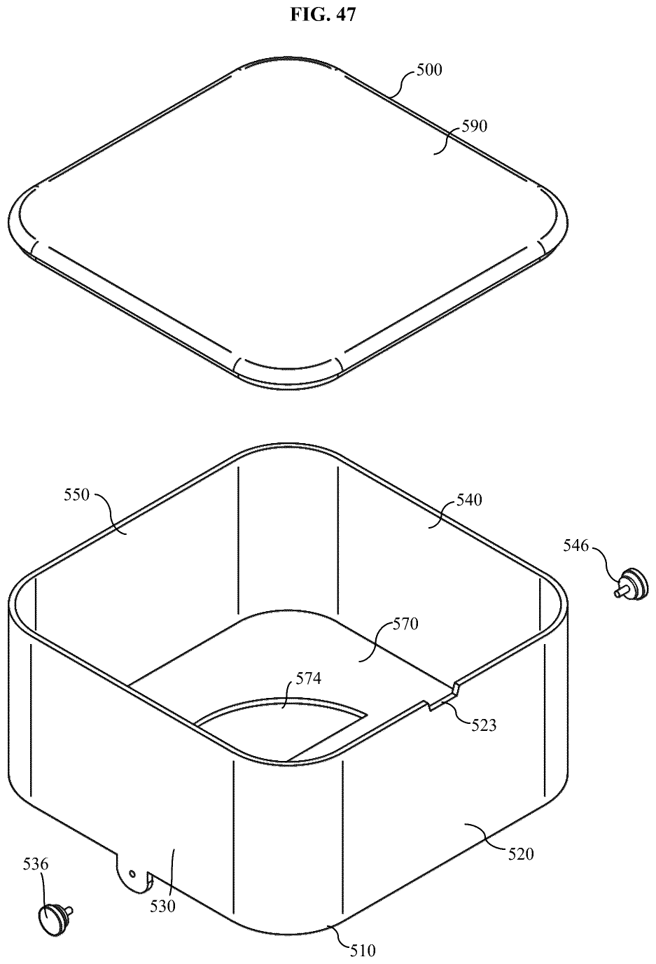

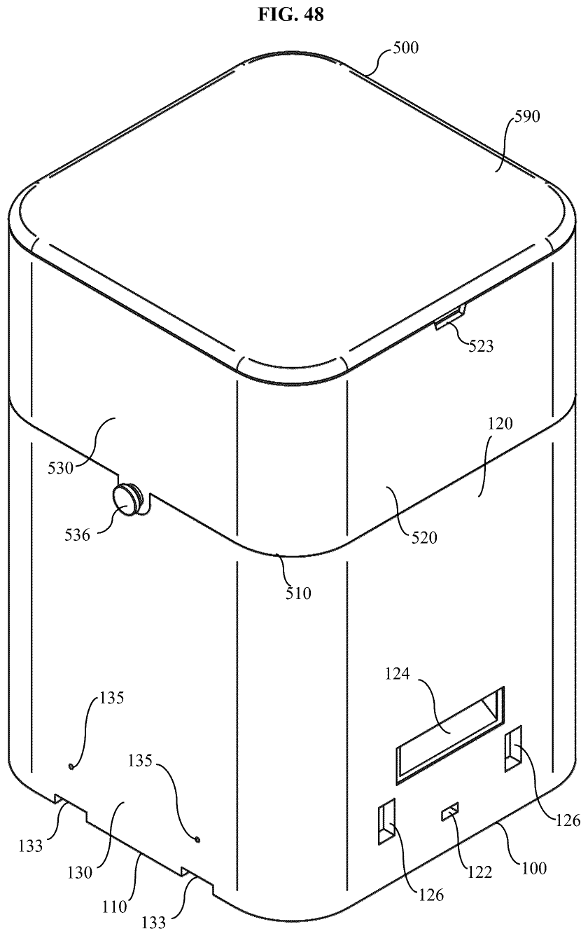

Referring now to another preferred embodiment of the present invention, FIG. 41, FIG. 42, FIG. 43, FIG. 44, FIG. 45, FIG. 46, FIG. 47, and FIG. 48, show a simple food container module 500, which is a module that may be mounted on top of a base feeder module 100 of a Modular Smart Pet Feeder. FIG. 41 depicts a front perspective view of a simple food container module 500. FIG. 42 illustrates a bottom perspective view of a simple food container module 500. FIG. 43 displays a front view of a simple food container module 500. FIG. 44 shows a left side view of a simple food container module 500. FIG. 45 depicts a top view of a simple food container module 500. FIG. 46 illustrates a bottom view of a simple food container module 500. FIG. 47 displays an exploded perspective view of a simple food container module 500. FIG. 48 shows a front perspective view of a simple food container module 500 mounted on a base feeder module 100.

In further detail, still referring to the invention of FIG. 41, FIG. 42, FIG. 43, FIG. 44, FIG. 45, FIG. 46, FIG. 47, and FIG. 48, a simple food container module 500 comprises a simple food container body 510 and a simple food container lid 590. The simple food container body 510 comprises a simple food container front side 520, a simple food container left side 530, a simple food container right side 540, a simple food container rear side 550, and a simple food container bottom side 570, which are joined together as a single unit, which functions as a storage container for pet food. The simple food container front side 520 comprises a simple food container front slot 523, which allow the simple food container lid 590 to be gripped and lifted in order to fill the simple food container module 500 with pet food. The simple food container left side 530 comprises a simple food container left fastener 536, which depends from the bottom of the simple food container left side 530 and which allows the simple food container module 500 to be physically attached to the top of the base feeder module 100 using the base feeder left top mount receiver 132. The simple food container right side 540 comprises a simple food container right fastener 546, which depends from the bottom of the simple food container right side 540 and which allows the simple food container module 500 to be physically attached to the top of the base feeder module 100 using the base feeder right top mount receiver 142. The simple food container rear side 550 comprises a panel. The simple food container bottom side 570 comprises a simple food container bottom aperture 574. The simple food container bottom aperture 574 comprises an opening in the simple food container bottom side 570, which allows food to fall into a food dispensing module mounted in the base feeder module 100, such as into the rotating dispenser top aperture 294 of the rotating dispenser module 200 or the auger dispenser top aperture 394 of the auger dispenser module 300, as described above, or into the LED ring top aperture 694 of the LED ring module 600, as described below. The simple food container lid 590 fits on top of the simple food container body 510 to prevent access to the stored pet food, is removable or openable to allow the simple food container module 500 to be refilled with pet food, and comprises a fitted panel. During operation, a user lifts the simple food container lid 590, fills the simple food container body 510 with pet food, and places the simple food container lid 590 back onto the simple food container body 510. When the food in the simple food container module 500 is completely consumed, the user then manually refills the simple food container module 500. Modular variations of the simple food container module 500 include a version with a larger food container, a version with a translucent food container, and a version with a food container with two or more compartments for different types of pet food, which are mixed together by the dispensing mechanism. In some embodiments of the present invention, a simple food container module 500 is integrated into the base feeder module 100 along with a food dispensing mechanism, which are all joined together as a single unit.

The construction details of the invention as shown in FIG. 41, FIG. 42, FIG. 43, FIG. 44, FIG. 45, FIG. 46, FIG. 47, and FIG. 48, are as follows. The simple food container module 500 comprises a simple food container body 510 and a simple food container lid 590. The simple food container body 510 comprises a simple food container front side 520, a simple food container left side 530, a simple food container right side 540, a simple food container rear side 550, and a simple food container bottom side 570, which are joined together as a single unit. The simple food container front side 520 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food container front slot 523 comprises an indentation or handle in the simple food container lid 590, or the like, which allows a user to grip and lift the simple food container lid 590. The simple food container left side 530 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food container left fastener 536 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The simple food container right side 540 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food container right fastener 546 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The simple food container rear side 550 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food container bottom side 570 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food container bottom aperture 574 comprises an opening in the simple food container bottom side 570, or the like. The simple food container lid 590 comprises metal, steel, copper, plastic, high density plastic, silicone, PVC, fiber glass, carbon fiber, composite material, wood, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

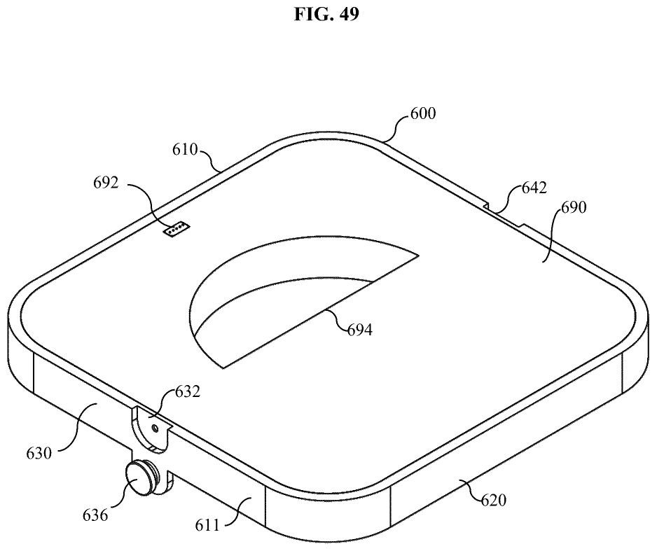

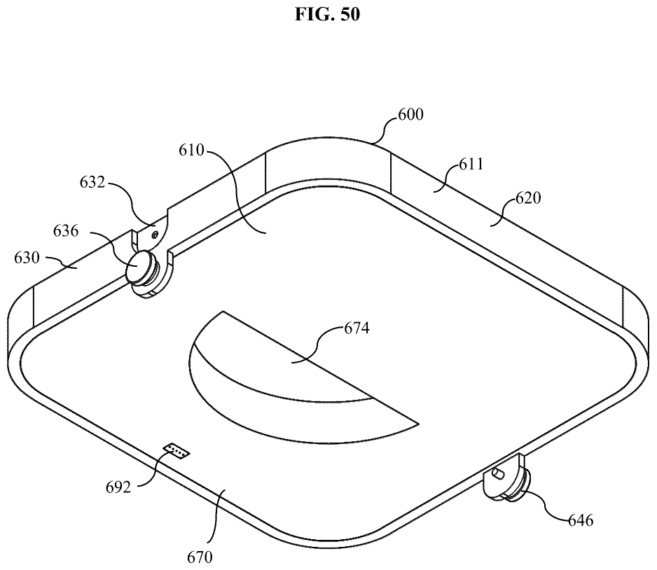

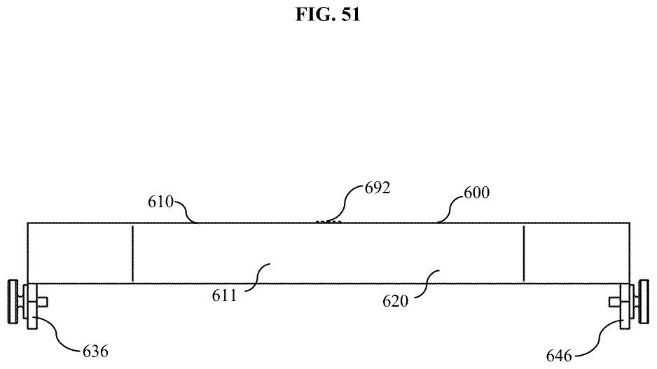

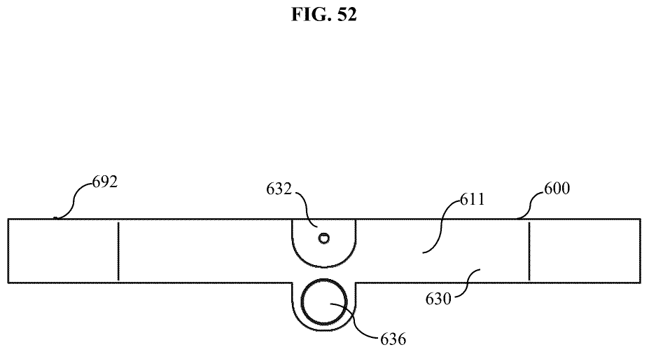

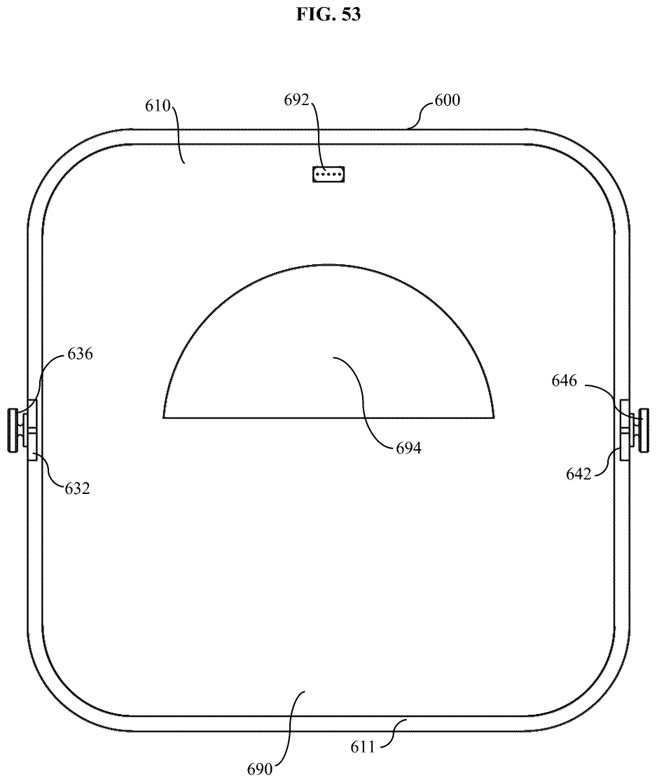

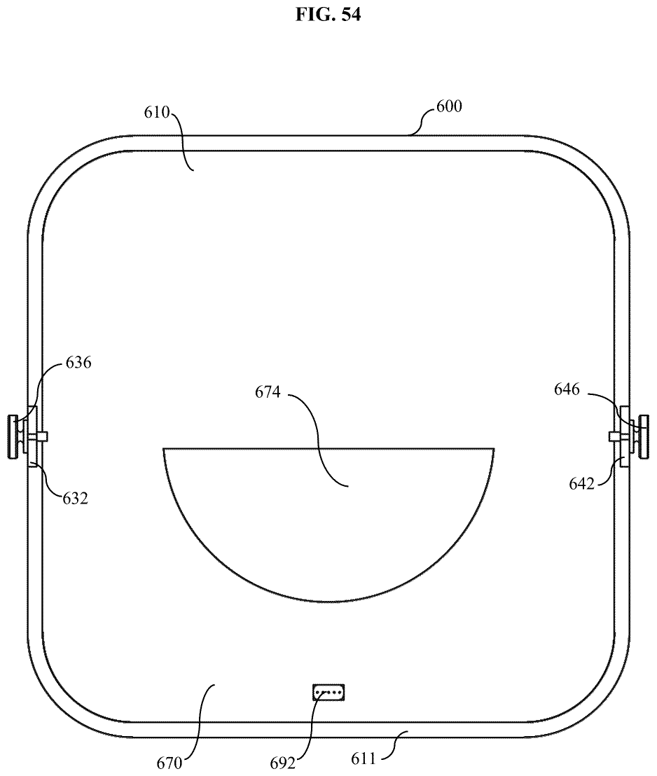

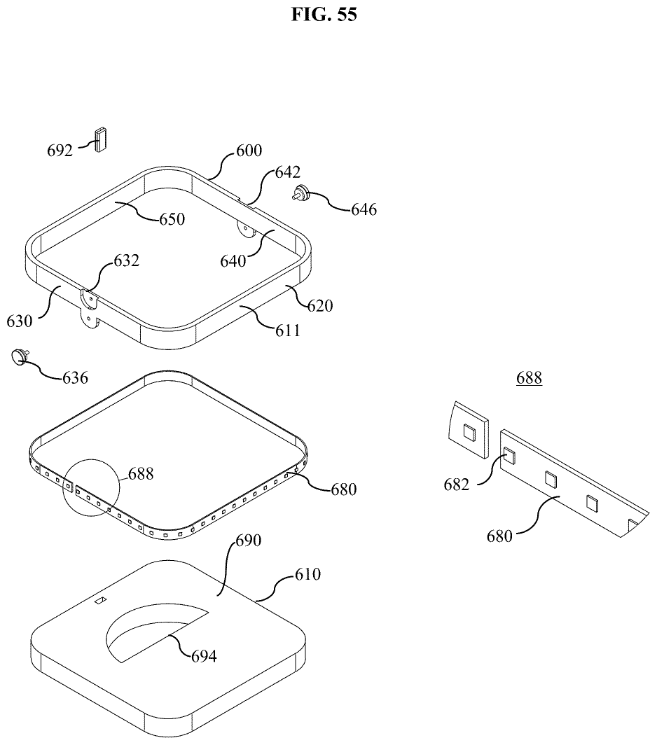

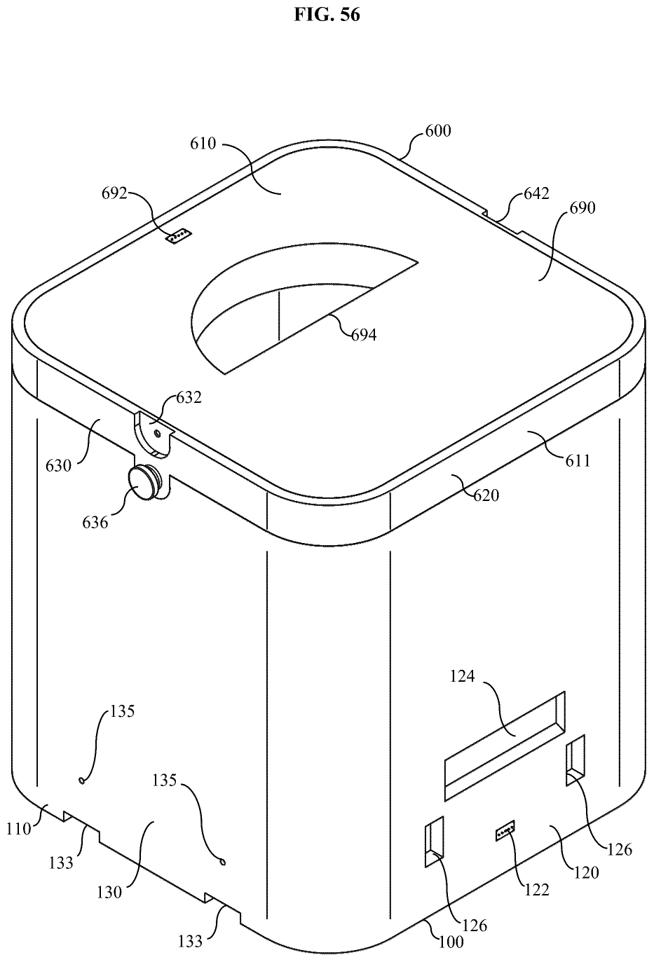

Referring now to another preferred embodiment of the present invention, FIG. 49, FIG. 50, FIG. 51, FIG. 52, FIG. 53, FIG. 54, FIG. 55, and FIG. 56, depict an LED ring module 600, which is an optional module that may be mounted on top of a base feeder module 100 of a Modular Smart Pet Feeder. FIG. 49 depicts a front perspective view of a LED ring module 600. FIG. 50 illustrates a bottom perspective view of an LED ring module 600. FIG. 51 displays a front view of an LED ring module 600. FIG. 52 shows a left side view of an LED ring module 600. FIG. 53 depicts a top view of an LED ring module 600. FIG. 54 illustrates a bottom view of an LED ring module 600. FIG. 55 displays an exploded perspective view of an LED ring module 600. FIG. 56 shows a front perspective view of an LED ring module 600 mounted on a base feeder module 100. The LED ring module 600 is intended to provide stimulation for a pet to encourage feeding, such as by simulating motion that increases speed as a feeding time approaches. The LED ring module 600 is also decorative and customizable to a user's personal taste.

In further detail, still referring to the invention of FIG. 49, FIG. 50, FIG. 51, FIG. 52, FIG. 53, FIG. 54, FIG. 55, and FIG. 56, an LED ring module 600 comprises an LED ring inner body 610, an LED ring outer body 611, and LED ring light strip 680. The LED ring inner body 610 comprises an LED ring top side 690, an LED ring bottom side 670, and an LED ring connector 692. The LED ring top side 690 comprises an LED ring top aperture 694, which comprises an opening in the LED ring top side 690, which allows food to fall from a module mounted above the LED ring module 600, such as out of a food container bottom aperture 474 of a food container module 400 or out of a simple food container bottom aperture 574 of a simple food container module 500 as described above, and through the LED ring inner body 610 of the LED ring module 600. The LED ring bottom side 670 comprises an LED ring bottom aperture 674, which comprises an opening in the LED ring bottom side 670, which allows food to fall through the LED ring inner body 610 of the LED ring module 600 and into a food dispensing module mounted in the base feeder module 100, such as into the rotating dispenser top aperture 294 of the rotating dispenser module 200 or the auger dispenser top aperture 394 of the auger dispenser module 300, as described above. The LED ring top aperture 694 and the LED ring bottom aperture 674 are vertically aligned to allow pet food to easily pass through the LED ring inner body 610 of the LED ring module 600. The LED ring connector 692 of the LED ring inner body 610 extends through the width of the LED ring inner body 610 and is exposed on both the LED ring top side 690 and the LED ring bottom side 670. The LED ring connector 692 comprises an electronic connector for receiving power from a module mounted in the base feeder module 100, such as the rotating dispenser module 200 using the rotating dispenser top connector 292 or the auger dispenser module 300 using the auger dispenser top connector 392, as described above, and passing power through the LED ring module 600 to a module mounted on top of it, such as through the food container bottom connector 472 of the food container module 400, as described above. The LED ring connector 692 is controllable by and communicates with the base feeder controller 180 of the base feeder module 100. The LED ring connector 692 also facilitates electronic communications between the LED ring module 600 and the base feeder module 100 through a module mounted in the base feeder module 100, such as the rotating dispenser module 200 using the rotating dispenser top connector 292 and the rotating dispenser bottom connector 272 or the auger dispenser module 300 using the auger dispenser top connector 392 and the auger dispenser bottom connector 372, as described above, as well as any other modules, which may be connected to the base feeder module 100 or the LED ring module 600. The LED ring connector 692 can also send data from the LED ring module 600 for the purposes of predictive or preventative maintenance or for reporting statistical information about its functionality, such as predicting when the LED ring light strip 680 needs to be replaced or when the LED ring connector 692, which is a conduit for power and communications for other critical modules, may fail so that the module may be replaced to ensure functionality during critical times, such as when a pet owner is away. The LED ring outer body 611 comprises an LED ring front side 620, an LED ring left side 630, an LED ring right side 640, and an LED ring rear side 650, which are joined together as a single unit. The LED ring front side 620 comprises a light diffuser for light generated by the LED ring light strip 680. The LED ring left side 630 comprises a light diffuser for light generated by the LED ring light strip 680; an LED ring left fastener 636, which depends from the bottom of the LED ring left side 630 and which allows the LED ring module 600 to be physically attached to the top of the base feeder module 100 using the base feeder left top mount receiver 132, as described above; and an LED ring left mount receiver 632, which comprises an indentation with an attachment point for receiving mounting hardware from other modules, which may be mounted on top of the LED ring module 600, such as a food container module 400 using the food container left fastener 436 or a simple food container module 500 using the simple food container left fastener 536, as described above. The LED ring right side 640 comprises a light diffuser for light generated by the LED ring light strip 680; an LED ring right fastener 646, which depends from the bottom of the LED ring right side 640 and which allows the LED ring module 600 to be physically attached to the top of the base feeder module 100 using the base feeder right top mount receiver 142, as described above; and an LED ring right mount receiver 642, which comprises an indentation with an attachment point for receiving mounting hardware from other modules, which may be mounted on top of the LED ring module 600, such as a food container module 400 using the food container right fastener 446 or a simple food container module 500 using the simple food container right fastener 546, as described above. The LED ring rear side 650 comprises a light diffuser for light generated by the LED ring light strip 680. The LED ring light strip 680 comprises a strip of LED ring LED lights 682 (as shown in LED ring close up view 688) with a light controller, which is disposed between the LED ring inner body 610 and the LED ring outer body 611, which is powered by power fed into the LED ring connector 692, and which is controlled by the base feeder controller 180 of the base feeder module 100 through the LED ring connector 692 and through a module mounted in the base feeder module 100, such as the rotating dispenser module 200 using the rotating dispenser top connector 292 or the auger dispenser module 300 using the auger dispenser top connector 392, as described above. The LED ring light strip 680 is capable of illuminating the various LED ring LED lights 682 at different times and with different colors in order to generate a variety of patterns or simulate motion or animation. During operation, the LED ring light strip 680 provides illumination through the light diffusers of the LED ring outer body 611, and may simulate a spinning pattern around the LED ring module 600, which increases in frequency as a feeding time approaches, thereby attracting a pet to the Modular Smart Pet Feeder and creating excitement for the pet to encourage feeding. The LED ring module 600 may also generate customizable patterns, colors, and animations to fit the desire of a pet owner user. The user may modify colors, intensity, speed, the order of LED illumination, and the number illuminated. If a single pet feeder is feeding two pets, the user can set a pattern for each pet. In addition, the brightness may auto-adjust according to the time based on user's geo-location, which may be specified when setting up the Modular Smart Pet Feeder. Brightness can also auto-adjust according to the ambient brightness. Moreover, special pattern can be set for night time to allow the feeder to function as a night light. In some embodiments of the present invention, an LED ring module 600 is integrated into a base feeder module 100 along with a pet food storage compartment and a food dispensing mechanism, which are all joined together as a single unit. In other versions of the present invention, a light fixture module comprising one or more light sources is used in place of an LED ring module 600, and the one or more light sources comprise a customizable pattern, which changes as feeding time approaches. In other embodiments of the present invention, the light pattern changes depending on a pet's weigh as measured by a pet weight scale. For a multi-pet household, other embodiments of the present invention may change patterns depending on which pet approaches the feeder or on which pet is detected by a pet detection system.

The construction details of the invention as shown in FIG. 49, FIG. 50, FIG. 51, FIG. 52, FIG. 53, FIG. 54, FIG. 55, and FIG. 56, are as follows. The LED ring module 600 comprises an LED ring inner body 610, an LED ring outer body 611, and LED ring light strip 680. The LED ring inner body 610 comprises an LED ring top side 690, an LED ring bottom side 670, and an LED ring connector 692. The LED ring outer body 611 comprises an LED ring front side 620, an LED ring left side 630, an LED ring right side 640, and an LED ring rear side 650, which are joined together as a single unit. The LED ring front side 620 comprises metal, steel, copper, plastic, high density plastic, silicone, PVC, fiber glass, carbon fiber, composite material, wood, galvanized steel, stainless steel, aluminum, brass, gold, silver, copper, or other like material. The LED ring left side 630 comprises metal, steel, copper, plastic, high density plastic, silicone, PVC, fiber glass, carbon fiber, composite material, wood, galvanized steel, stainless steel, aluminum, brass, gold, silver, copper, or other like material. The LED ring left mount receiver 632 comprises an indentation with an attachment point for receiving mounting hardware from other modules, which may be mounted on top of the LED ring module 600. The LED ring left fastener 636 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The LED ring right side 640 comprises metal, steel, copper, plastic, high density plastic, silicone, PVC, fiber glass, carbon fiber, composite material, wood, galvanized steel, stainless steel, aluminum, brass, gold, silver, copper, or other like material. The LED ring right mount receiver 642 comprises an indentation with an attachment point for receiving mounting hardware from other modules, which may be mounted on top of the LED ring module 600. The LED ring right fastener 646 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The LED ring rear 650 comprises metal, steel, copper, plastic, high density plastic, silicone, PVC, fiber glass, carbon fiber, composite material, wood, galvanized steel, stainless steel, aluminum, brass, gold, silver, copper, or other like material. The LED ring bottom side 670 comprises metal, steel, copper, plastic, high density plastic, silicone, PVC, fiber glass, carbon fiber, composite material, wood, galvanized steel, stainless steel, aluminum, brass, gold, silver, copper, or other like material. The LED ring bottom aperture 674 comprises an opening in the LED ring bottom side 670, or the like. The LED ring light strip 680 comprises an electronic strip with one or more light emitting diodes (LEDs) embedded, which may also comprise a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The LED ring LEDs 682 comprise a light source, such as light emitting diodes (LEDs), or the like. The LED ring light diffuser 689 comprises a translucent or transparent material, which lets light through comprising plastic, high density plastic, silicone, PVC, fiber glass, carbon fiber, composite material, glass, or other like material. The LED ring top side 690 comprises metal, steel, copper, plastic, high density plastic, silicone, PVC, fiber glass, carbon fiber, composite material, wood, galvanized steel, stainless steel, aluminum, brass, gold, silver, copper, or other like material. The LED ring connector 692 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The LED ring top aperture 694 comprises an opening in the LED ring top side 690, or the like. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

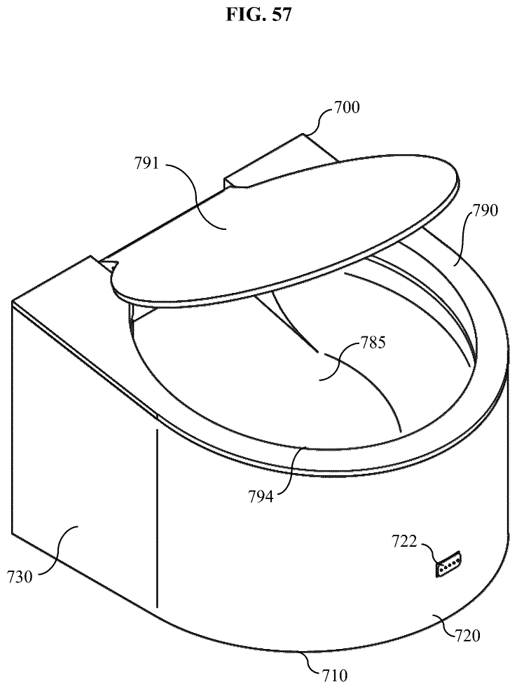

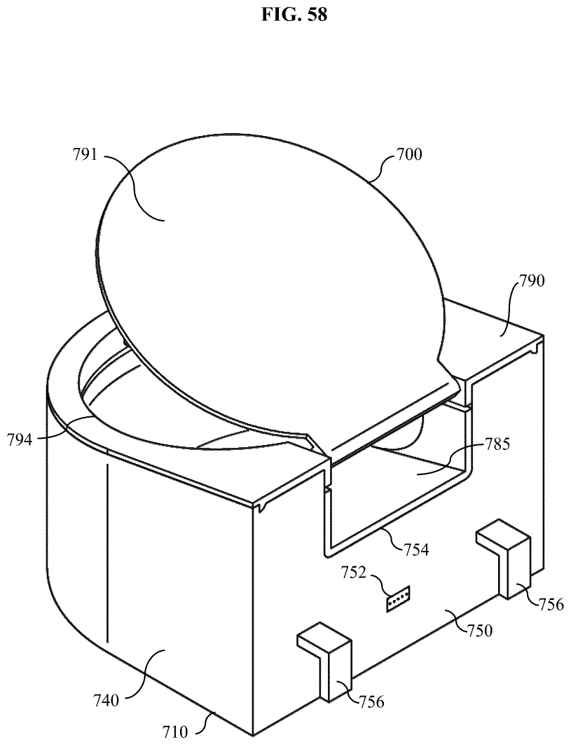

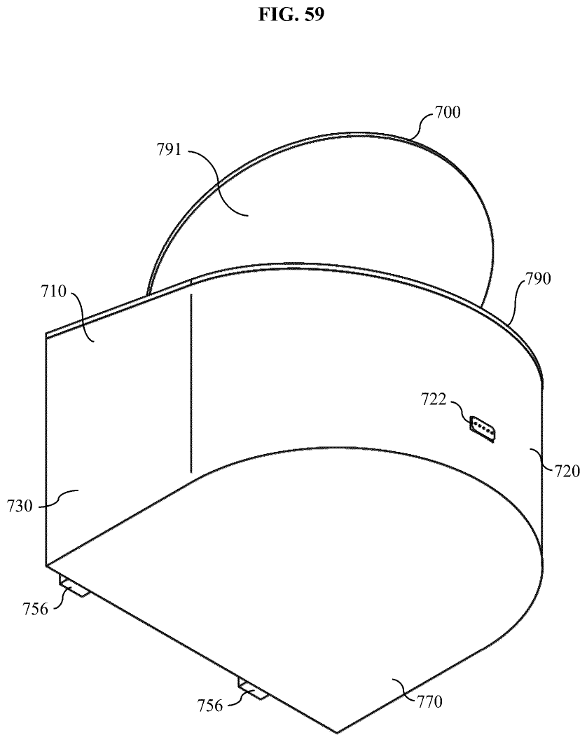

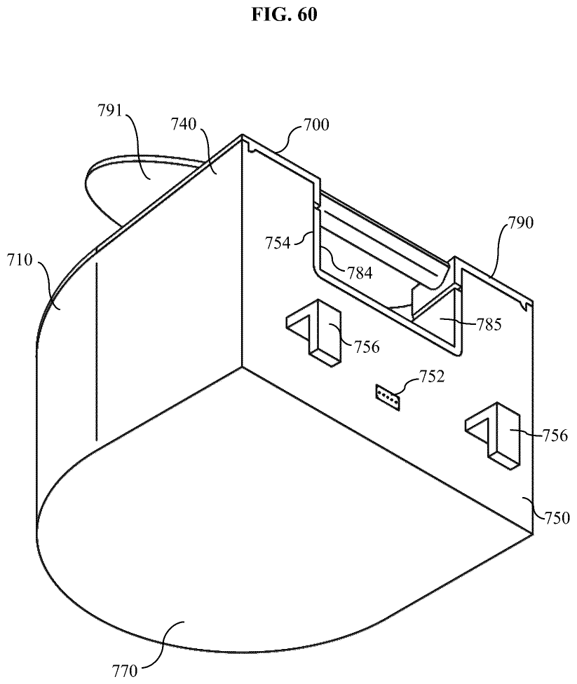

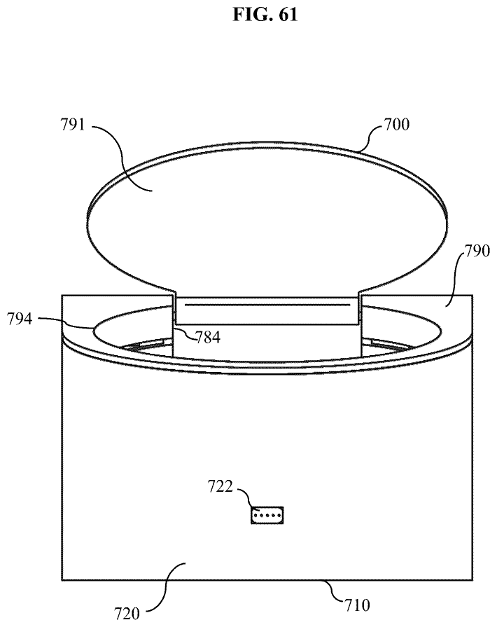

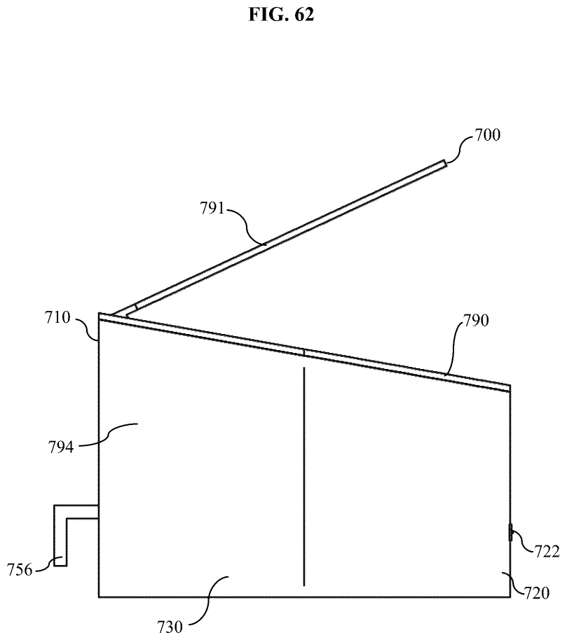

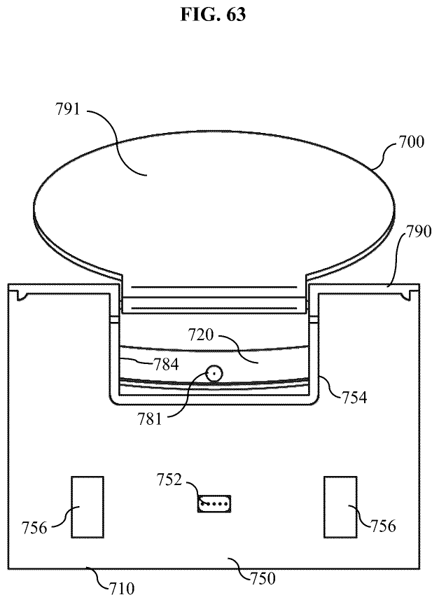

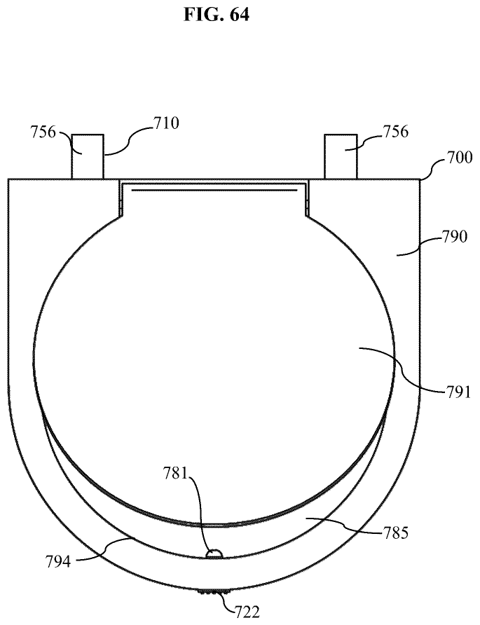

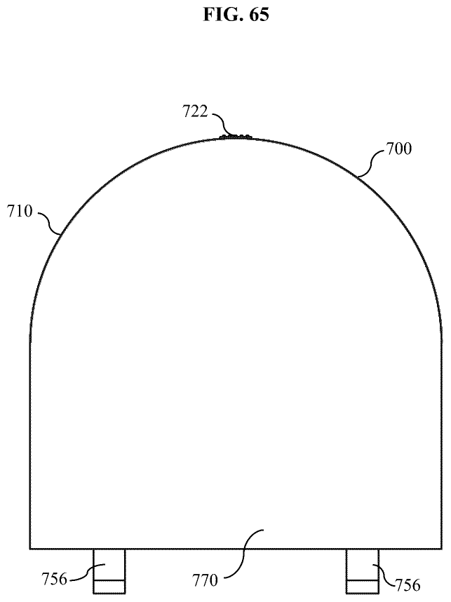

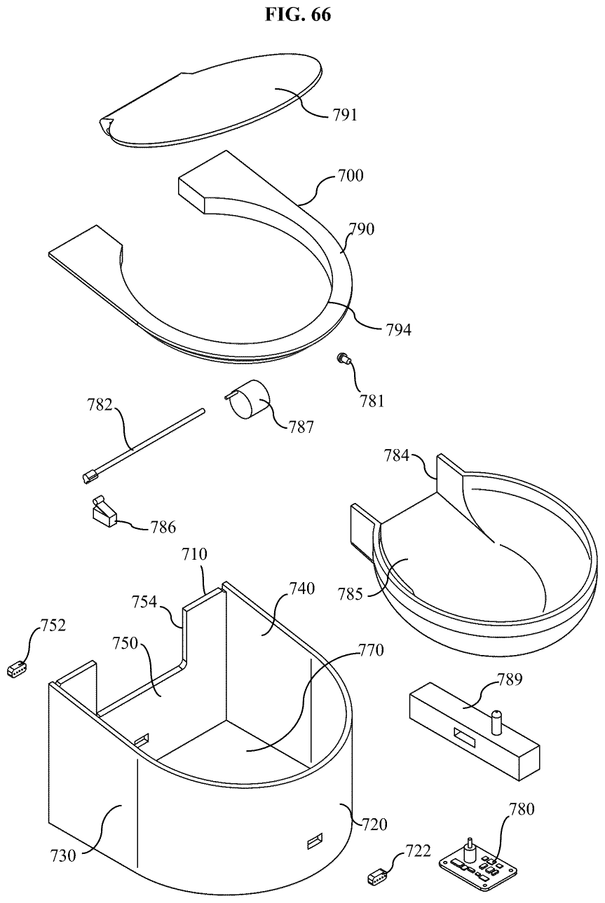

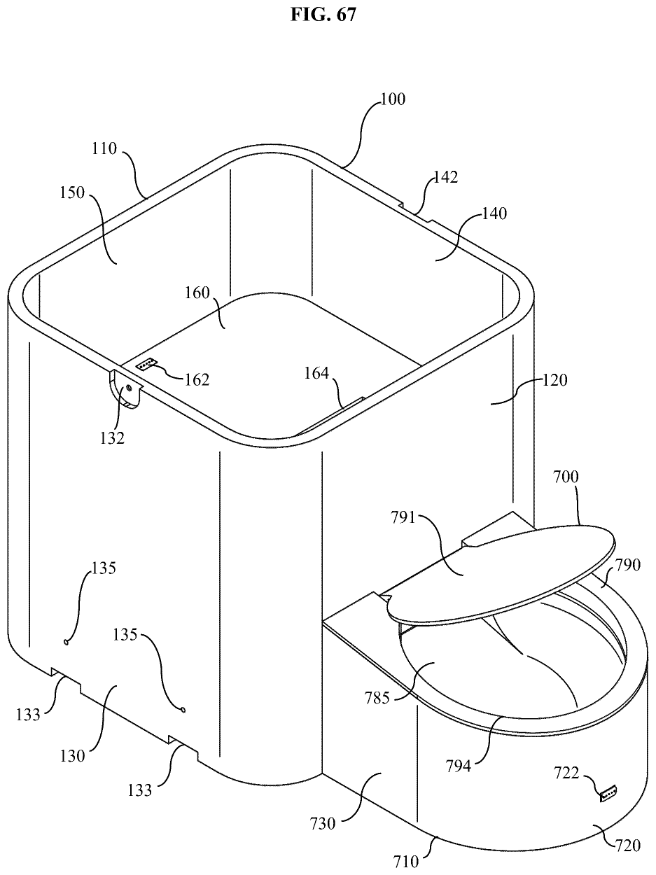

Referring now to another preferred embodiment of the present invention, FIG. 57, FIG. 58, FIG. 59, FIG. 60, FIG. 61, FIG. 62, FIG. 63, FIG. 64, FIG. 65, FIG. 66, and FIG. 67, illustrate a food bowl module 700, which is an optional module that may be mounted on the base feeder front side 120 of a base feeder module 100 of a Modular Smart Pet Feeder. FIG. 57 depicts a front perspective view of a food bowl module 700. FIG. 58 illustrates a rear perspective view of a food bowl module 700. FIG. 59 displays a front bottom perspective view of a food bowl module 700. FIG. 60 shows a rear bottom perspective view of a food bowl module 700. FIG. 61 depicts a front view of a food bowl module 700. FIG. 62 illustrates a left side view of a food bowl module 700. FIG. 63 demonstrates a rear view of a food bowl module 700. FIG. 64 shows a top view of a food bowl module 700. FIG. 65 depicts a bottom view of a food bowl module 700. FIG. 66 illustrates an exploded perspective view of a food bowl module 700. FIG. 67 displays a front perspective view of a food bowl module 700 mounted on a base feeder module 100.

In further detail, still referring to the invention of FIG. 57, FIG. 58, FIG. 59, FIG. 60, FIG. 61, FIG. 62, FIG. 63, FIG. 64, FIG. 65, FIG. 66, and FIG. 67, a food bowl module 700 comprises a food bowl body 710, a food bowl dish 785, a food bowl top side 790, a food bowl lid 791, and a food bowl controller 780. The food bowl body 710 comprises a food bowl front side 720, a food bowl left side 730, a food bowl right side 740, a food bowl rear side 750, and a food bowl bottom side 770, which are joined together as a single unit. The food bowl front side 720 comprises a food bowl front connector 722, which comprises an electronic connector for sending power to a module mounted on the front of a food bowl module 700, such as the weight scale module 900 using the weight scale rear connector 952, as described below. The food bowl front connector 722 also facilitates electronic communications between the food bowl module 700 and a module mounted on the front of a food bowl module 700, such as the weight scale module 900 using the weight scale rear connector 952 as described below, as well as any other modules, which may be connected to the food bowl module 700 or connected to a module mounted on the front of a food bowl module 700. The food bowl front connector 722 is controllable by and communicates with the food bowl controller 780 and/or the base feeder controller 180 of the base feeder module 100. The food bowl front connector 722 can also send data from a module mounted on the front of a food bowl module 700 for the purposes of predictive or preventative maintenance or for reporting statistical information about its functionality, such as predicting when the module or a part of the module needs to be replaced or when the food bowl front connector 722, which is a conduit for power and communications for other modules, may fail so that the module may be replaced to ensure functionality during critical times, such as when a pet owner is away.. The food bowl left side 730 comprises a side panel, which conceals and protects the internal electronics of the food bowl module 700. The food bowl right side 740 comprises a side panel, which conceals and protects the internal electronics of the food bowl module 700. The food bowl rear side 750 comprises a food bowl rear connector 752, a food bowl rear aperture 754, and food bowl rear hooks 756. The food bowl rear connector 752 comprises an electronic connector for receiving power from a base feeder module 100 when the food bowl module 700 is mounted on a base feeder module 100, for powering the internal electronics of the food bowl module 700 and for passing power through the food bowl module 700 to a module mounted on the front of it through the food bowl front connector 722, as described above. The food bowl rear connector 752 also facilitates electronic communications between the base feeder module 100 and a connected food bowl module 700, as well as any other modules, which may be connected to the food bowl module 700, such as the weight scale module 900 using the weight scale rear connector 952, as described below. The food bowl rear connector 752 is controllable by and communicates with the food bowl controller 780 and/or the base feeder controller 180 of the base feeder module 100. The food bowl rear connector 752 can also send data from a connected food bowl module 700 or a module mounted on the front of a food bowl module 700 for the purposes of predictive or preventative maintenance or for reporting statistical information about its functionality, such as predicting when the module or a part of the module needs to be replaced or when the food bowl rear connector 752, which is a conduit for power and communications for other modules, may fail so that the module may be replaced to ensure functionality during critical times, such as when a pet owner is away. The food bowl rear aperture 754 comprises an opening, which aligns with the base feeder front aperture 124 of the base feeder module 100 when the food bowl module 700 is mounted on a base feeder module 100, and receives food from the base feeder food ramp 185 of the base feeder module 100 during a pet feeding time. The food bowl rear hooks 756 comprise hook-shaped protrusions depending from the back of the food bowl rear side 750 and which allows the food bowl module 700 to be physically attached to the base feeder front side 120 of the base feeder module 100 using the base feeder front mount receivers 126. The food bowl bottom side 770 comprises a bottom panel, which serves as a base for the food bowl module 700 and conceals and protects the internal electronics of the food bowl module 700. The food bowl dish 785 comprises a downwardly angled feeding bowl insert, which fits on top of the food bowl body 710; a food bowl dish aperture 784; a food bowl weight scale 789; and a food bowl UV light 781. The food bowl dish aperture 784 comprises an opening, which aligns with the food bowl rear aperture 754 of the food bowl rear side 750 and allows pet food to enter the food bowl dish 785 from the base feeder food ramp 185 of the base feeder module 100 during feeding times. The food bowl UV light 781 extends through the side of the food bowl dish 785, comprises an ultraviolet (UV) light source, and is capable of sterilizing the food bowl dish 785 after a pet has eaten by exposing the interior of the food bowl dish 785 to UV light when the food bowl lid 791 is closed. The food bowl weight scale 789 comprises an electronic scale, which attaches to the bottom of the food bowl dish 785 of the food bowl module 700; which measures the weight of the contents of the food bowl dish 785 and relays the data to the food bowl controller 780 and/or the base feeder controller 180 of the base feeder module 100 for monitoring, reporting, predictive maintenance, and/or preventative maintenance; which is concealed under the food bowl dish 785 inside the food bowl body 710; and which is controllable by and communicates with the food bowl controller 780 and/or the base feeder controller 180 of the base feeder module 100. The food bowl top side 790 is a panel, which fits on top of the food bowl body 710, and comprises a food bowl top aperture 794. The food bowl top aperture 794 comprises an opening in the food bowl top side 790, which allows access for a pet to feed from the food bowl dish 785. The food bowl lid 791 comprises an openable and closable panel, which fits over the food bowl top aperture 794 of the food bowl top side 790 and either allows or denies access to the food bowl dish 785; a food bowl axle 782; a food bowl lid switch 786; and a food bowl motor 787; and is controllable by the food bowl controller 780. The food bowl axle 782 is mounted on the food bowl motor 787 and comprises a rigid shaft with a protrusion that acts like a crankshaft, which triggers the food bowl lid switch 786 during rotation. The food bowl lid switch 786 comprises a switch, which is triggered by the food bowl axle 782 during rotation and which can turn the food bowl motor 787 on or off, and is controllable by and communicates with the food bowl controller 780 and/or the base feeder controller 180 of the base feeder module 100. A hall sensor may also be used instead of a switch. The food bowl motor 787 is controllable by and communicates with the food bowl controller 780 and/or the base feeder controller 180 of the base feeder module 100 and/or the food bowl lid switch 786; is capable of rotating the food bowl axle 782, which in turn rotates to trigger food bowl lid switch 786; and comprises an electric motor or the like. The food bowl controller 780 comprises a printed circuit board (PCB) with a memory and one or more processors for controlling, managing, and monitoring the food bowl module 700 as well as various modules, which may be attached to the food bowl front side 720 of the food bowl module 700 using the food bowl front side 720, and for communicating with the base feeder module 100. The food bowl controller 780 may also comprise wireless connectivity, Bluetooth, Near Field Communication (NFC), internet connectivity, network connectivity, or the like. The food bowl controller 780 is also capable of monitoring the functional parameters of various components of the food bowl module 700, such as by monitoring the status of the food bowl UV light 781, the food bowl motor 787, and/or the food bowl weight scale 789, and predicting when they need to be replaced, as well as being capable of monitoring the functional parameters of various connected modules or communicating those parameters to the base feeder module 100 for monitoring, in order to facilitate preventive and predictive maintenance and report data, which may be displayed in an app, webpage, computer program, or the like. During operation, when a pet's feeding time occurs, as determined by the base feeder controller 180 of the base feeder module 100 through timing or user initiation, the base feeder controller 180 causes food to be dispensed from the base feeder food ramp 185 of the base feeder module 100 through the food bowl dish aperture 784 and into the food bowl dish 785. Next, the food bowl controller 780 activates the food bowl motor 787 thereby causing the food bowl lid 791 to start to open. Next, when the food bowl axle 782 triggers the food bowl lid switch 786, the food bowl lid switch 786 stops the food bowl motor 787 thereby leaving the food bowl lid 791 open and making the food bowl dish 785 accessible for pet feeding. The food bowl lid 791 remains open for a preprogramed amount of time or until the food bowl weight scale 789 measures the consumption of a preselected amount of food by weight and sends this data to the food bowl controller 780 and/or the base feeder controller 180 of the base feeder module 100. Next, the food bowl controller 780 activates the food bowl motor 787 thereby causing the food bowl lid 791 to start to close. Lastly, when the food bowl axle 782 triggers the food bowl lid switch 786, the food bowl lid switch 786 stops the food bowl motor 787 thereby leaving the food bowl lid 791 closed and preventing a pet from accessing the food bowl dish 785 until the next feeding time.

The construction details of the invention as shown in FIG. 57, FIG. 58, FIG. 59, FIG. 60, FIG. 61, FIG. 62, FIG. 63, FIG. 64, FIG. 65, FIG. 66, and FIG. 67, are as follows. The food bowl module 700 comprises a food bowl body 710, a food bowl dish 785, a food bowl top side 790, a food bowl lid 791, and a food bowl controller 780. The food bowl body 710 comprises a food bowl front side 720, a food bowl left side 730, a food bowl right side 740, a food bowl rear side 750, and a food bowl bottom side 770, which are joined together as a single unit. The food bowl front side 720 comprises metal, steel, copper, plastic, high density plastic, silicone, PVC, fiber glass, carbon fiber, composite material, wood, galvanized steel, stainless steel, aluminum, brass, gold, silver, copper, or other like material. The food bowl front connector 722 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The food bowl left side 730 comprises metal, steel, copper, plastic, high density plastic, silicone, PVC, fiber glass, carbon fiber, composite material, wood, galvanized steel, stainless steel, aluminum, brass, gold, silver, copper, or other like material. The food bowl right side 740 comprises metal, steel, copper, plastic, high density plastic, silicone, PVC, fiber glass, carbon fiber, composite material, wood, galvanized steel, stainless steel, aluminum, brass, gold, silver, copper, or other like material. The food bowl rear side 750 comprises metal, steel, copper, plastic, high density plastic, silicone, PVC, fiber glass, carbon fiber, composite material, wood, galvanized steel, stainless steel, aluminum, brass, gold, silver, copper, or other like material. The food bowl rear connector 752 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The food bowl rear aperture 754 comprises an opening in the food bowl rear side 750. The food bowl rear hooks 756 comprise hook-shaped protrusions depending from the back of the food bowl rear side 750 and comprising metal, steel, copper, plastic, high density plastic, silicone, PVC, fiber glass, carbon fiber, composite material, wood, galvanized steel, stainless steel, aluminum, brass, gold, silver, copper, or other like material. The food bowl bottom side 770 comprises metal, steel, copper, plastic, high density plastic, silicone, PVC, fiber glass, carbon fiber, composite material, wood, galvanized steel, stainless steel, aluminum, brass, gold, silver, copper, or other like material. The food bowl controller 780 comprises a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The food bowl UV light 781 comprises an ultraviolet (UV) light source, such as an UV LED and its accompanying electronics, or the like. The food bowl axle 782 comprises a rigid shaft comprising metal, steel, copper, plastic, high density plastic, silicone, PVC, fiber glass, carbon fiber, composite material, wood, galvanized steel, stainless steel, aluminum, brass, gold, silver, copper, or other like material. The food bowl dish aperture 784 comprises an opening in the food bowl dish 785. The food bowl dish 785 comprises a UV safe material, metal, steel, copper, plastic, high density plastic, silicone, PVC, fiber glass, carbon fiber, composite material, wood, galvanized steel, stainless steel, aluminum, brass, gold, silver, copper, or other like material. The food bowl lid switch 786 comprises an electronic switch, pressure switch, or the like. The food bowl motor 787 comprises an electric motor, or the like. The food bowl weight scale 789 comprises a load cell, a printed circuit board (PCB) with an integrated electronic scale, a memory, storage, one or more processors, wireless connectivity, Bluetooth, Near Field Communication (NFC), internet connectivity, network connectivity, network connectivity, or the like. The food bowl top side 790 comprises metal, steel, copper, plastic, high density plastic, silicone, PVC, fiber glass, carbon fiber, composite material, wood, galvanized steel, stainless steel, aluminum, brass, gold, silver, copper, or other like material. The food bowl lid 791 comprises metal, steel, copper, plastic, high density plastic, silicone, PVC, fiber glass, carbon fiber, composite material, wood, galvanized steel, stainless steel, aluminum, brass, gold, silver, copper, or other like material. The food bowl top aperture 794 comprises an opening in the food bowl top side 790, or the like. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

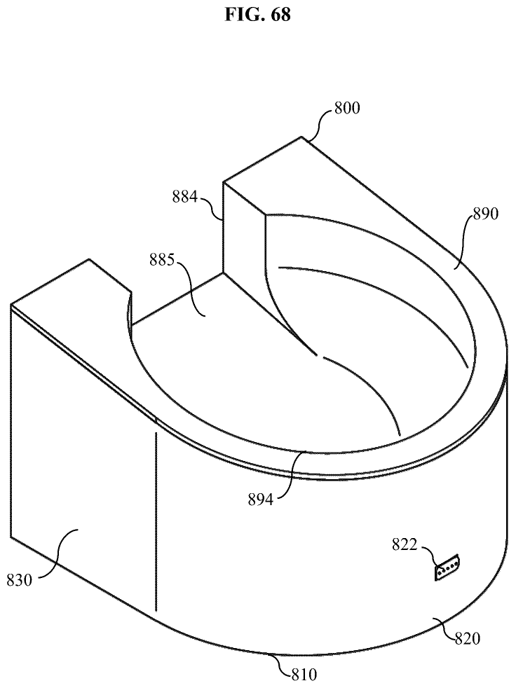

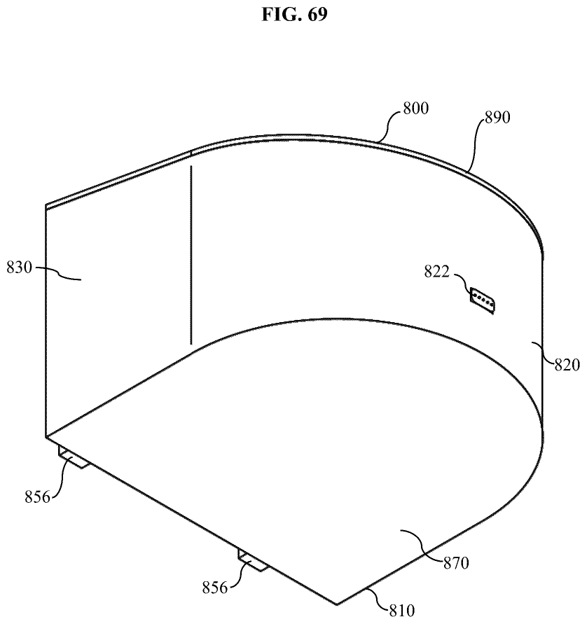

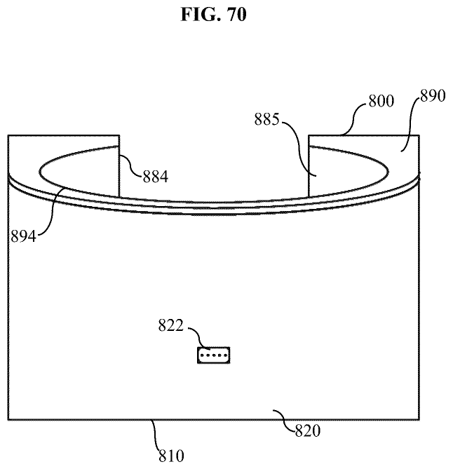

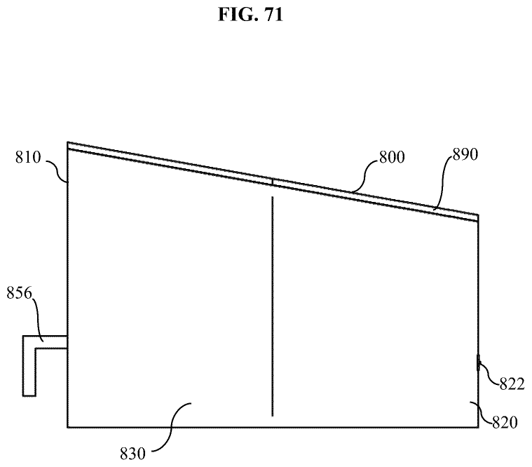

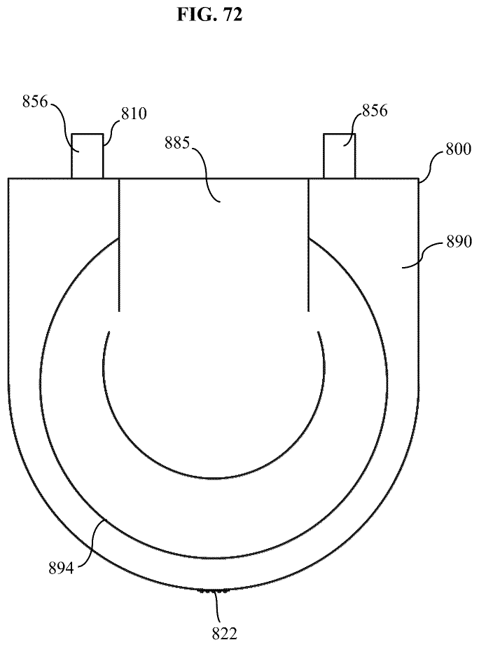

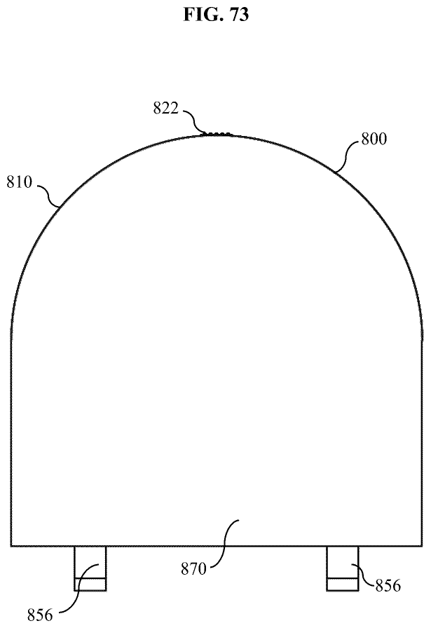

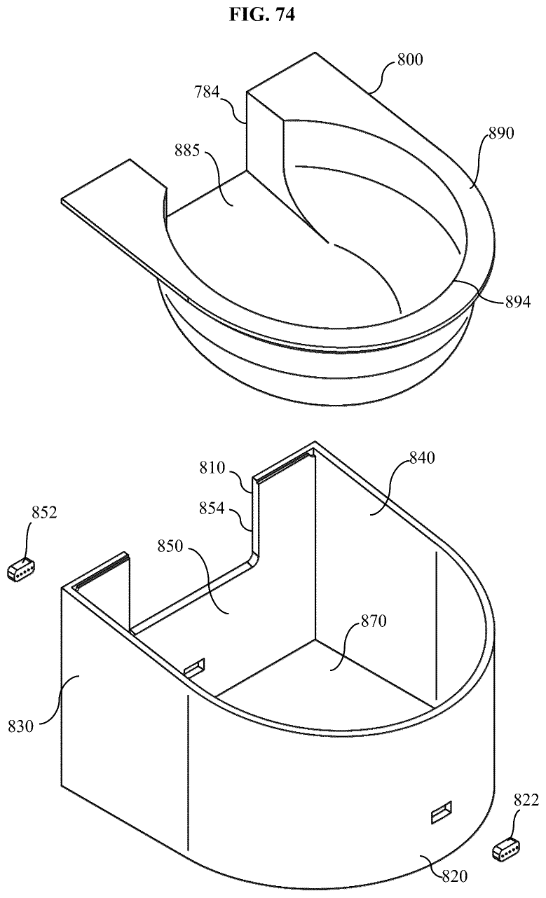

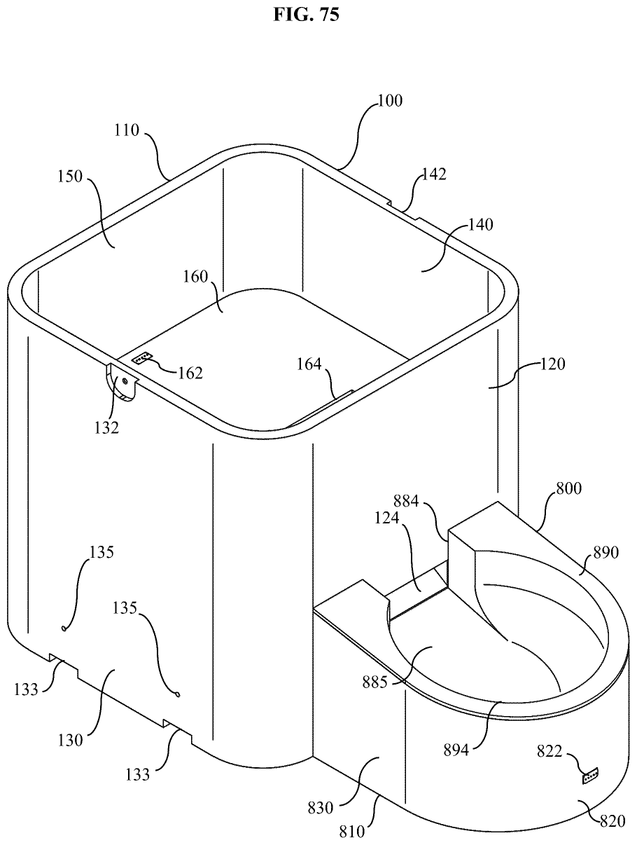

Referring now to another preferred embodiment of the present invention, FIG. 68, FIG. 69, FIG. 70, FIG. 71, FIG. 72, FIG. 73, FIG. 74, and FIG. 75, show a simple food bowl module 800, which is an optional module that may be mounted on the base feeder front side 120 of a base feeder module 100 of a Modular Smart Pet Feeder. FIG. 68 shows a front perspective view of a simple food bowl module 800. FIG. 69 depicts a bottom perspective view of a simple food bowl module 800. FIG. 70 illustrates a front view of a simple food bowl module 800. FIG. 71 displays a left side view of a simple food bowl module 800. FIG. 72 demonstrates a top view of a simple food bowl module 800. FIG. 73 depicts a bottom view of a simple food bowl module 800. FIG. 74 illustrates an exploded perspective view of a simple food bowl module 800. FIG. 75 displays a front perspective view of a simple food bowl module 800 mounted on a base feeder module 100.

In further detail, still referring to the invention of FIG. 68, FIG. 69, FIG. 70, FIG. 71, FIG. 72, FIG. 73, FIG. 74, and FIG. 75, a simple food bowl module 800 comprises a simple food bowl body 810 and a simple food bowl dish 885. The simple food bowl body 810 comprises a simple food bowl front side 820, a simple food bowl left side 830, a simple food bowl right side 840, a simple food bowl rear side 850, and a simple food bowl bottom side 870, which are joined together as a single unit. The simple food bowl front side 820 comprises a simple food bowl front connector 822, which comprises an electronic connector for sending power to a module mounted on the front of a simple food bowl module 800, such as the weight scale module 900 using the weight scale rear connector 952, as described below. The simple food bowl front connector 822 also facilitates electronic communications between the base feeder controller 180 of the base feeder module 100 and a module mounted on the front of a simple food bowl module 800, such as the weight scale module 900 using the weight scale rear connector 952 as described below, as well as any other modules, which may be connected to the simple food bowl module 800 or connected to a module mounted on the front of a simple food bowl module 800. The simple food bowl front connector 822 is controllable by and communicates with the base feeder controller 180 of the base feeder module 100. The simple food bowl front connector 822 can also send data from a module mounted on the front of a simple food bowl module 800 for the purposes of predictive or preventative maintenance or for reporting statistical information about its functionality, such as predicting when the module or a part of the module needs to be replaced or when the simple food bowl front connector 822, which is a conduit for power and communications for other modules, may fail so that the module may be replaced to ensure functionality during critical times, such as when a pet owner is away. The simple food bowl left side 830 comprises a side panel. The simple food bowl right side 840 comprises a side panel. The simple food bowl rear side 850 comprises a simple food bowl rear connector 852, a simple food bowl rear aperture 854, and simple food bowl rear hooks 856. The simple food bowl rear connector 852 comprises an electronic connector for receiving power from a base feeder module 100 when the simple food bowl module 800 is mounted on a base feeder module 100 and for passing power through the simple food bowl module 800 to a module mounted on the front of it through the simple food bowl front connector 822, as described above. The simple food bowl rear connector 852 also facilitates electronic communications between the base feeder module 100 and any other modules, which may be connected to the simple food bowl module 800, such as the weight scale module 900 using the weight scale rear connector 952, as described below. The simple food bowl rear connector 852 is controllable by and communicates with the base feeder controller 180 of the base feeder module 100. The simple food bowl rear connector 852 can also send data from a module mounted on the front of a simple food bowl module 800 for the purposes of predictive or preventative maintenance or for reporting statistical information about its functionality, such as predicting when the module or a part of the module needs to be replaced or when the simple food bowl rear connector 852, which is a conduit for power and communications for other modules, may fail so that the module may be replaced to ensure functionality during critical times, such as when a pet owner is away. The simple food bowl rear aperture 854 comprises an opening, which aligns with the base feeder front aperture 124 of the base feeder module 100 when the simple food bowl module 800 is mounted on a base feeder module 100, and receives food from the base feeder food ramp 185 of the base feeder module 100 during a pet feeding time. The simple food bowl rear hooks 856 comprise hook-shaped protrusions depending from the back of the simple food bowl rear side 850 and which allows the simple food bowl module 800 to be physically attached to the base feeder front side 120 of the base feeder module 100 using the base feeder front mount receivers 126. The simple food bowl bottom side 870 comprises a bottom panel, which serves as a base for the simple food bowl module 800. The simple food bowl dish 885 comprises a downwardly angled feeding bowl insert, which fits on top of the simple food bowl body 810, a simple food bowl dish aperture 884, and a simple food bowl top side 890, which are joined together as a single unit. The simple food bowl dish aperture 884 comprises an opening, which aligns with the simple food bowl rear aperture 854 of the simple food bowl rear side 850 and allows pet food to enter the simple food bowl dish 885 from the base feeder food ramp 185 of the base feeder module 100 during feeding times. The simple food bowl top side 890 comprises a top panel of the simple food bowl dish 885 and a simple food bowl top aperture 894. The simple food bowl top aperture 894 comprises an opening in the top of the simple food bowl top side 890, which allows access for a pet to feed from the simple food bowl dish 885. During operation, when a pet's feeding time occurs, as determined by the base feeder controller 180 of the base feeder module 100 through timing or user initiation, the base feeder controller 180 causes food to be dispensed from the base feeder food ramp 185 of the base feeder module 100 through the simple food bowl dish aperture 884 and into the simple food bowl dish 885.

The construction details of the invention as shown in FIG. 68, FIG. 69, FIG. 70, FIG. 71, FIG. 72, FIG. 73, FIG. 74, and FIG. 75, are as follows. The simple food bowl module 800 comprises a simple food bowl body 810 and a simple food bowl dish 885. The simple food bowl body 810 comprises a simple food bowl front side 820, a simple food bowl left side 830, a simple food bowl right side 840, a simple food bowl rear side 850, and a simple food bowl bottom side 870, which are joined together as a single unit. The simple food bowl front side 820 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food bowl front connector 822 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The simple food bowl left side 830 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food bowl right side 840 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food bowl rear side 850 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food bowl rear connector 852 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The simple food bowl rear aperture 854 comprises an opening in the simple food bowl rear side 850, or the like. The simple food bowl rear hooks 856 comprise hook-shaped protrusions depending from the back of the simple food bowl rear side 850 and comprising metal, steel, copper, plastic, high density plastic, silicone, PVC, fiber glass, carbon fiber, composite material, wood, galvanized steel, stainless steel, aluminum, brass, gold, silver, copper, or other like material. The simple food bowl bottom side 870 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food bowl dish aperture 884 comprises an opening in the simple food bowl dish 885, or the like. The simple food bowl dish 885 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food bowl top side 890 comprises metal, steel, copper, plastic, high density plastic, silicone, PVC, fiber glass, carbon fiber, composite material, wood, galvanized steel, stainless steel, aluminum, brass, gold, silver, copper, or other like material. The simple food bowl top aperture 894 comprises an opening in the simple food bowl top side 890, or the like. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

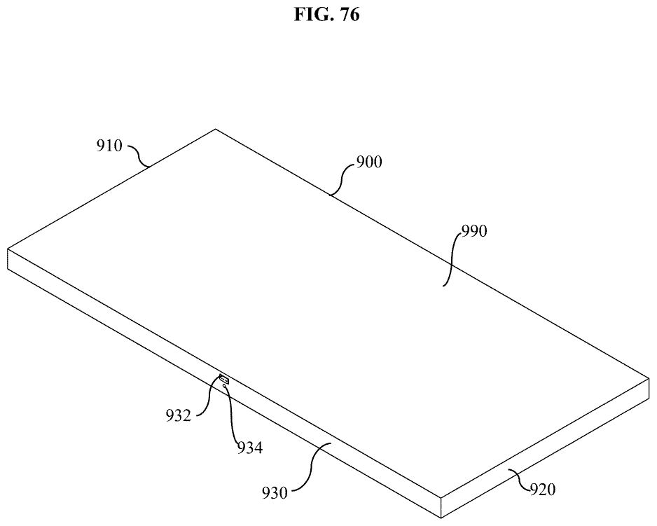

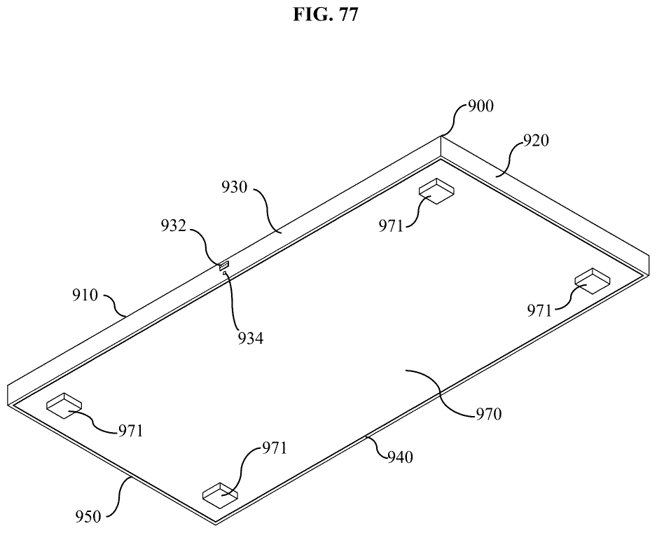

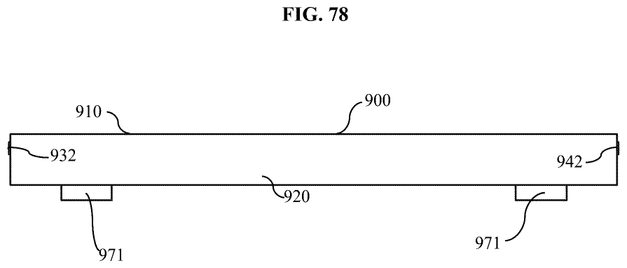

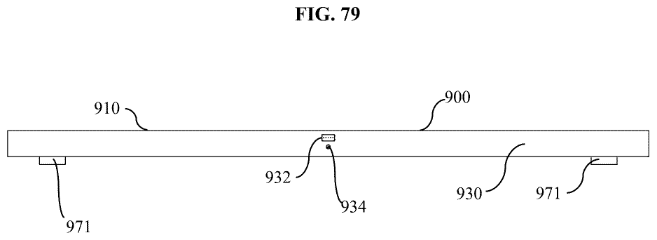

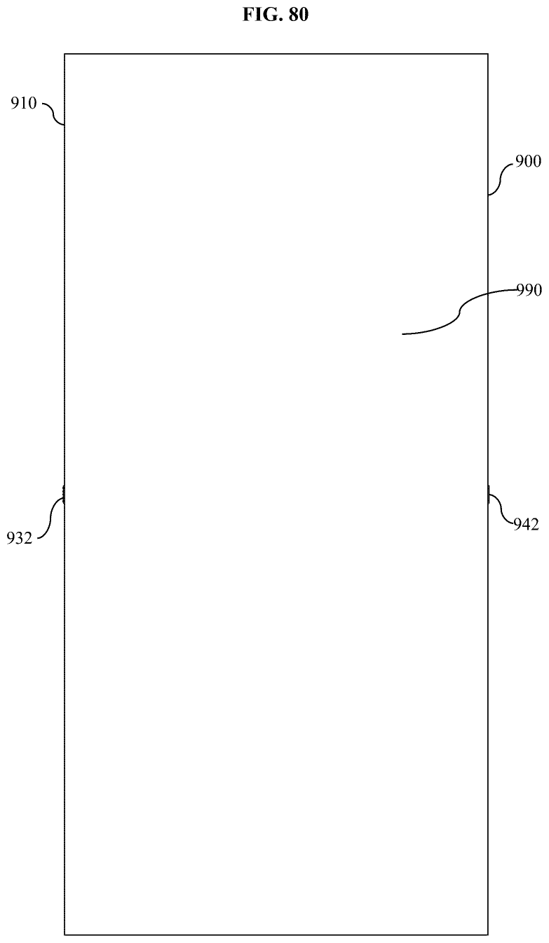

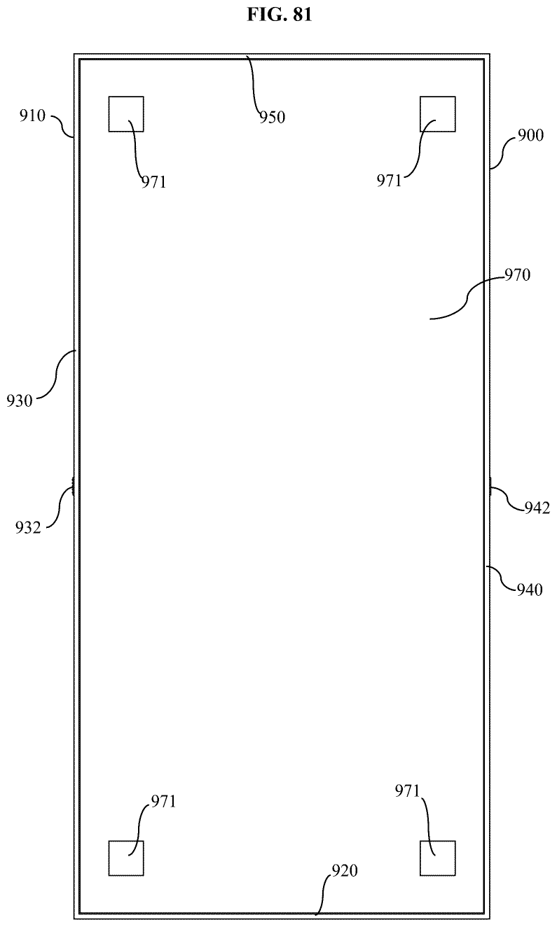

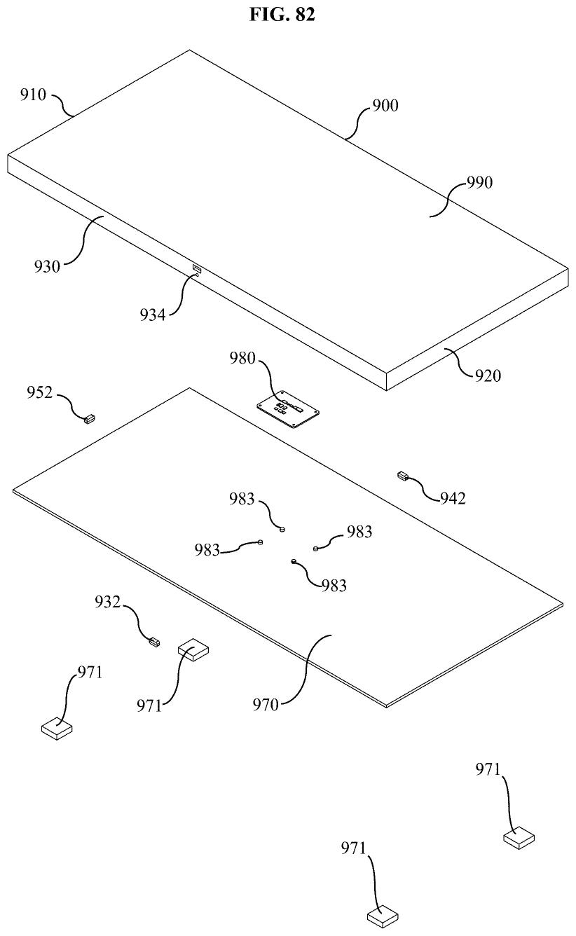

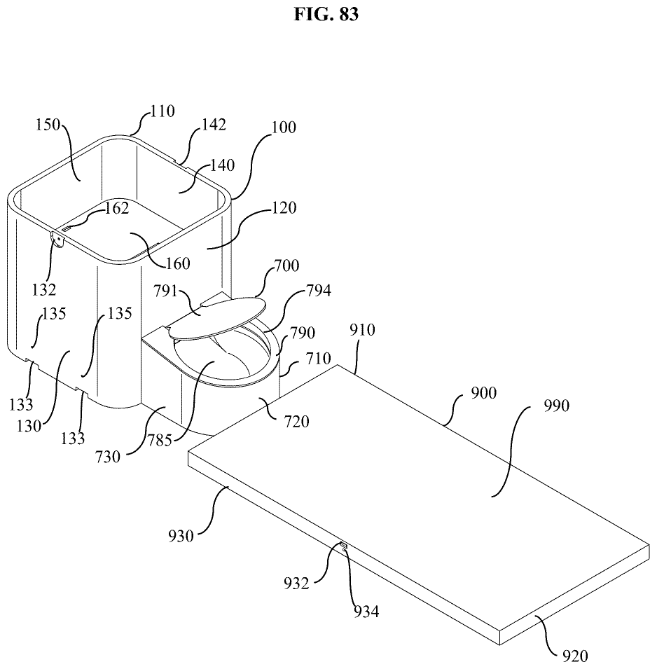

Referring now to another preferred embodiment of the present invention, FIG. 76, FIG. 77, FIG. 78, FIG. 79, FIG. 80, FIG. 81, FIG. 82, and FIG. 83, depict a weight scale module 900, which is an optional module that may be mount on the front side of a food bowl module, such as a food bowl module 700 using the food bowl front connector 722 or a simple food bowl module 800 using the simple food bowl front connector 822, which is mounted on the base feeder front side 120 of a base feeder module 100 of a Modular Smart Pet Feeder. FIG. 76 shows a front perspective view of a weight scale module 900. FIG. 77 depicts a bottom perspective view of a weight scale module 900. FIG. 78 illustrates a front view of a weight scale module 900. FIG. 79 displays a left side view of a weight scale module 900. FIG. 80 shows a top view of a weight scale module 900. FIG. 81 depicts a bottom view of a weight scale module 900. FIG. 82 illustrates an exploded perspective view of a weight scale module 900. FIG. 83 displays a front perspective view of a weight scale module 900 mounted on a food bowl module 700, which is mounted on a base feeder module 100.

In further detail, still referring to the invention of FIG. 76, FIG. 77, FIG. 78, FIG. 79, FIG. 80, FIG. 81, FIG. 82, and FIG. 83, a weight scale module 900 comprises a weight scale body 910, a weight scale bottom side 970, and a weight scale controller 980. The weight scale body 910 comprises a weight scale front side 920, a weight scale left side 930, a weight scale right side 940, a weight scale rear side 950, and a weight scale top side 990, which are joined together as a single unit. The weight scale front side 920 comprises a front panel. The weight scale left side 930 comprises a weight scale left connector 932 and a weight scale left attachment point 934. The weight scale left connector 932 comprises an electronic connector for sending power to a module mounted to the weight scale left side 930 of a weight scale module 900, such as an RFID reader module 1100 using the RFID reader left connector 1132, as described below. The weight scale left connector 932 also facilitates electronic communications between the base feeder controller 180 of the base feeder module 100 and a module mounted to the weight scale left side 930 of a weight scale module 900, such as an RFID reader module 1100 using the RFID reader left connector 1132 as described below, as well as any other modules, which may be connected to the weight scale module 900 or connected to a module mounted on the side of a weight scale module 900. The weight scale left connector 932 is controllable by and communicates with the weight scale controller 980 of the weight scale module 900 and/or the base feeder controller 180 of the base feeder module 100. The weight scale left connector 932 can also send data from a module mounted on the side of a weight scale module 900 for the purposes of predictive or preventative maintenance or for reporting statistical information about its functionality, such as predicting when the module or a part of the module needs to be replaced or when the weight scale left connector 932, which is a conduit for power and communications for other modules, may fail so that the module may be replaced to ensure functionality during critical times, such as when a pet owner is away. The weight scale left attachment point 934 comprises a hole for receiving a fastener in order to physically mount other modules to the weight scale left side 930 of a weight scale module 900, such as an RFID reader module 1100 using the RFID reader left fastener 1135, as described below. The weight scale right side 940 comprises a weight scale right connector 942 and a weight scale right attachment point 944. The weight scale right connector 942 comprises an electronic connector for sending power to a module mounted to the weight scale right side 940 of a weight scale module 900, such as an RFID reader module 1100 using the RFID reader right connector 1142, as described below. The weight scale right connector 942 also facilitates electronic communications between the base feeder controller 180 of the base feeder module 100 and a module mounted to the weight scale right side 940 of a weight scale module 900, such as an RFID reader module 1100 using the RFID reader right connector 1142 as described below, as well as any other modules, which may be connected to the weight scale module 900 or connected to a module mounted on the side of a weight scale module 900. The weight scale right connector 942 is controllable by and communicates with the weight scale controller 980 of the weight scale module 900 and/or the base feeder controller 180 of the base feeder module 100. The weight scale right connector 942 can also send data from a module mounted on the side of a weight scale module 900 for the purposes of predictive or preventative maintenance or for reporting statistical information about its functionality, such as predicting when the module or a part of the module needs to be replaced or when the weight scale right connector 942, which is a conduit for power and communications for other modules, may fail so that the module may be replaced to ensure functionality during critical times, such as when a pet owner is away. The weight scale right attachment point 944 comprises a hole for receiving a fastener in order to physically mount other modules to the weight scale right side 940 of a weight scale module 900, such as an RFID reader module 1100 using the RFID reader right fastener 1145, as described below. The weight scale rear side 950 comprises a weight scale rear connector 952, which comprises an electronic connector for receiving power from a module mounted on the base feeder front side 120 of a base feeder module 100, such as a food bowl module 700 using the food bowl front connector 722 or a simple food bowl module 800 using the simple food bowl front connector 822, and for passing power through the weight scale module 900 to a module mounted on the sides of it through the weight scale left connector 932 and/or weight scale right connector 942, such as the RFID reader module 1100 using the RFID reader left connector 1132 and RFID reader right connector 1142, respectively, as described below. The weight scale rear connector 952 also facilitates electronic communications between the base feeder module 100, a module installed between the base feeder module 100 and the weight scale module 900, such as a food bowl module 700 or a simple food bowl module 800 as described above, and any other modules, which may be connected to the weight scale module 900, such as the RFID reader module 1100, as described below. The weight scale rear connector 952 is controllable by and communicates with the base feeder controller 180 of the base feeder module 100 and/or the weight scale controller 980. The weight scale rear connector 952 can also send data from a module mounted to the weight scale module 900 for the purposes of predictive or preventative maintenance or for reporting statistical information about its functionality, such as predicting when the module or a part of the module needs to be replaced or when the weight scale rear connector 952, which is a conduit for power and communications for other modules, may fail so that the module may be replaced to ensure functionality during critical times, such as when a pet owner is away. The weight scale top side 990 comprises a large flat panel with enough space to allow a pet to stand on it during feeding. The weight scale bottom side 970 comprises a bottom panel, which serves as a base for the weight scale module 900, and weight scale feet 971, which support the weight scale module 900. The weight scale controller 980 is mounted on the weight scale bottom side 970 using weight scale controller connectors 983 and to the underside of the weight scale top side 990 of the weight scale body 910 and comprises a load cell, a printed circuit board (PCB) with an integrated electronic scale, a memory, and one or more processors for controlling, managing, and monitoring the weight scale module 900 as well as various modules, which may be attached to the weight scale module 900, and for communicating with the base feeder module 100. The weight scale controller 980 may also comprise wireless connectivity, Bluetooth, Near Field Communication (NFC), internet connectivity, network connectivity, or the like. The weight scale controller 980 is also capable of monitoring the functional parameters of various components of the weight scale module 900 and predicting when they need to be replaced, as well as being capable of monitoring the functional parameters of various connected modules or communicating those parameters to the base feeder module 100 for monitoring, in order to facilitate preventive and predictive maintenance and report data, which may be displayed in an app, webpage, computer program, or the like. The weight scale controller 980 supports the entire weight scale body 910 to allow for accurate measurements of a pet's weight when the pet is atop the weight scale top side 990.

The construction details of the invention as shown in FIG. 76, FIG. 77, FIG. 78, FIG. 79, FIG. 80, FIG. 81, FIG. 82, and FIG. 83, are as follows. The weight scale module 900 comprises a weight scale body 910, a weight scale bottom side 970, and a weight scale controller 980. The weight scale body 910 comprises a weight scale front side 920, a weight scale left side 930, a weight scale right side 940, a weight scale rear side 950, and a weight scale top side 990, which are joined together as a single unit. The weight scale front side 920 comprises metal, steel, copper, plastic, high density plastic, silicone, PVC, fiber glass, carbon fiber, composite material, wood, galvanized steel, stainless steel, aluminum, brass, gold, silver, copper, or other like material. The weight scale left side 930 comprises metal, steel, copper, plastic, high density plastic, silicone, PVC, fiber glass, carbon fiber, composite material, wood, galvanized steel, stainless steel, aluminum, brass, gold, silver, copper, or other like material. The weight scale left connector 932 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The weight scale left attachment point 934 comprises a hole for receiving a fastener, or the like. The weight scale right side 940 comprises metal, steel, copper, plastic, high density plastic, silicone, PVC, fiber glass, carbon fiber, composite material, wood, galvanized steel, stainless steel, aluminum, brass, gold, silver, copper, or other like material. The weight scale right connector 942 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The weight scale right attachment point 944 comprises a hole for receiving a fastener, or the like. The weight scale rear side 950 comprises metal, steel, copper, plastic, high density plastic, silicone, PVC, fiber glass, carbon fiber, composite material, wood, galvanized steel, stainless steel, aluminum, brass, gold, silver, copper, or other like material. The weight scale rear connector 952 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The weight scale bottom side 970 comprises metal, steel, copper, plastic, high density plastic, silicone, PVC, fiber glass, carbon fiber, composite material, wood, galvanized steel, stainless steel, aluminum, brass, gold, silver, copper, or other like material. The weight scale feet 971 comprise feet, which support the weight scale module 900, comprising rubber, metal, steel, copper, plastic, high density plastic, silicone, PVC, fiber glass, carbon fiber, composite material, wood, galvanized steel, stainless steel, aluminum, brass, gold, silver, copper, or other like material. The weight scale controller 980 comprises a load cell, a printed circuit board (PCB), an integrated electronic scale, a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The weight scale controller connectors 983 comprise feet, which attach the weight scale controller 980 to the weight scale bottom side 970, comprising electrical connectors, metal, steel, copper, plastic, rubber, high density plastic, silicone, PVC, fiber glass, carbon fiber, composite material, wood, galvanized steel, stainless steel, aluminum, brass, gold, silver, copper, or other like material. The weight scale top side 990 comprises metal, steel, copper, plastic, high density plastic, silicone, PVC, fiber glass, carbon fiber, composite material, wood, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

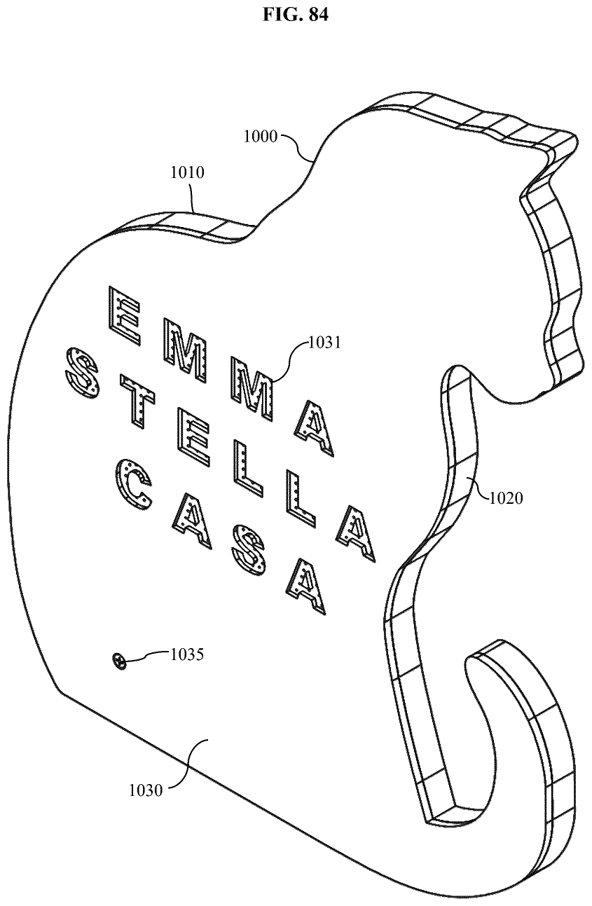

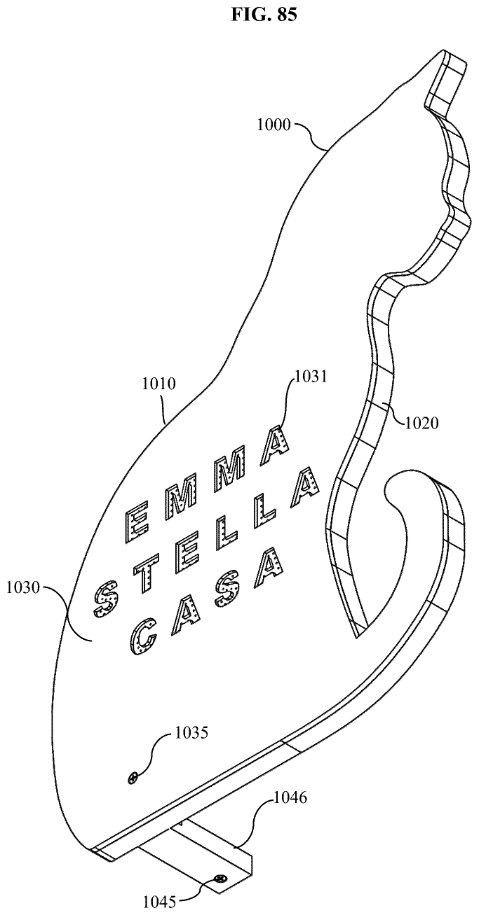

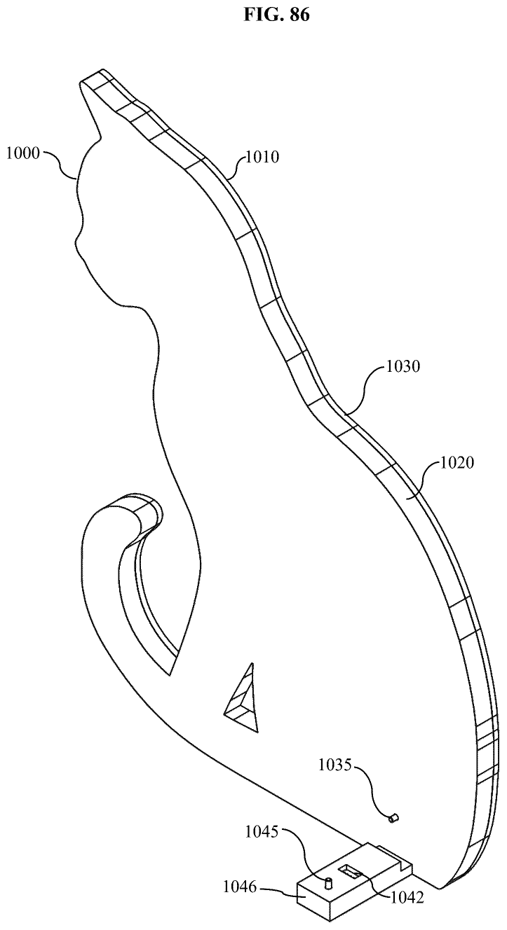

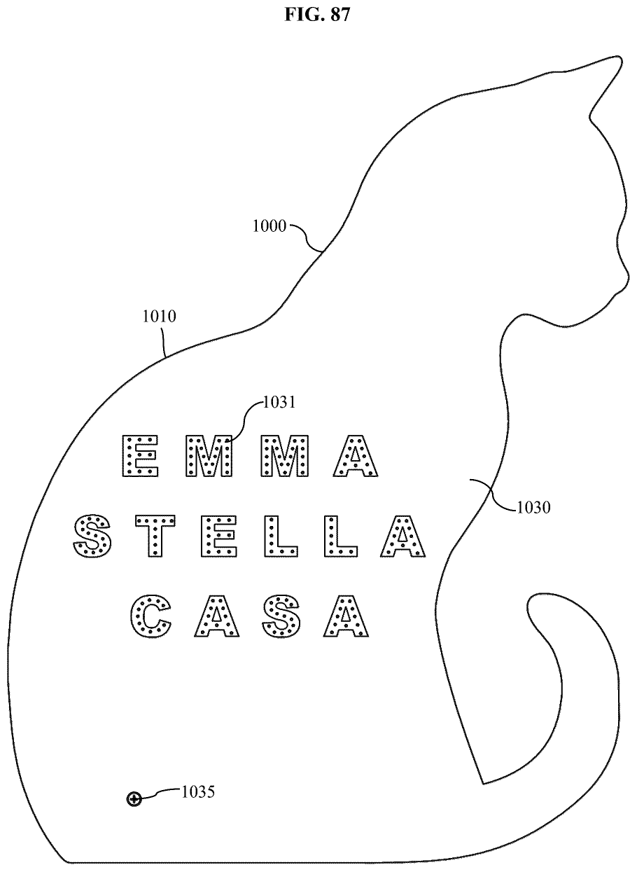

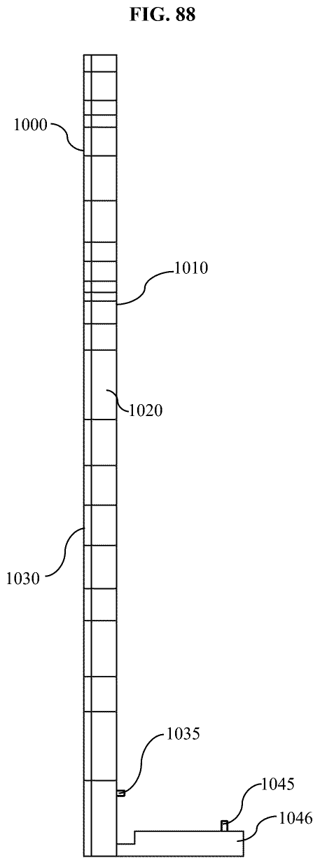

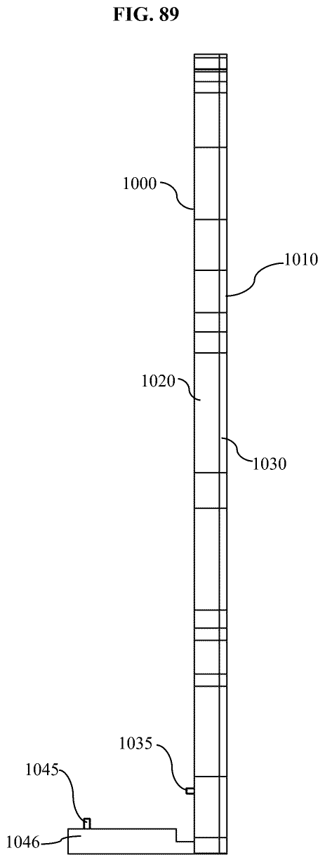

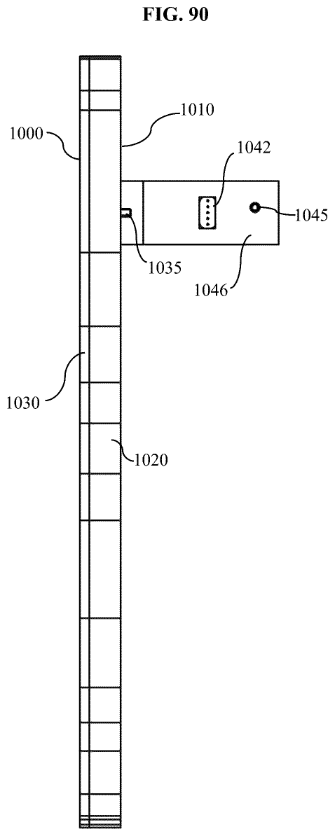

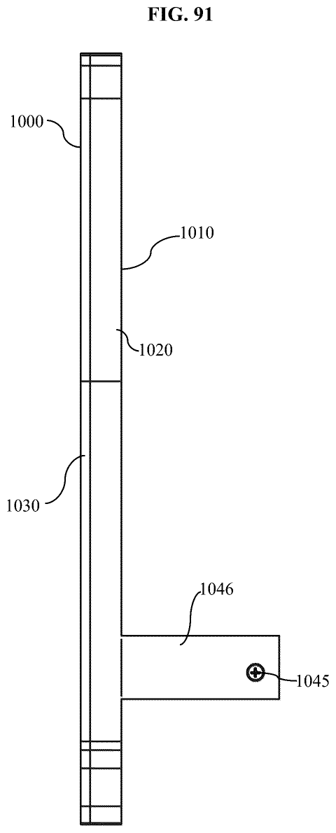

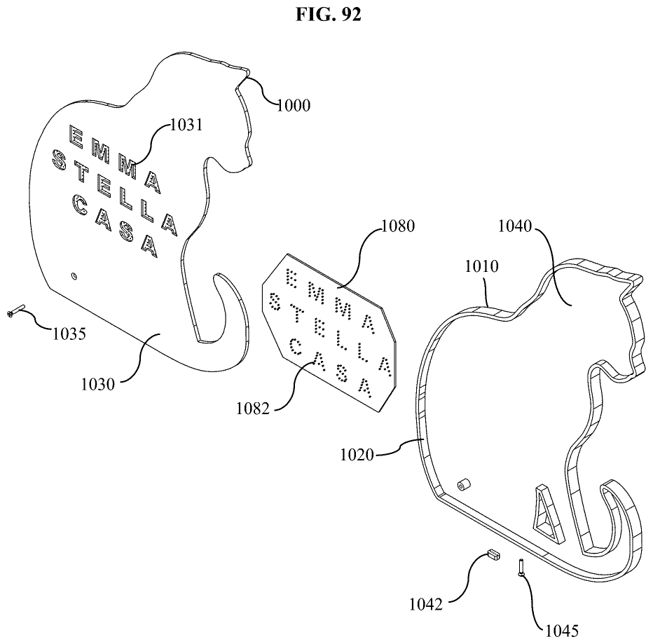

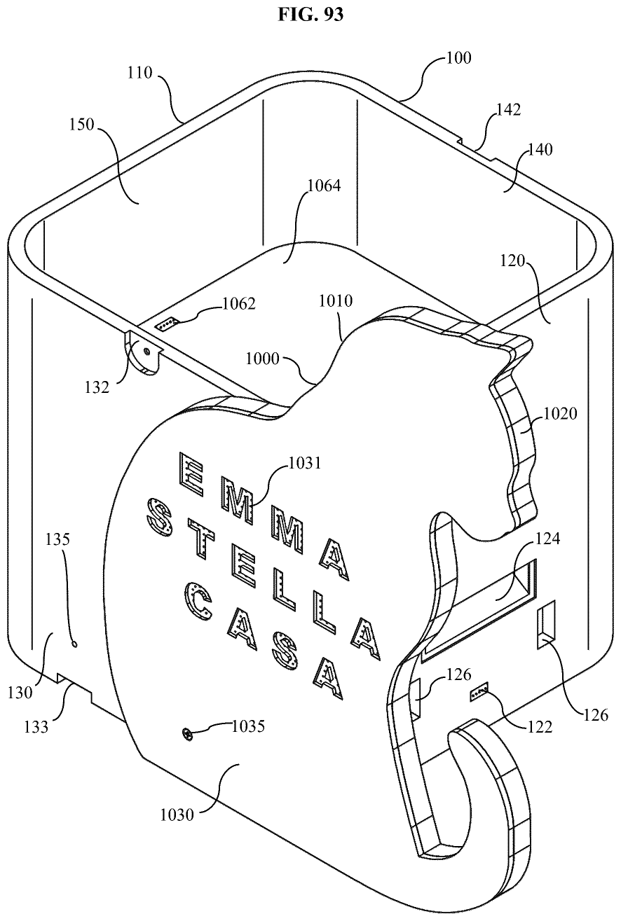

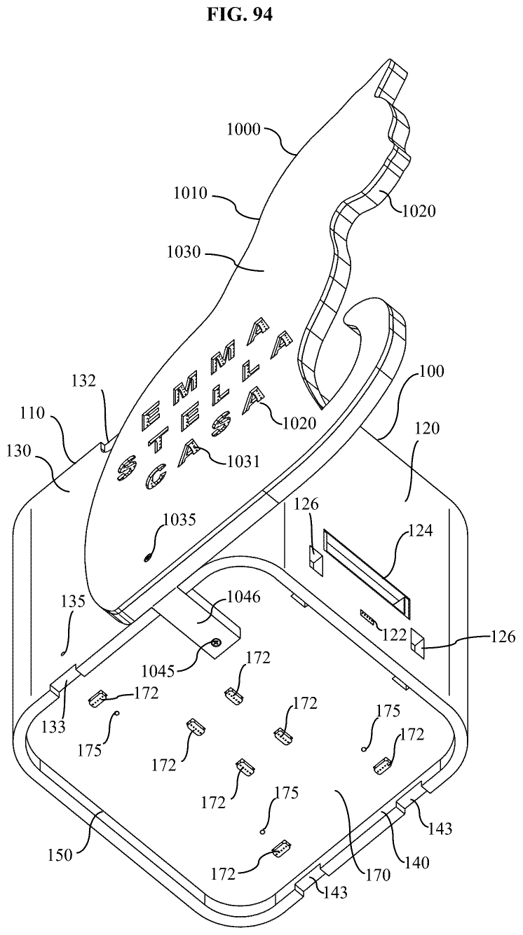

Referring now to another preferred embodiment of the present invention, FIG. 84, FIG. 85, FIG. 86, FIG. 87, FIG. 88, FIG. 89, FIG. 90, FIG. 91, FIG. 92, FIG. 93, and FIG. 94, illustrate a side wall module 1000, which is an optional module that is a type of barrier that may be mounted on the base feeder left side 130 or the base feeder right side 140 of a base feeder module 100 of a Modular Smart Pet Feeder and that provides protection, security, and privacy for a dining pet, as well as, customizable ornamentation and/or data display. FIG. 84 shows a front perspective view of a side wall module 1000. FIG. 85 depicts a bottom perspective view of a side wall module 1000. FIG. 86 illustrates a rear perspective view of a side wall module 1000. FIG. 87 displays a left side view of a side wall module 1000. FIG. 88 shows a front view of a side wall module 1000. FIG. 89 depicts a rear view of a side wall module 1000. FIG. 90 illustrates a top view of a side wall module 1000. FIG. 91 displays a bottom view of a side wall module 1000. FIG. 92 shows an exploded perspective view of a side wall module 1000. FIG. 93 depicts a front perspective view of a side wall module 1000 mounted on a base feeder module 100. FIG. 94 illustrates a bottom perspective view of a side wall module 1000 mounted on a base feeder module 100. In some embodiments of the present invention, a barrier may comprise one or more side walls, a top cover, a tunnel, or an all-around cover comprising a door, and may include customizable LEDs or display screens.

In further detail, still referring to the invention of FIG. 84, FIG. 85, FIG. 86, FIG. 87, FIG. 88, FIG. 89, FIG. 90, FIG. 91, FIG. 92, FIG. 93, and FIG. 94, a side wall module 1000 comprises a side wall body 1010, side wall left side 1030, and a side wall controller 1080. The side wall body 1010 of the side wall module 1000 comprises a side wall depth side 1020 and a side wall right side 1040, which are joined together as a single unit. The side wall depth side 1020 extends around the edge of the side wall right side 1040 and provides a width for the side wall module 1000. The side wall right side 1040 comprises a panel that has the same shape as the side wall left side 1030, which in the illustrated example is the silhouette of a cat, and a side wall right mount 1046, which protrudes from the back of the side wall right side 1040 at the bottom of the panel. The side wall right mount 1046 extends to fit into a base feeder left bottom mount receiver 133 of the base feeder left side 130 of the base feeder module 100 and comprises a side wall right connector 1042 and a side wall right mount fastener 1045. The side wall right connector 1042 extends upward from the side wall right mount 1046 of the side wall right side 1040 and comprises an electronic connector for receiving power from the base feeder module 100 using a base feeder bottom connector 172 and transferring it to the side wall module 1000 and for facilitating electronic communications between the base feeder module 100 and the side wall module 1000. The side wall right connector 1042 is controllable by and communicates with the base feeder controller 180 of the base feeder module 100. The side wall right mount fastener 1045 comprises a fastener, which extends upward through the side wall right mount 1046 of the side wall right side 1040 and allows the side wall module 1000 to be physically attached to the base feeder bottom side 170 of the base feeder module 100 using a base feeder attachment point 175, as described above, after the side wall right mount 1046 is inserted into a base feeder left bottom mount receiver 133 of the base feeder left side 130 of the base feeder module 100. The side wall left side 1030 comprises a panel, which has the same shape as the side wall right side 1040, a side wall graphic 1031, and a side wall left mount fastener 1035. The side wall graphic 1031 comprises a design in the surface of the side wall left side 1030, which may be illuminated by the side wall light source 1082 of the side wall controller 1080. In the illustrated example, the side wall graphic 1031 comprises cut out letters, which spell out, “EMMA STELLA CASA;” however, the side wall graphic 1031 can be customized to suit the tastes of the pet owner to spell out other words, display decorative shapes or patterns, display data concerning the Modular Smart Pet Feeder or the pet or pets that use it, or the like. The side wall left mount fastener 1035 comprises a fastener, which extends through the side wall left side 1030 and through the side wall right side 1040 and allows the side wall module 1000 to be physically attached to the base feeder left side 130 of the base feeder module 100 using a base feeder left attachment points 135, as described above. The side wall controller 1080 comprises a printed circuit board (PCB) with a side wall light sources 1082, a memory, and one or more processors for controlling, managing, and monitoring the side wall module 1000 and its side wall light sources 1082 and for communicating with the base feeder controller 180 of the base feeder module 100. The side wall controller 1080 may also comprise wireless connectivity, Bluetooth, Near Field Communication (NFC), internet connectivity, network connectivity, or the like. The side wall controller 1080 is also capable of monitoring the functional parameters of various components of the side wall module 1000 and predicting when they need to be replaced in order to facilitate preventive and predictive maintenance and report data, which may be displayed in an app, webpage, computer program, on the side wall module 1000 itself, or the like. The side wall light sources 1082 comprises LED light sources, which illuminate side wall graphic 1031 of the base feeder left side 130 and which are controllable by the side wall controller 1080 and/or the base feeder controller 180 of the base feeder module 100. The side wall light sources 1082 are customizable and are capable of providing illumination at different times and with different colors in order to generate a variety of patterns or simulate motion or animation. During use, the side wall module 1000 blocks a food bowl module, such as the food bowl module 700 or the simple food bowl module 800, while a pet is eating and limits or prevents other animals from accessing the food bowl, thereby protection, security, and privacy for a dining pet. In addition, the side wall module 1000 provides customizable ornamentation, which allows a pet owner to express their personality, or the personality of their pet, in a fun and entertaining manner.

The construction details of the invention as shown in FIG. 84, FIG. 85, FIG. 86, FIG. 87, FIG. 88, FIG. 89, FIG. 90, FIG. 91, FIG. 92, FIG. 93, and FIG. 94, are as follows. The side wall module 1000 comprises a side wall body 1010, side wall left side 1030, and a side wall controller 1080. The side wall body 1010 of the side wall module 1000 comprises a side wall depth side 1020 and a side wall right side 1040, which are joined together as a single unit. The side wall depth side 1020 comprises metal, steel, copper, plastic, high density plastic, silicone, PVC, fiber glass, carbon fiber, composite material, wood, galvanized steel, stainless steel, aluminum, brass, gold, silver, copper, or other like material. The side wall left side 1030 comprises metal, steel, copper, plastic, high density plastic, silicone, PVC, fiber glass, carbon fiber, composite material, wood, galvanized steel, stainless steel, aluminum, brass, gold, silver, copper, or other like material. The side wall graphic 1031 comprises a cutout, a screen, a display, a display board, attachments, an ornamental design, decorations, personalized messages, letters, or the like. The side wall left mount fastener 1035 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The side wall right side 1040 comprises metal, steel, copper, plastic, high density plastic, silicone, PVC, fiber glass, carbon fiber, composite material, wood, galvanized steel, stainless steel, aluminum, brass, gold, silver, copper, or other like material. The side wall right connector 1042 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The side wall right mount fastener 1045 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The side wall right mount 1046 comprises metal, steel, copper, plastic, high density plastic, silicone, PVC, fiber glass, carbon fiber, composite material, wood, galvanized steel, stainless steel, aluminum, brass, gold, silver, copper, or other like material. The side wall controller 1080 comprises a printed circuit board (PCB), a memory, storage, a light source(s), an LED array, a display, a screen, a hard drive, an SSD (solid state drive), integrated circuits, one or more processors, a CPU, a computer, network capability, wireless connectivity, Bluetooth, Near Field Communication (NFC), internet connectivity, network connectivity, or the like. The side wall light source 1082 comprises a light source, an array of lights, light emitting diodes (LEDs), or the like. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

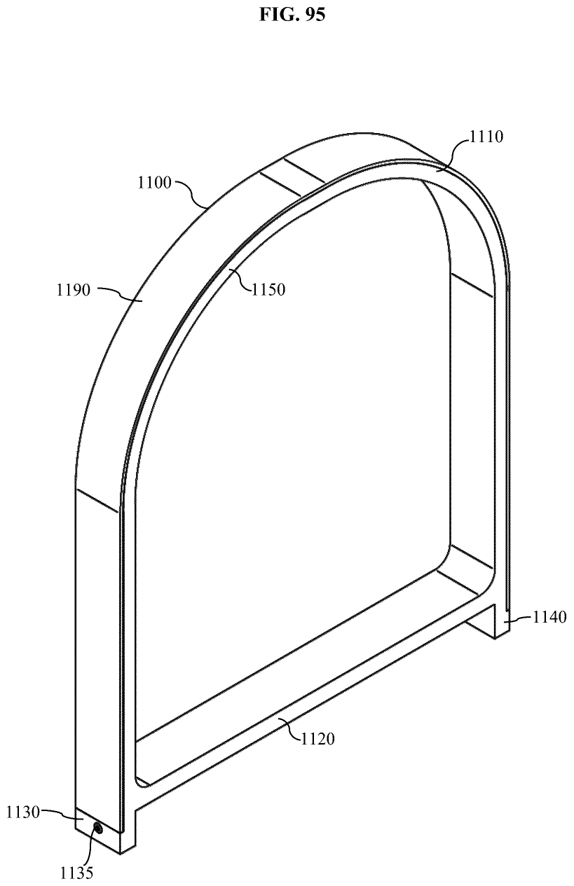

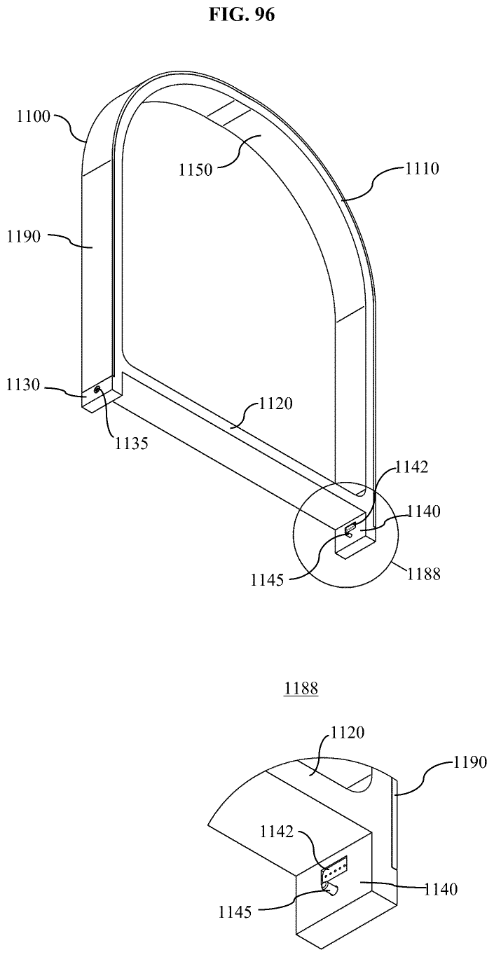

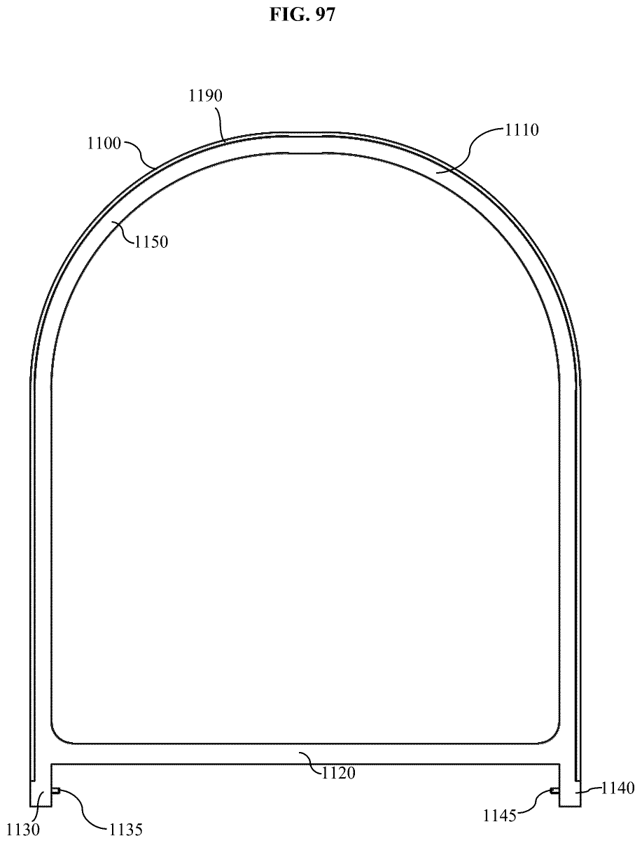

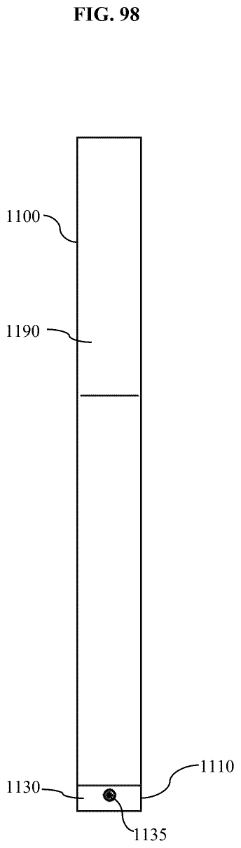

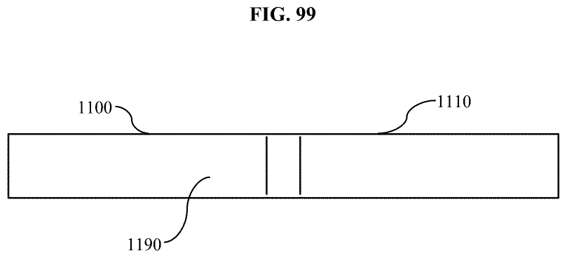

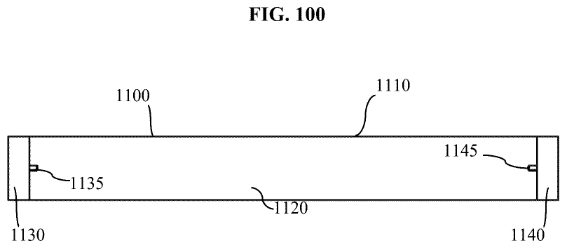

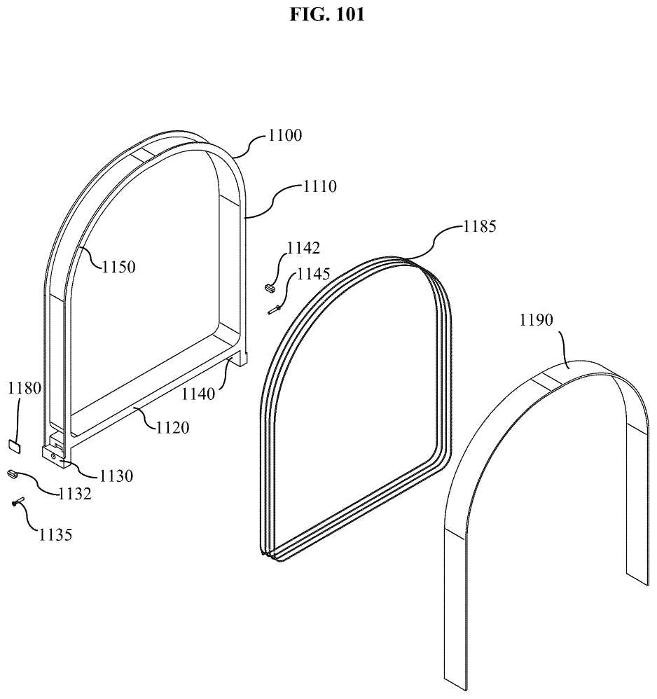

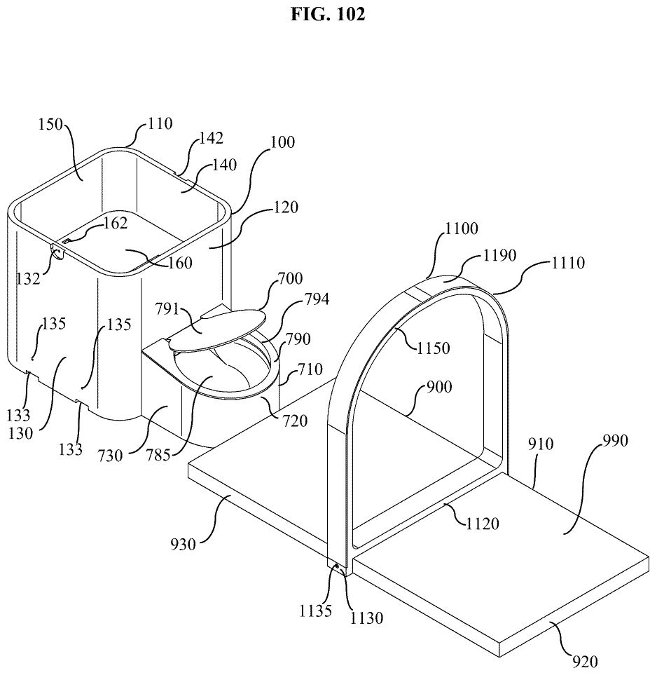

Referring now to another preferred embodiment of the present invention, FIG. 95, FIG. 96, FIG. 97, FIG. 98, FIG. 99, FIG. 100, FIG. 101, and FIG. 102, display an RFID reader module 1100, which is an optional module for household with multiple pets that may be mounted on a weight scale module 900 of a Modular Smart Pet Feeder and that allows individual pets to be identified by identifying an RFID tag, which each pet may be wearing, such as on a collar, or an RFID implant that each pet may have, in order to control the access of different pets to the Modular Smart Pet Feeder to manage the different dietary needs of different pets. The RFID reader module 1100 of the present embodiment is intended to be mounted on a weight scale module 900, which is mounted on a food bowl module, such as the food bowl module 700 or the simple food bowl module 800, which is in turn mounted on a base feeder module 100 of a Modular Smart Pet Feeder. FIG. 95 displays a front perspective view of a RFID reader module 1100. FIG. 96 shows a bottom perspective view of a RFID reader module 1100. FIG. 97 depicts a front view of a RFID reader module 1100. FIG. 98 illustrates a left side view of a RFID reader module 1100. FIG. 99 displays a top view of a RFID reader module 1100. FIG. 100 shows a bottom view of a RFID reader module 1100. FIG. 101 depicts an exploded perspective view of a RFID reader module 1100. FIG. 102 illustrates a front perspective view of a RFID reader module 1100 mounted on a weight scale module 900, which is mounted on a food bowl module 700, which is mounted on a base feeder module 100.

In further detail, still referring to the invention of FIG. 95, FIG. 96, FIG. 97, FIG. 98, FIG. 99, FIG. 100, FIG. 101, and FIG. 102, an RFID reader module 1100 comprises an RFID reader body 1110, an RFID reader antenna 1185, and an RFID reader cover 1190. The RFID reader body 1110 comprises an RFID reader arch 1150, an RFID reader crossbar 1120, an RFID reader left foot 1130, and an RFID reader right foot 1140, which are joined together as a single unit. The RFID reader arch 1150 comprises an arch that spans the width of the RFID reader module 1100 and provides enough space for a pet to easily pass through the arch when the pet is approaching a food bowl mounted on the base feeder module 100 of the Modular Smart Pet Feeder. The RFID reader crossbar 1120 comprises a hollow bar, which spans the distance between the bases of the RFID reader arch 1150, and which allows a portion of the RFID reader antenna 1185 to pass through said hollow. The RFID reader left foot 1130 comprises a protrusion at the left base of the RFID reader arch 1150, an RFID reader left connector 1132, and an RFID reader left fastener 1135. The RFID reader left connector 1132 comprises an electronic connector for receiving power and communications from a weight scale module 900 through the weight scale left connector 932, as described above. The RFID reader left connector 1132 also facilitates electronic communications between the RFID reader module 1100 and the weight scale controller 980 of the weight scale module 900 using the weight scale left connector 932; a module mounted between the weight scale rear side 950 of the weight scale module 900 and the base feeder front side 120 of the base feeder module 100, such as a food bowl module 700 or a simple food bowl module 800; and the base feeder controller 180 of the base feeder module 100 using the base feeder front connector 122. The RFID reader left connector 1132 is controllable by and communicates with the RFID reader controller 1180 of the RFID reader module 1100 and/or the base feeder controller 180 of the base feeder module 100. The RFID reader left connector 1132 can also send data from the RFID reader controller 1180 for the purposes of predictive or preventative maintenance or for reporting statistical information about its functionality, such as predicting when the module or a part of the module needs to be replaced or when the RFID reader left connector 1132 itself may fail so that the module may be replaced to ensure functionality during critical times, such as when a pet owner is away. The RFID reader left fastener 1135 comprises a fastener, which extends through the RFID reader left foot 1130 and allows the RFID reader module 1100 to be physically attached to the weight scale left side 930 of the weight scale module 900 using the weight scale left attachment point 934, as described above. The RFID reader right foot 1140 comprises a protrusion at the right base of the RFID reader arch 1150, an RFID reader right connector 1142, and an RFID reader right fastener 1145. The RFID reader right connector 1142 comprises an electronic connector for receiving power and communications from a weight scale module 900 through the weight scale right connector 942, as described above. The RFID reader right connector 1142 also facilitates electronic communications between the RFID reader module 1100 and the weight scale controller 980 of the weight scale module 900 using the weight scale right connector 942; a module mounted between the weight scale rear side 950 of the weight scale module 900 and the base feeder front side 120 of the base feeder module 100, such as a food bowl module 700 or a simple food bowl module 800; and the base feeder controller 180 of the base feeder module 100 using the base feeder front connector 122. The RFID reader right connector 1142 is controllable by and communicates with the RFID reader controller 1180 of the RFID reader module 1100 and/or the base feeder controller 180 of the base feeder module 100. The RFID reader right connector 1142 can also send data from the RFID reader controller 1180 for the purposes of predictive or preventative maintenance or for reporting statistical information about its functionality, such as predicting when the module or a part of the module needs to be replaced or when the RFID reader right connector 1142 itself may fail so that the module may be replaced to ensure functionality during critical times, such as when a pet owner is away. The RFID reader right fastener 1145 comprises a fastener, which extends through the RFID reader right foot 1140 and allows the RFID reader module 1100 to be physically attached to the weight scale right side 940 of the weight scale module 900 using the weight scale right attachment point 944, as described above. The RFID reader controller 1180 comprises a printed circuit board (PCB) with an integrated RFID reader, a memory, and one or more processors for controlling, managing, and monitoring the RFID reader module 1100, and for communicating with the base feeder module 100 and with the RFID reader antenna 1185. The RFID reader controller 1180 may also comprise wireless connectivity, Bluetooth, Near Field Communication (NFC), internet connectivity, network connectivity, or the like. The RFID reader controller 1180 is also capable of monitoring the functional parameters of various components of the RFID reader module 1100, such as the RFID reader antenna 1185, and predicting when they need to be replaced, as well as being capable of monitoring the functional parameters of the module and communicating those parameters to the base feeder module 100 for monitoring, in order to facilitate preventive and predictive maintenance and report data, which may be displayed in an app, webpage, computer program, or the like. The RFID reader antenna 1185 comprises a coiled RF antenna, which wraps around the RFID reader arch 1150 and through the hollow RFID reader crossbar 1120, which is capable of detecting RF signals, such as from an RFID tag worn on a pet's collar or an RFID implant, and which is covered by the RFID reader cover 1190. The RFID reader cover 1190 comprises an articulated panel, which fits over the RFID reader arch 1150 and conceals and protects the RFID reader antenna 1185. During use, when an individual pet wearing an RFID tag or having an RFID implant approaches the Modular Smart Pet Feeder and passes through the RFID reader module 1100, the RFID reader module 1100 detects the RFID tag or implant signal and identifies the pet in order to control the pet's access to the Modular Smart Pet Feeder to manage the different dietary needs of different pets. If an identified pet is authorized by the Modular Smart Pet Feeder, the pet is allowed to access dispensed pet food. If an identified pet is not authorized by the Modular Smart Pet Feeder, the pet is denied access to the dispensed pet food until such a time it is authorized. In some embodiments of the present invention, a near field system comprising a near field tag and a near field reader, or other pet detection system, is used in place of an RFID system with similar functionality. In other embodiments, the RFID system, near field system, or other pet detection system, is not activated until triggered by a pet being weighed by a pet weight scale in order to conserve energy.

The construction details of the invention as shown in FIG. 95, FIG. 96, FIG. 97, FIG. 98, FIG. 99, FIG. 100, FIG. 101, and FIG. 102, are as follows. The RFID reader module 1100 comprises an RFID reader body 1110, an RFID reader antenna 1185, and an RFID reader cover 1190. The RFID reader body 1110 comprises an RFID reader arch 1150, an RFID reader crossbar 1120, an RFID reader left foot 1130, and an RFID reader right foot 1140, which are joined together as a single unit. The RFID reader crossbar 1120 comprises metal, steel, copper, plastic, high density plastic, silicone, PVC, fiber glass, carbon fiber, composite material, wood, galvanized steel, stainless steel, aluminum, brass, gold, silver, copper, or other like material. The RFID reader left foot 1130 comprises metal, steel, copper, plastic, high density plastic, silicone, PVC, fiber glass, carbon fiber, composite material, wood, galvanized steel, stainless steel, aluminum, brass, gold, silver, copper, or other like material. The RFID reader left connector 1132 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The RFID reader left fastener 1135 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The RFID reader right foot 1140 comprises metal, steel, copper, plastic, high density plastic, silicone, PVC, fiber glass, carbon fiber, composite material, wood, galvanized steel, stainless steel, aluminum, brass, gold, silver, copper, or other like material. The RFID reader right connector 1142 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The RFID reader right fastener 1145 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The RFID reader arch 1150 comprises metal, steel, copper, plastic, high density plastic, silicone, PVC, fiber glass, carbon fiber, composite material, wood, galvanized steel, stainless steel, aluminum, brass, gold, silver, copper, or other like material. The RFID reader controller 1180 comprises a printed circuit board (PCB), a memory, storage, an RFID reader, a hard drive, an SSD (solid state drive), integrated circuits, one or more processors, a CPU, a computer, network capability, wireless connectivity, Bluetooth, Near Field Communication (NFC), internet connectivity, network connectivity, or the like. The RFID reader antenna 1185 comprises an antenna for detecting RFID signals, or the like. The RFID reader cover 1190 comprises metal, steel, copper, plastic, high density plastic, silicone, PVC, fiber glass, carbon fiber, composite material, wood, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

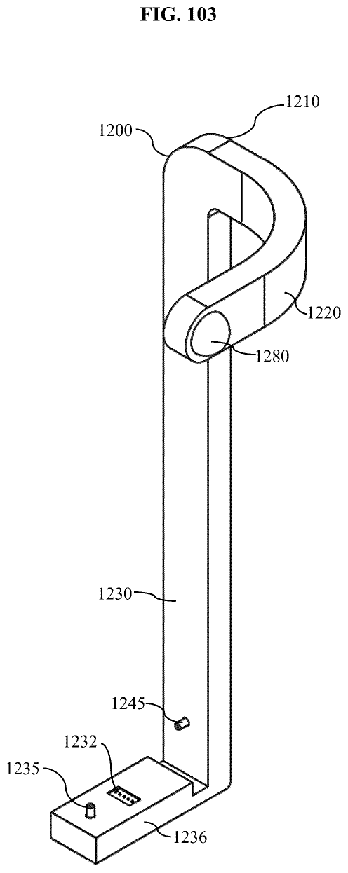

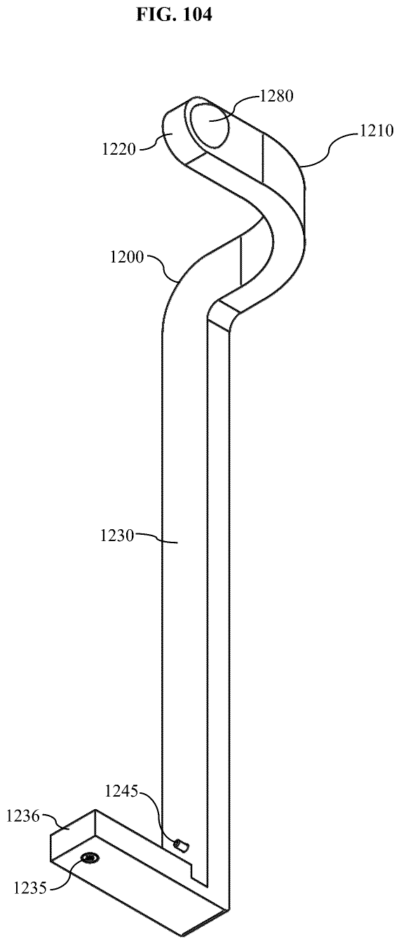

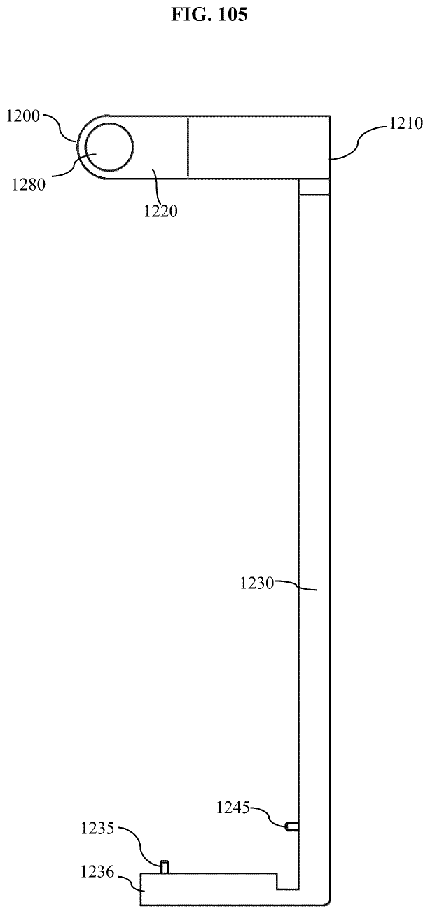

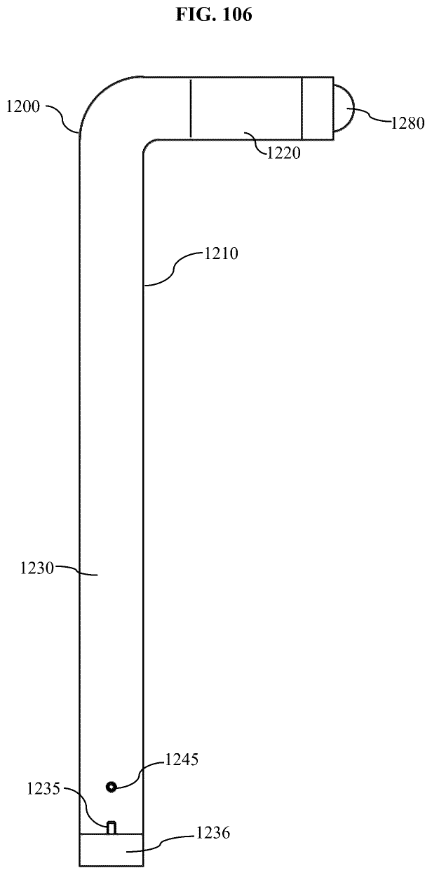

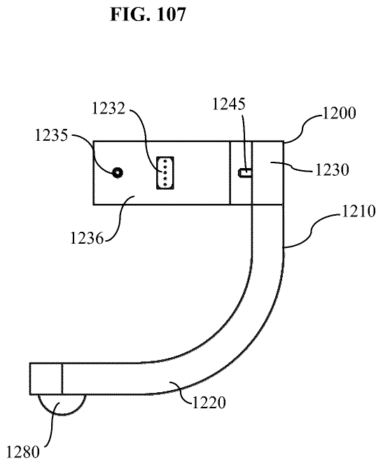

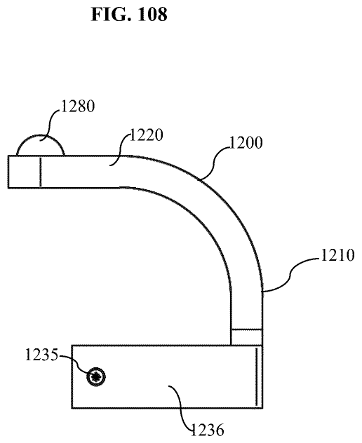

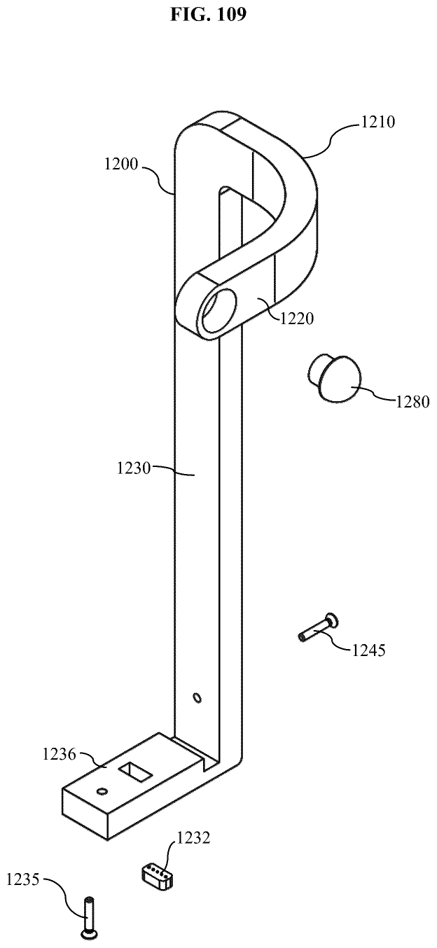

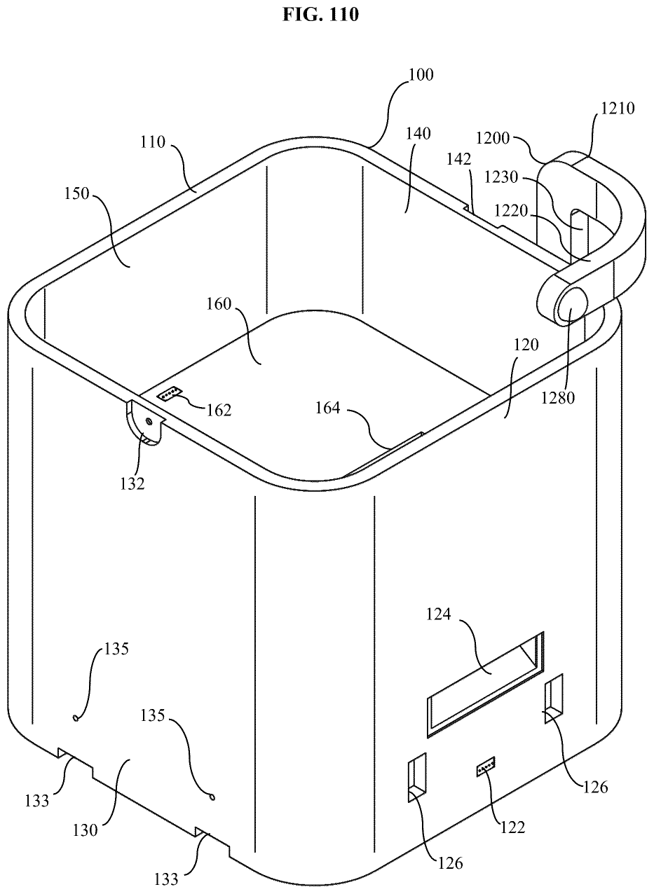

Referring now to another preferred embodiment of the present invention, FIG. 103, FIG. 104, FIG. 105, FIG. 106, FIG. 107, FIG. 108, FIG. 109, and FIG. 110, show a camera module 1200, which is an optional module that may be mounted on the base feeder right side 140 of a base feeder module 100 of a Modular Smart Pet Feeder and which provides video monitoring of the Modular Smart Pet Feeder and a pet using it. FIG. 103 displays a front perspective view of a camera module 1200. FIG. 104 shows a bottom perspective view of a camera module 1200. FIG. 105 depicts a front view of a camera module 1200. FIG. 106 illustrates a left side view of a camera module 1200. FIG. 107 displays a top view of a camera module 1200. FIG. 108 shows a bottom view of a camera module 1200. FIG. 109 depicts an exploded perspective view of a camera module 1200. FIG. 110 illustrates a front perspective view of a camera module 1200 mounted on a base feeder module 100.

In further detail, still referring to the invention of FIG. 103, FIG. 104, FIG. 105, FIG. 106, FIG. 107, FIG. 108, FIG. 109, and FIG. 110, a camera module 1200 comprises a camera body 1210 and a camera unit 1280. The camera body 1210 comprises a camera arm 1220, camera stalk 1230, and a camera base 1236, which are joined together as a single unit. The camera arm 1220 comprises a protrusion, which extends horizontally from the front of the top of the camera stalk 1230 and wraps around the base feeder module 100 from the base feeder right side 140 to the base feeder front side 120 when mounted. The camera stalk 1230 comprises a vertical mast with the camera arm 1220 extending horizontally from the front of the top of the camera stalk 1230 and with the camera base 1236 extending horizontally from the right bottom of the camera stalk 1230 and a camera right fastener 1245. The camera right fastener 1245 comprises a fastener, which extends through the camera stalk 1230 and allows the camera module 1200 to be physically attached to the base feeder right side 140 of the base feeder module 100 using a base feeder left attachment point 135, as described above. The camera base 1236 comprises a protrusion, which extends horizontally from the right bottom of the camera stalk 1230 and which is capable of extending into a base feeder right bottom mount receiver 143 of the base feeder right side 140 of the base feeder module 100 and under the base feeder module 100 for mounting; a camera connector 1232; and a camera bottom mount 1235. The camera connector 1232 comprises extends upwardly from the camera base 1236 and comprises an electronic connector for receiving power from the base feeder module 100 using a base feeder bottom connector 172 and transferring it to camera module 1200 and for facilitating electronic communications between the base feeder module 100 and the camera module 1200, including sending out video signals, whether live or recorded by the camera module 1200. The camera connector 1232 is controllable by and communicates with the base feeder controller 180 of the base feeder module 100. The camera bottom fastener 1235 comprises a fastener, which extends upwardly through the camera base 1236 and allows the camera module 1200 to be physically attached to base feeder bottom side 170 of the base feeder module 100 using a base feeder attachment point 175, as described above. The camera unit 1280 comprises is mounted on the camera arm 1220 and comprises lenses, a light chip, optional storage, a printed circuit board (PCB) with a memory and one or more processors for controlling, managing, and monitoring the camera module 1200, and for communicating with the base feeder module 100, including sending out video signals from the camera module 1200, whether live or recorded. The camera unit 1280 may also comprise wireless connectivity, Bluetooth, Near Field Communication (NFC), internet connectivity, network connectivity, or the like. The camera unit 1280 is also capable of monitoring the functional parameters of various components of the camera module 1200 and predicting when they need to be replaced, as well as being capable of monitoring the functional parameters of various connected modules or communicating those parameters to the base feeder module 100 for monitoring, in order to facilitate preventive and predictive maintenance and report data, which may be displayed in an app, webpage, computer program, or the like. During use, the camera module 1200 may be configured to record video at different times or when a module or component of the Modular Smart Pet Feeder is triggered by an event, such as a feeding time or detection of a pet using the weight scale module 900 or the RFID reader module 1100. The pet owner may also access the camera module 1200 remotely on demand through an app, webpage, computer program, or the like. In some versions of the present invention, the camera module 1200 may be used as a pet detection system, as part of a pet detection system, or for triggering a pet detection system, such as an RFID system or near field system.

The construction details of the invention as shown in FIG. 103, FIG. 104, FIG. 105, FIG. 106, FIG. 107, FIG. 108, FIG. 109, and FIG. 110, are as follows. The camera module 1200 comprises a camera body 1210 and a camera unit 1280. The camera body 1210 comprises a camera arm 1220, camera stalk 1230, and a camera base 1236, which are joined together as a single unit. The camera arm 1220 comprises metal, steel, copper, plastic, high density plastic, silicone, PVC, fiber glass, carbon fiber, composite material, wood, galvanized steel, stainless steel, aluminum, brass, gold, silver, copper, or other like material. The camera stalk 1230 comprises metal, steel, copper, plastic, high density plastic, silicone, PVC, fiber glass, carbon fiber, composite material, wood, galvanized steel, stainless steel, aluminum, brass, gold, silver, copper, or other like material. The camera connector 1232 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. The camera bottom fastener 1235 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The camera base 1236 comprises metal, steel, copper, plastic, high density plastic, silicone, PVC, fiber glass, carbon fiber, composite material, wood, galvanized steel, stainless steel, aluminum, brass, gold, silver, copper, or other like material. The camera right fastener 1245 comprises a fastener, such as a screw, bolt, or nail, or the like, comprising metal, steel, copper, plastic, high density plastic, silicone, PVC, fiber glass, carbon fiber, composite material, wood, galvanized steel, stainless steel, aluminum, brass, gold, silver, copper, or other like material. The camera unit 1280 comprises a camera, a digital video camera, a complementary metal-oxide-semiconductor (“CMOS”) device, a charge-coupled device (“CCD”), an image sensor, an analog camera, lenses, light chip, a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

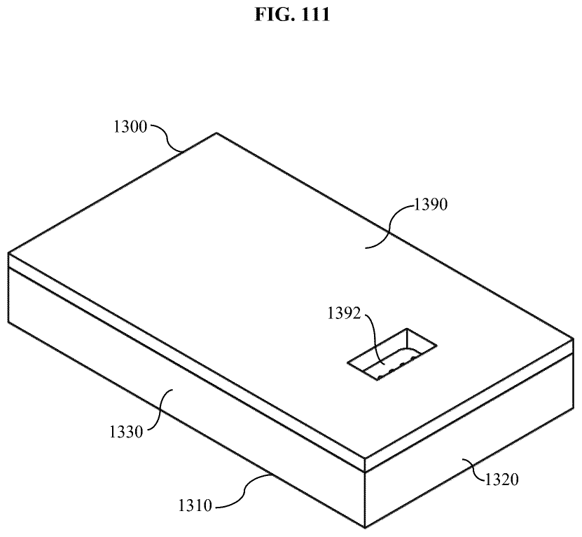

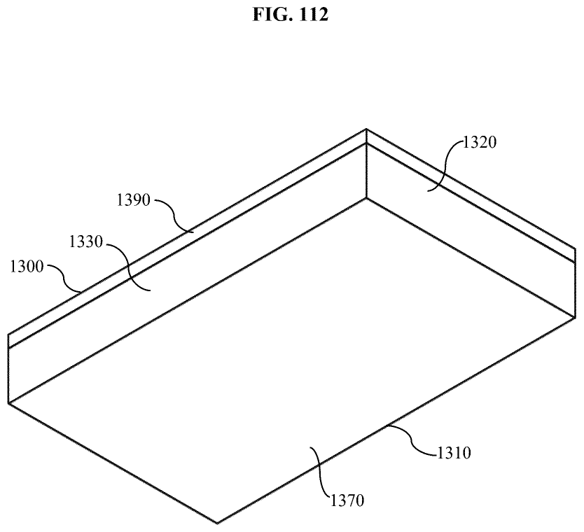

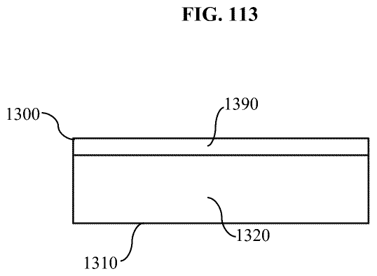

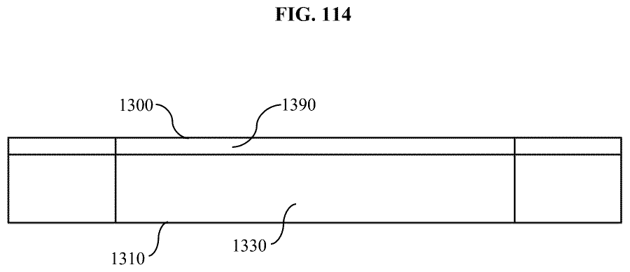

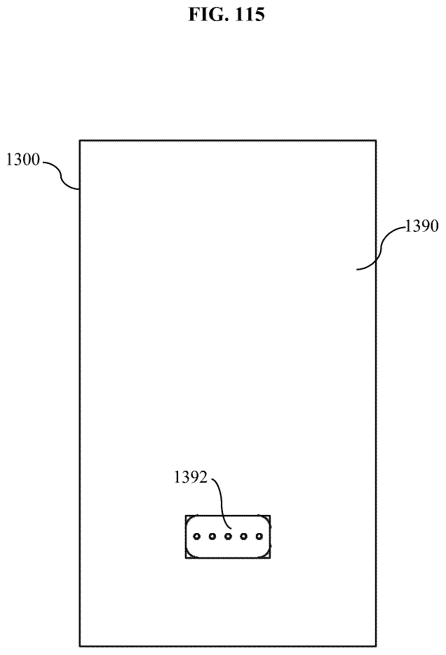

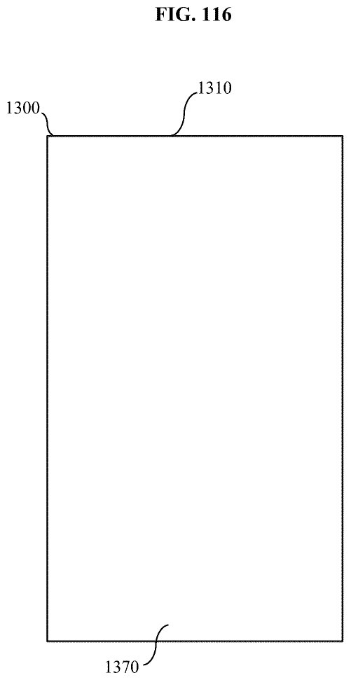

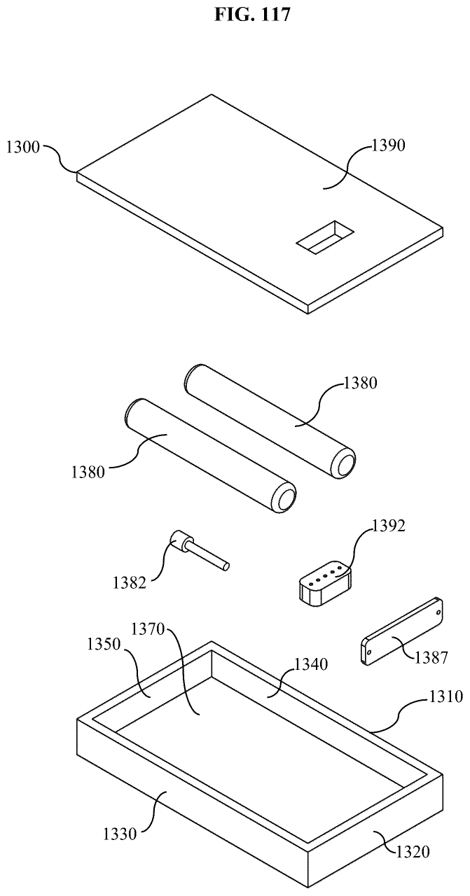

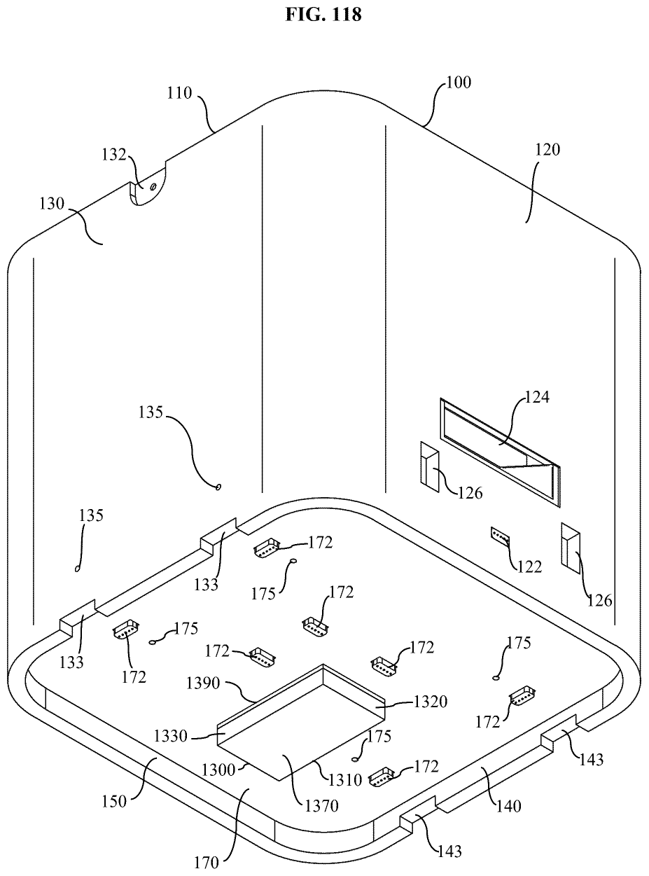

Referring now to another preferred embodiment of the present invention, FIG. 111, FIG. 112, FIG. 113, FIG. 114, FIG. 115, FIG. 116, FIG. 117, and FIG. 118, depict a battery module 1300, which is an optional module that may be mounted on the base feeder bottom side 170 of a base feeder module 100 of a Modular Smart Pet Feeder using a base feeder bottom connector 172 and which provides battery power to the Modular Smart Pet Feeder. FIG. 111 displays a front perspective view of a battery module 1300. FIG. 112 shows a bottom perspective view of a battery module 1300. FIG. 113 depicts a front view of a battery module 1300. FIG. 114 illustrates a left side view of a battery module 1300. FIG. 115 displays a top view of a battery module 1300. FIG. 116 shows a bottom view of a battery module 1300. FIG. 117 depicts an exploded perspective view of a battery module 1300. FIG. 118 illustrates a bottom perspective view of a battery module 1300 mounted on a base feeder module 100.

In further detail, still referring to the invention of FIG. 111, FIG. 112, FIG. 113, FIG. 114, FIG. 115, FIG. 116, FIG. 117, and FIG. 118, a battery module 1300 comprises a battery body 1310, battery cells 1380, battery temperature sensor 1382, a battery controller 1387, and a battery lid 1390. The battery body 1310 comprises a battery front side 1320, a battery left side 1330, a battery right side 1340, a battery rear side 1350, and a battery bottom side 1370, which are joined together as a single unit. The battery front side 1320 comprises a panel, which conceals and protects the internal electronics of a battery module 1300. The battery left side 1330 comprises a panel, which conceals and protects the internal electronics of a battery module 1300. The battery right side 1340 comprises a panel, which conceals and protects the internal electronics of a battery module 1300. The battery rear side 1350 comprises a panel, which conceals and protects the internal electronics of a battery module 1300. The battery bottom side 1370 comprises a panel, which conceals and protects the internal electronics of a battery module 1300. The battery cells 1380 comprise one or more batteries, which are capable of supplying power to a base feeder module 100, to any modules that are connected to the base feeder module 100, to any modules connected to a module connected to the base feeder module 100, and to any other modules, which may be connected to them. The battery temperature sensor 1382 comprises an electronic temperature sensor, which measures the temperature of the battery cells 1380 and relays this information to the battery controller 1387 or the base feeder controller 180 of the base feeder module 100 in order to monitor functionality and provide predictive and preventative maintenance, such as by predicting a battery failure before it occurs so that the battery may be replaced before failure to insure continuous operation of the Modular Smart Pet Feeder. The battery controller 1387 comprises a printed circuit board (PCB) with a memory and one or more processors for controlling, managing, and monitoring the battery module 1300 and for communicating with the base feeder module 100. The battery controller 1387 may also comprise wireless connectivity, Bluetooth, Near Field Communication (NFC), internet connectivity, network connectivity, or the like. The battery controller 1387 is also capable of monitoring the functional parameters of various components of the battery module 1300, such as the battery cells 1380 or the battery temperature sensor 1382, and predicting when they need to be replaced, or communicating those parameters to the base feeder module 100 for monitoring, in order to facilitate preventive and predictive maintenance and report data, which may be displayed in an app, webpage, computer program, or the like. The battery lid 1390 comprises a panel, which fits on top of the battery body 1310 in order to conceal and protect the internal electronics of the battery module 1300, and a battery top connector 1392. The battery top connector 1392 comprises an electronic connector for sending battery power from the battery module 1300 to a base feeder module 100 using a base feeder bottom connector 172, to any modules that are connected to the base feeder module 100, to any modules connected to a module connected to the base feeder module 100, and to any other modules, which may be connected to them. The battery top connector 1392 also facilitates electronic communications between the battery module 1300 and the base feeder module 100 and any other modules, which may be connected to the base feeder module 100. The battery top connector 1392 is controllable by and communicates with the base feeder controller 180 of the base feeder module 100 and/or the battery controller 1387. The battery top connector 1392 can also send data from the battery module 1300 for the purposes of predictive or preventative maintenance or for reporting statistical information about its functionality, such as predicting when the module or a part of the module needs to be replaced or when the battery top connector 1392 may fail so that the module may be replaced to ensure functionality during critical times, such as when a pet owner is away. During use, the battery module 1300 may provide power to a base feeder module 100, to any modules that are connected to the base feeder module 100, to any modules connected to a module connected to the base feeder module 100, and to any other modules, which may be connected to them, when a house power supply is unavailable or if there is a power failure, thereby extending the working time of the Modular Smart Pet Feeder to ensure continual functionality during critical times, such as when a pet owner is away.

The construction details of the invention as shown in FIG. 111, FIG. 112, FIG. 113, FIG. 114, FIG. 115, FIG. 116, FIG. 117, and FIG. 118, are as follows. The battery module 1300 comprises a battery body 1310, battery cells 1380, battery temperature sensor 1382, a battery controller 1387, and a battery lid 1390. The battery body 1310 comprises a battery front side 1320, a battery left side 1330, a battery right side 1340, a battery rear side 1350, and a battery bottom side 1370, which are joined together as a single unit. The battery front side 1320 comprises metal, steel, copper, plastic, high density plastic, silicone, PVC, fiber glass, carbon fiber, composite material, wood, galvanized steel, stainless steel, aluminum, brass, gold, silver, copper, or other like material. The battery left side 1330 comprises metal, steel, copper, plastic, high density plastic, silicone, PVC, fiber glass, carbon fiber, composite material, wood, galvanized steel, stainless steel, aluminum, brass, gold, silver, copper, or other like material. The battery right side 1340 comprises metal, steel, copper, plastic, high density plastic, silicone, PVC, fiber glass, carbon fiber, composite material, wood, galvanized steel, stainless steel, aluminum, brass, gold, silver, copper, or other like material. The battery rear side 1350 comprises metal, steel, copper, plastic, high density plastic, silicone, PVC, fiber glass, carbon fiber, composite material, wood, galvanized steel, stainless steel, aluminum, brass, gold, silver, copper, or other like material. The battery bottom side 1370 comprises metal, steel, copper, plastic, high density plastic, silicone, PVC, fiber glass, carbon fiber, composite material, wood, galvanized steel, stainless steel, aluminum, brass, gold, silver, copper, or other like material. The battery cells 1380 comprises batteries, rechargeable batteries, lithium batteries, battery cells, or the like. The battery temperature sensor 1382 comprises a sensor for measuring temperature, or the like. The battery controller 1387 comprises a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The battery lid 1390 comprises metal, steel, copper, plastic, high density plastic, silicone, PVC, fiber glass, carbon fiber, composite material, wood, galvanized steel, stainless steel, aluminum, brass, gold, silver, copper, or other like material. The battery top connector 1392 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

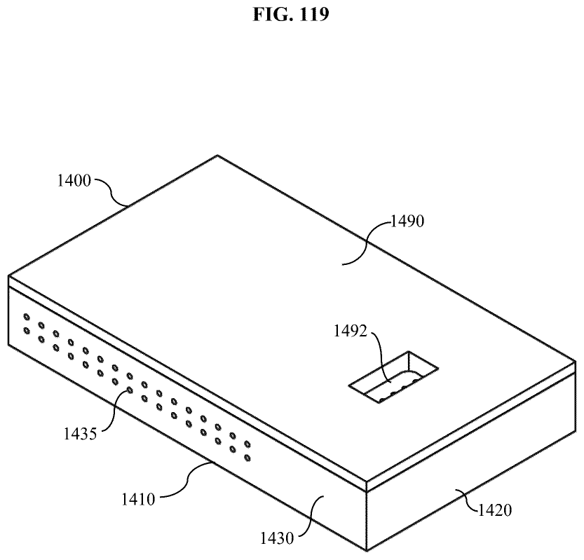

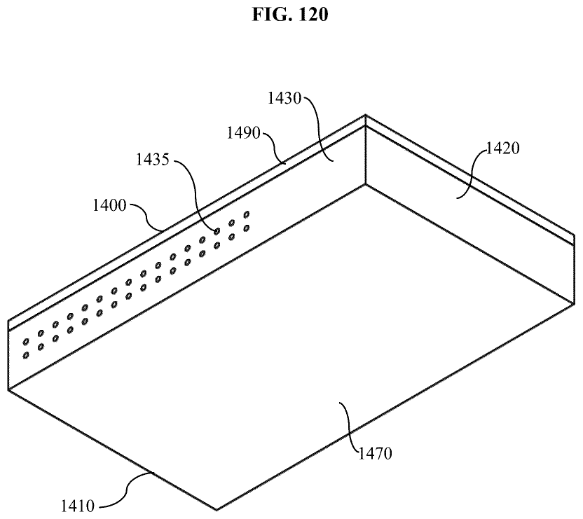

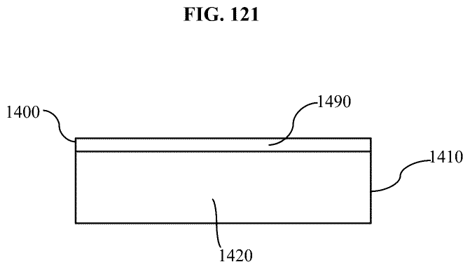

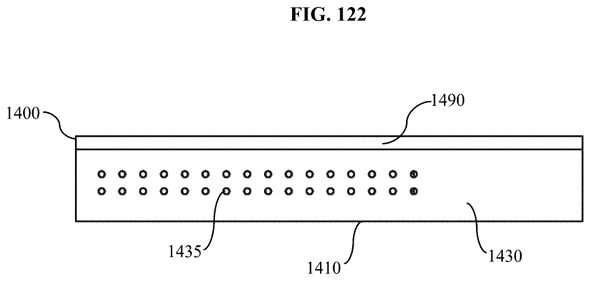

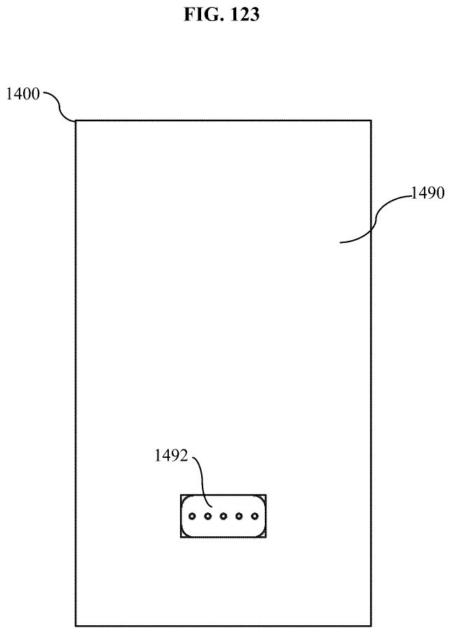

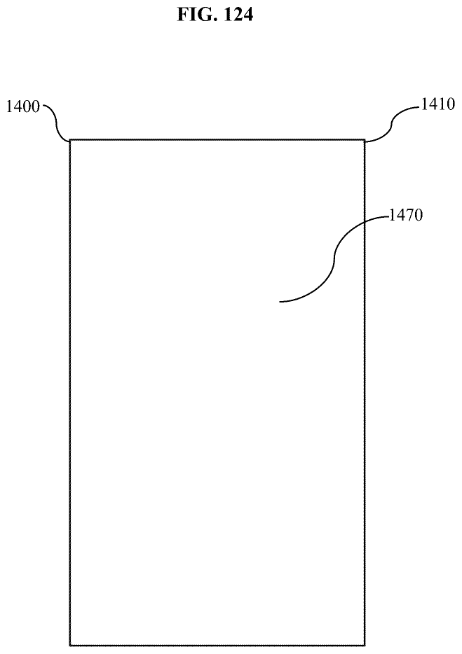

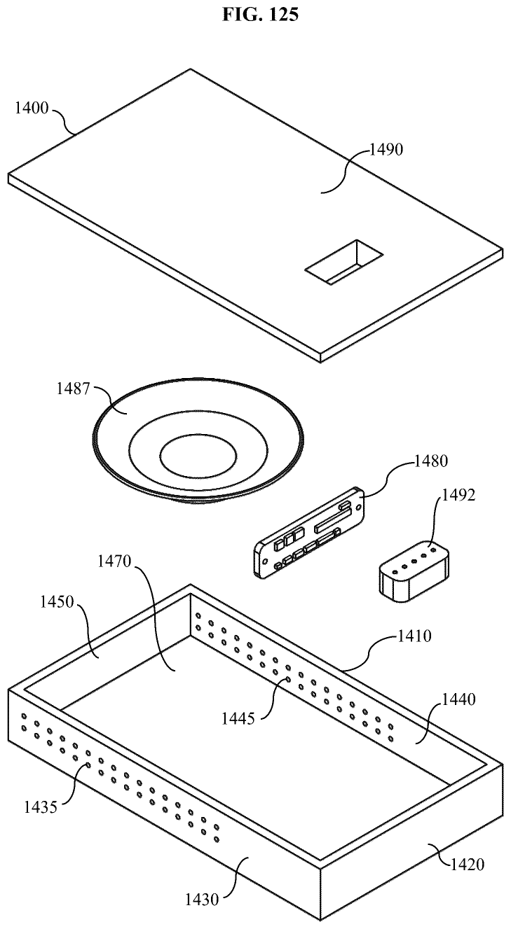

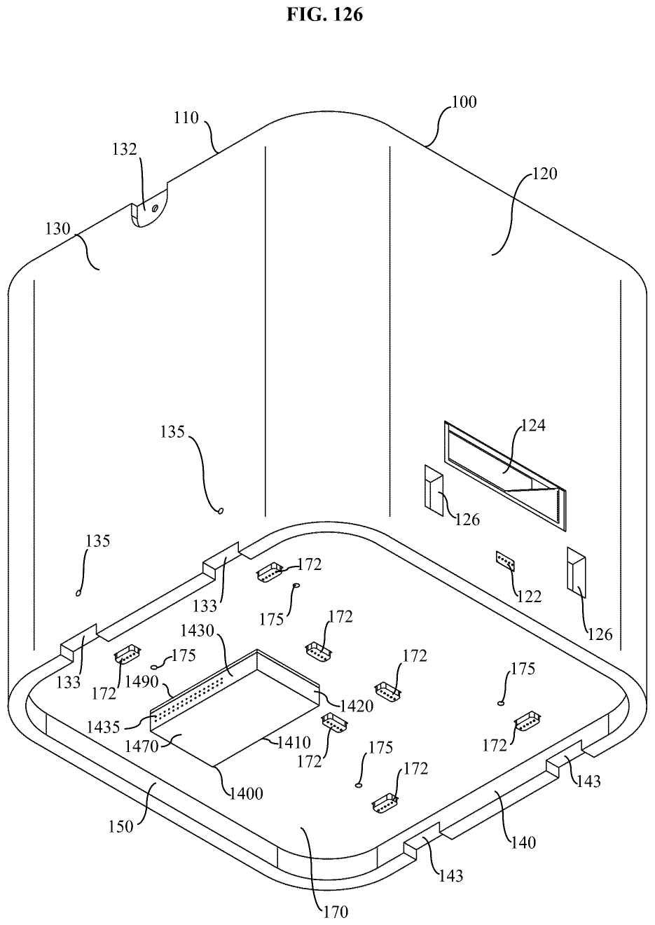

Referring now to another preferred embodiment of the present invention, FIG. 119, FIG. 120, FIG. 121, FIG. 122, FIG. 123, FIG. 124, FIG. 125, and FIG. 126, illustrate a speaker module 1400, which is an optional module that may be mounted on the base feeder bottom side 170 of a base feeder module 100 of a Modular Smart Pet Feeder using a base feeder bottom connector 172 and which allows a Modular Smart Pet Feeder to generate sound. FIG. 119 displays a front perspective view of a speaker module 1400. FIG. 120 shows a bottom perspective view of a speaker module 1400. FIG. 121 depicts a front view of a speaker module 1400. FIG. 122 illustrates a left side view of a speaker module 1400. FIG. 123 displays a top view of a speaker module 1400. FIG. 124 shows a bottom view of a speaker module 1400. FIG. 125 depicts an exploded perspective view of a speaker module 1400. FIG. 126 illustrates a bottom perspective view of a speaker module 1400 mounted on a base feeder module 100.

In further detail, still referring to the invention of FIG. 119, FIG. 120, FIG. 121, FIG. 122, FIG. 123, FIG. 124, FIG. 125, and FIG. 126, a speaker module 1400 comprises a speaker body 1410, a speaker cone 1487, a speaker controller 1480, and a speaker lid 1490. The speaker body 1410 comprises a speaker front side 1420, a speaker left side 1430, a speaker right side 1440, a speaker rear side 1450, and a speaker bottom side 1470, which are joined together as a single unit. The speaker front side 1420 comprises a panel, which conceals and protects the internal electronics of a speaker module 1400. The speaker left side 1430 comprises a panel, which conceals and protects the internal electronics of a speaker module 1400, and a speaker left grill 1435. The speaker left grill 1435 comprises and array of small openings, which allow sound to be emitted from inside the speaker module 1400. The speaker right side 1440 comprises a panel, which conceals and protects the internal electronics of a speaker module 1400, and a speaker right grill 1445. The speaker right grill 1445 comprises and array of small openings, which allow sound to be emitted from inside the speaker module 1400. The speaker rear side 1450 comprises a panel, which conceals and protects the internal electronics of a speaker module 1400. The speaker bottom side 1470 comprises a panel, which conceals and protects the internal electronics of a speaker module 1400. The speaker cone 1487 comprises an electronic component, which generates sound, and communicates with the speaker controller 1480. The speaker controller 1480 comprises a printed circuit board (PCB) with a memory and one or more processors for controlling, managing, and monitoring the speaker module 1400 and for communicating with the base feeder module 100. The speaker controller 1480 may also comprise wireless connectivity, Bluetooth, Near Field Communication (NFC), internet connectivity, network connectivity, or the like. The speaker controller 1480 is also capable of monitoring the functional parameters of various components of the speaker module 1400, such as the speaker cone 1487, and predicting when they need to be replaced, or communicating those parameters to the base feeder module 100 for monitoring, in order to facilitate preventive and predictive maintenance and report data, which may be displayed in an app, webpage, computer program, or the like. The speaker lid 1490 comprises a panel, which fits on top of the speaker body 1410 in order to conceal and protect the internal electronics of the speaker module 1400, and a speaker top connector 1492. The speaker top connector 1492 comprises an electronic connector for transferring power from a base feeder module 100 to the speaker module 1400 using a base feeder bottom connector 172. The speaker top connector 1492 also facilitates electronic communications between the speaker module 1400 and the base feeder module 100 and any other modules, which may be connected to the base feeder module 100. The speaker top connector 1492 is controllable by and communicates with the base feeder controller 180 of the base feeder module 100 and/or the speaker controller 1480. The speaker top connector 1492 can also send data from the speaker module 1400 for the purposes of predictive or preventative maintenance or for reporting statistical information about its functionality, such as predicting when the module or a part of the module needs to be replaced or when the speaker top connector 1492 may fail so that the module may be replaced to ensure functionality during critical times, such as when a pet owner is away. During use, the speaker module 1400 may generate different sounds based on the operation of the Modular Smart Pet Feeder or sounds selected by a user, or play sounds send from an external device or from an app, webpage, computer program, or the like. For example, using the speaker module 1400, a pet owner may talk to their pet while they are away from home.

The construction details of the invention as shown in FIG. 119, FIG. 120, FIG. 121, FIG. 122, FIG. 123, FIG. 124, FIG. 125, and FIG. 126, are as follows. The speaker module 1400 comprises a speaker body 1410, a speaker cone 1487, a speaker controller 1480, and a speaker lid 1490. The speaker body 1410 comprises a speaker front side 1420, a speaker left side 1430, a speaker right side 1440, a speaker rear side 1450, and a speaker bottom side 1470, which are joined together as a single unit. The speaker front side 1420 comprises metal, steel, copper, plastic, high density plastic, silicone, PVC, fiber glass, carbon fiber, composite material, wood, galvanized steel, stainless steel, aluminum, brass, gold, silver, copper, or other like material. The speaker left side 1430 comprises metal, steel, copper, plastic, high density plastic, silicone, PVC, fiber glass, carbon fiber, composite material, wood, galvanized steel, stainless steel, aluminum, brass, gold, silver, copper, or other like material. The speaker left grill 1435 comprises an array of openings in the speaker left side 1430, or the like. The speaker right side 1440 comprises metal, steel, copper, plastic, high density plastic, silicone, PVC, fiber glass, carbon fiber, composite material, wood, galvanized steel, stainless steel, aluminum, brass, gold, silver, copper, or other like material. The speaker right grill 1445 comprises an array of openings in the speaker right side 1440, or the like. The speaker rear side 1450 comprises metal, steel, copper, plastic, high density plastic, silicone, PVC, fiber glass, carbon fiber, composite material, wood, galvanized steel, stainless steel, aluminum, brass, gold, silver, copper, or other like material. The speaker bottom side 1470 comprises metal, steel, copper, plastic, high density plastic, silicone, PVC, fiber glass, carbon fiber, composite material, wood, galvanized steel, stainless steel, aluminum, brass, gold, silver, copper, or other like material. The speaker controller 1480 comprises a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The speaker cone 1487 comprises an electronic component, which generates sound, or the like. The speaker top side 1490 comprises metal, steel, copper, plastic, high density plastic, silicone, PVC, fiber glass, carbon fiber, composite material, wood, galvanized steel, stainless steel, aluminum, brass, gold, silver, copper, or other like material. The speaker top connector 1492 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

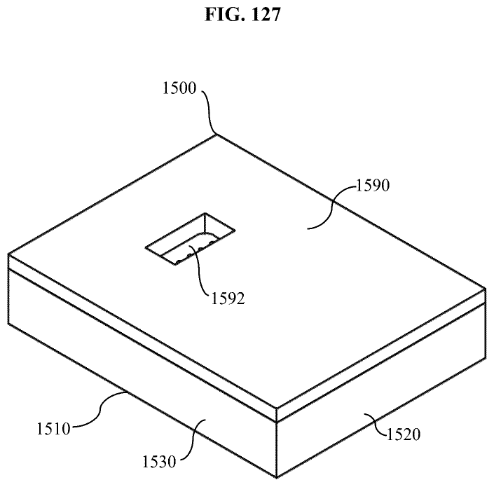

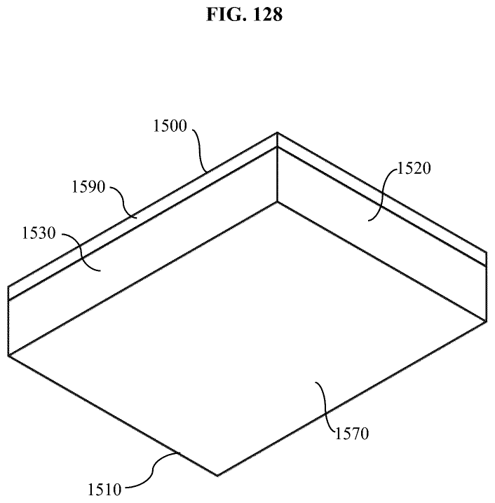

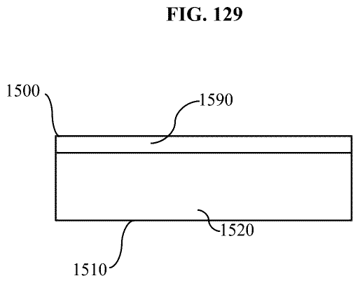

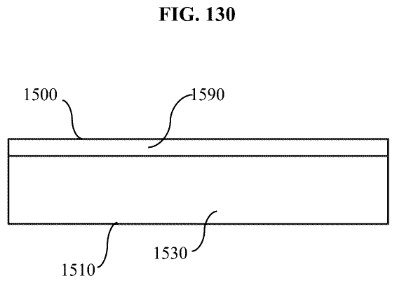

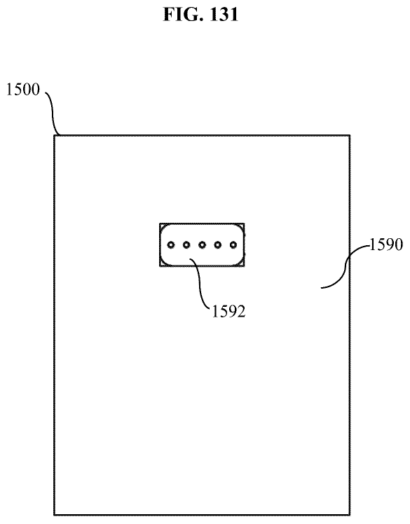

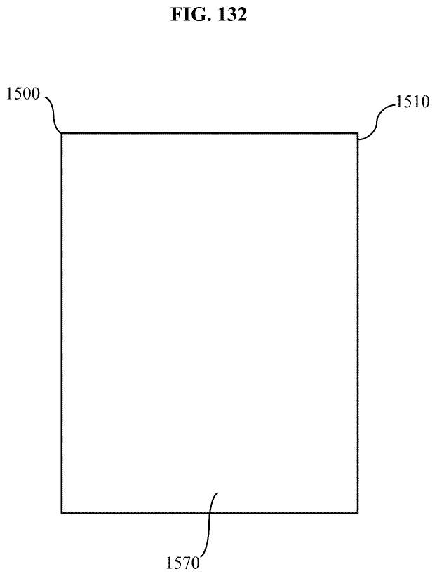

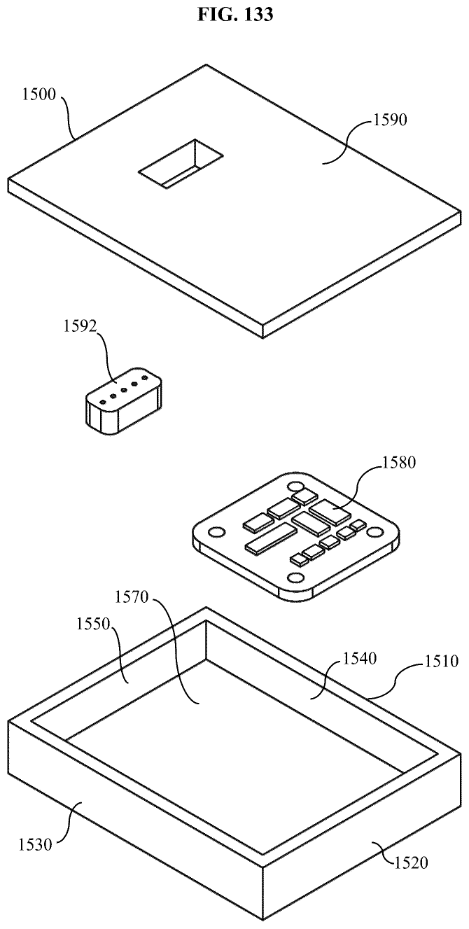

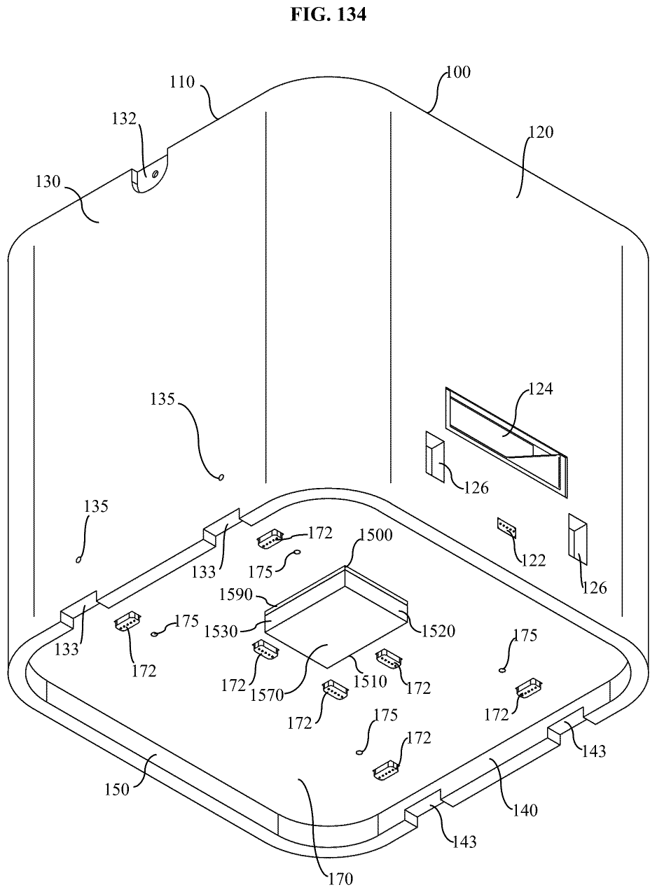

Referring now to another preferred embodiment of the present invention, FIG. 127, FIG. 128, FIG. 129, FIG. 130, FIG. 131, FIG. 132, FIG. 133, and FIG. 134, show a generic module 1500, which is an optional module that may be mounted on the base feeder bottom side 170 of a base feeder module 100 of a Modular Smart Pet Feeder using a base feeder bottom connector 172 and which provides additional modular functionality to the Modular Smart Pet Feeder. FIG. 127 displays a front perspective view of a generic module 1500. FIG. 128 shows a bottom perspective view of a generic module 1500. FIG. 129 depicts a front view of a generic module 1500. FIG. 130 illustrates a left side view of a generic module 1500. FIG. 131 displays a top view of a generic module 1500. FIG. 132 shows a bottom view of a generic module 1500. FIG. 133 depicts an exploded perspective view of a generic module 1500. FIG. 134 illustrates a bottom perspective view of a generic module 1500 mounted on a base feeder module 100.

In further detail, still referring to the invention of FIG. 127, FIG. 128, FIG. 129, FIG. 130, FIG. 131, FIG. 132, FIG. 133, and FIG. 134, a generic module 1500 comprises a generic body 1510, a generic controller 1580, and a generic lid 1590. The generic body 1510 comprises a generic front side 1520, a generic left side 1530, a generic right side 1540, a generic rear side 1550, and a generic bottom side 1570, which are joined together as a single unit. The generic front side 1520 comprises a panel, which conceals and protects the internal electronics of a generic module 1500. The generic left side 1530 comprises a panel, which conceals and protects the internal electronics of a generic module 1500. The generic right side 1540 comprises a panel, which conceals and protects the internal electronics of a generic module 1500. The generic rear side 1550 comprises a panel, which conceals and protects the internal electronics of a generic module 1500. The generic bottom side 1570 comprises a panel, which conceals and protects the internal electronics of a generic module 1500. The generic controller 1580 comprises a printed circuit board (PCB) with a memory and one or more processors for controlling, managing, and The generic controller 1580 may also comprise wireless connectivity, Bluetooth, Near Field Communication (NFC), internet connectivity, network connectivity, or the like. The generic controller 1580 is also capable of monitoring the functional parameters of various components of the generic module 1500 and predicting when they need to be replaced, or communicating those parameters to the base feeder module 100 for monitoring, in order to facilitate preventive and predictive maintenance and report data, which may be displayed in an app, webpage, computer program, or the like. The generic lid 1590 comprises a panel, which fits on top of the generic body 1510 in order to conceal and protect the internal electronics of the generic module 1500, and a generic top connector 1592. The generic top connector 1592 comprises an electronic connector for transferring power from a base feeder module 100 to the generic module 1500 using a base feeder bottom connector 172. The generic top connector 1592 also facilitates electronic communications between the generic module 1500 and the base feeder module 100 and any other modules, which may be connected to the base feeder module 100. The generic top connector 1592 is controllable by and communicates with the base feeder controller 180 of the base feeder module 100 and/or the generic controller 1580. The generic top connector 1592 can also send data from the generic module 1500 for the purposes of predictive or preventative maintenance or for reporting statistical information about its functionality, such as predicting when the module or a part of the module needs to be replaced or when the generic top connector 1592 may fail so that the module may be replaced to ensure functionality during critical times, such as when a pet owner is away. A generic module 1500 may comprise various components, which expand the functionality of a Modular Smart Pet Feeder, including, but not limited to, a microphone for monitoring sounds around the feeder; additional storage or memory, such as for storing recorded videos or sounds or other data collected by the Modular Smart Pet Feeder; WIFI connectivity; modules that control or communicate with wireless modules, which are not physically attached to the Modular Smart Pet Feeder; environmental sensors, such ambient temperature sensors, humidity sensors, pressure sensors, air quality sensors, or the like; a module that entertains a pet with a laser pointer, an “extender module” or “expansion module,” which uses one connection on the base feeder module 100 and allows more than one modules to be attached to it; a module with wheels, which would allow the feeder to move around, or other like customizable modules that may suit the needs or desires of a pet owner. In some versions of the present invention, a generic module 1500 with a microphone may be used as a pet detection system, as part of a pet detection system, or for triggering a pet detection system, such as an RFID system or near field system.

The construction details of the invention as shown in FIG. 127, FIG. 128, FIG. 129, FIG. 130, FIG. 131, FIG. 132, FIG. 133, and FIG. 134, are as follows. The generic module 1500 comprises a generic body 1510, a generic controller 1580, and a generic lid 1590. The generic body 1510 comprises a generic front side 1520, a generic left side 1530, a generic right side 1540, a generic rear side 1550, and a generic bottom side 1570, which are joined together as a single unit. The generic front side 1520 comprises metal, steel, copper, plastic, high density plastic, silicone, PVC, fiber glass, carbon fiber, composite material, wood, galvanized steel, stainless steel, aluminum, brass, gold, silver, copper, or other like material. The generic left side 1530 comprises metal, steel, copper, plastic, high density plastic, silicone, PVC, fiber glass, carbon fiber, composite material, wood, galvanized steel, stainless steel, aluminum, brass, gold, silver, copper, or other like material. The generic right side 1540 comprises metal, steel, copper, plastic, high density plastic, silicone, PVC, fiber glass, carbon fiber, composite material, wood, galvanized steel, stainless steel, aluminum, brass, gold, silver, copper, or other like material. The generic rear side 1550 comprises metal, steel, copper, plastic, high density plastic, silicone, PVC, fiber glass, carbon fiber, composite material, wood, galvanized steel, stainless steel, aluminum, brass, gold, silver, copper, or other like material. The generic bottom side 1570 comprises metal, steel, copper, plastic, high density plastic, silicone, PVC, fiber glass, carbon fiber, composite material, wood, galvanized steel, stainless steel, aluminum, brass, gold, silver, copper, or other like material. The generic controller 1580 comprises a printed circuit board (PCB), a memory, storage, a hard drive, an SSD (solid state drive), integrated circuits, one or more processors, a CPU, a computer, network capability, wireless connectivity, Bluetooth, Near Field Communication (NFC), internet connectivity, network connectivity, or the like. The generic top side 1590 comprises metal, steel, copper, plastic, high density plastic, silicone, PVC, fiber glass, carbon fiber, composite material, wood, galvanized steel, stainless steel, aluminum, brass, gold, silver, copper, or other like material. The generic top connector 1592 comprises an electrical connector comprising electronics, metal, steel, copper, plastic, high density plastic, silicone, PVC, fiber glass, carbon fiber, composite material, galvanized steel, stainless steel, aluminum, brass, gold, silver, copper, or other like material. Although the foregoing examples of materials have been described in some detail for purposes of clarity of understanding, the above-described materials are not limited to the details provided. There are many alternative ways of implementing the above-described invention. The disclosed examples are illustrative and not restrictive. These materials are not intended to limit the scope of the present invention.

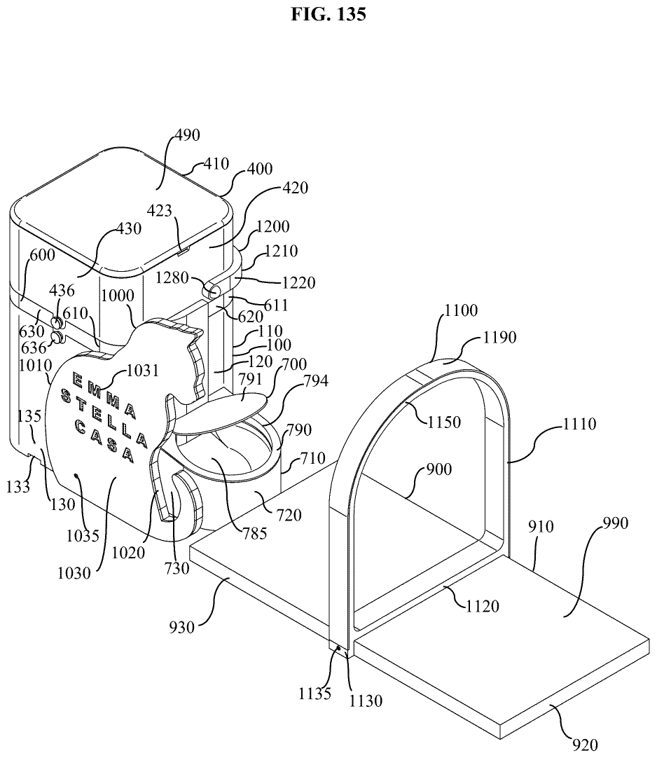

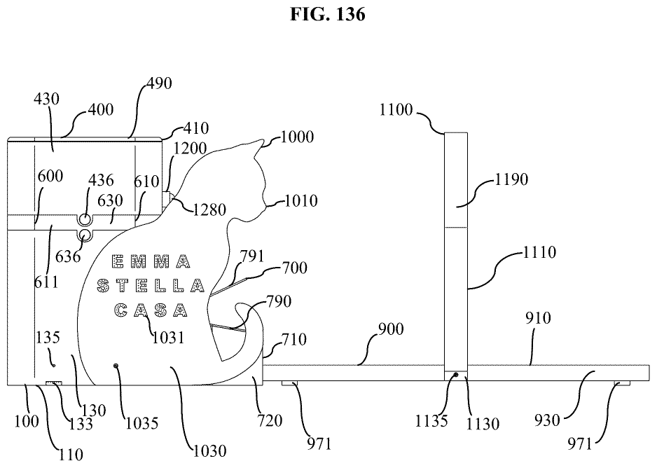

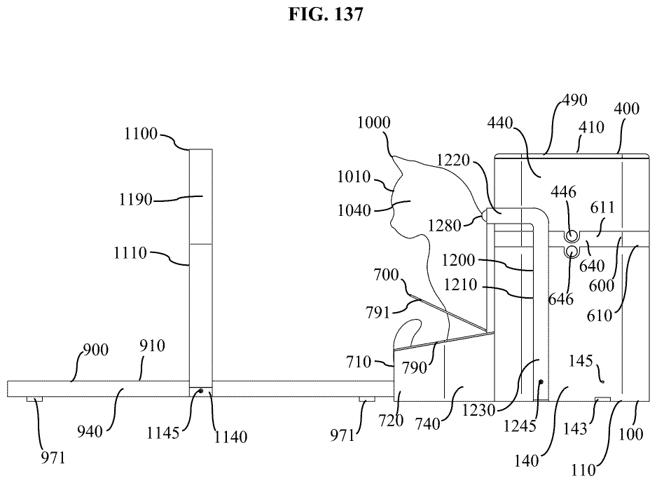

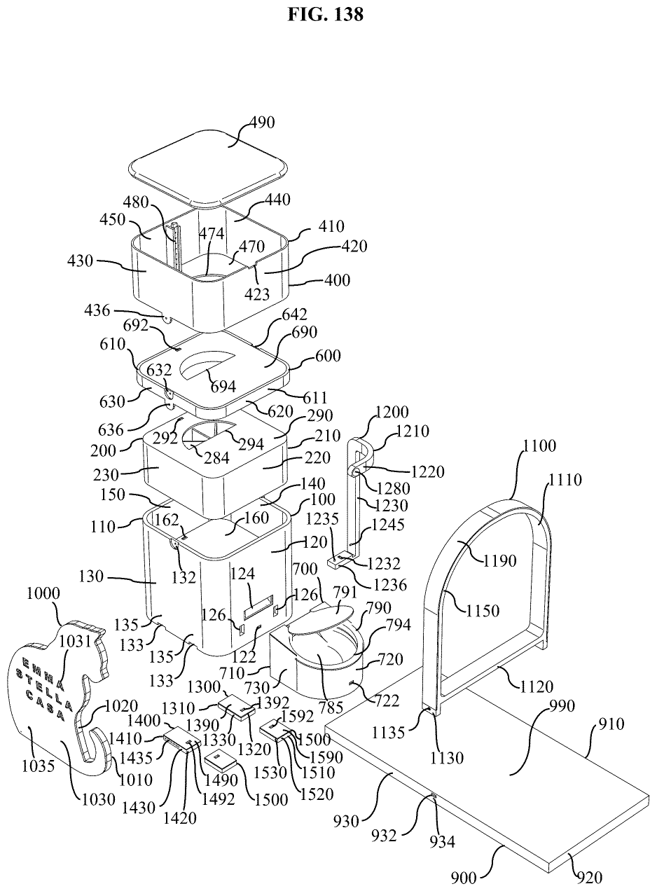

Referring now to FIG. 135, FIG. 136, FIG. 137, and FIG. 138, a configuration of combined modules of a Modular Smart Pet Feeder of the present invention is depicted. FIG. 135 is a front perspective view of a configuration of combined modules comprising: a food container module 400 connected to a LED ring module 600, which is connected to a base feeder module 100; a rotating depending mechanism module 200 installed within the base feeder module 100; a food bowl module 700, a side wall module 1000, a camera module 1200, a battery module 1300, a speaker module 1400, and two generic modules 1500, which are all mounted on the base feeder module 100; a weight scale module 900, which is mounted on the food bowl module 700; and an RFID reader module 1100, which is mounted on the weight scale module 900. FIG. 136 is a left side view of the configuration of FIG. 135. FIG. 137 is a right side view of the configuration of FIG. 135. FIG. 138 is an exploded perspective view of a configuration of FIG. 135. A Modular Smart Pet Feeder may also use other customizable combinations of modules as desired by the user.

In further detail, still referring to the invention of FIG. 135, FIG. 136, FIG. 137, and FIG. 138, the illustrated configuration of combined modules comprises a food container module 400 mounted on a LED ring module 600, which in turn is mounted on a base feeder module 100; a rotating depending mechanism module 200 installed within the base feeder module 100; a food bowl module 700, a side wall module 1000, a camera module 1200, a battery module 1300, a speaker module 1400, and two generic modules 1500, which are mounted on the base feeder module 100; a weight scale module 900, which is mounted on the food bowl module 700; and an RFID reader module 1100, which is mounted on the weight scale module 900. The food container module 400 is connected to the LED ring module 600 by connecting the food container bottom connector 472 of the food container module 400 to the LED ring connector 692 of the LED ring module 600, attaching the food container left fastener 436 of the food container module 400 to the LED ring left mount receiver 632 of the LED ring module 600, and attaching the food container right fastener 446 of the food container module 400 to the LED ring right mount receiver 642 of the LED ring module 600. The LED ring module 600 is connected to the base feeder module 100 by connecting the LED ring connector 692 of the LED ring module 600 to the rotating dispenser top connector 292 of the rotating depending mechanism module 200 installed within the base feeder module 100, attaching the LED ring left fastener 636 of the LED ring module 600 to the base feeder left top mount receiver 132 of the base feeder module 100, and attaching the LED ring right fastener 646 of the LED ring module 600 to the base feeder right top mount receiver 142 of the base feeder module 100. The rotating depending mechanism module 200 is installed within the base feeder module 100 by connecting the rotating dispenser bottom connector 272 of the rotating depending mechanism module 200 to the base feeder middle connector 162 of the base feeder module 100. The food bowl module 700 is connected to the base feeder module 100 by connecting the food bowl rear connector 752 of the food bowl module 700 to the base feeder front connector 122 of the base feeder module 100 and mounting the food bowl rear hooks 756 of the food bowl module 700 to the base feeder front mount receivers 126 of the base feeder module 100. The side wall module 1000 is connected to the base feeder module 100 by connecting the side wall right connector 1042 of the side wall module 1000 to a base feeder bottom connector 172 of the base feeder module 100, attaching the side wall left mount fastener 1035 of the side wall module 1000 to a base feeder left attachment point 135 of the base feeder module 100, and attaching the side wall right mount fastener 1045 of the side wall module 1000 to a base feeder attachment point 175 of the base feeder module 100. The camera module 1200 is connected to the base feeder module 100 by connecting the camera connector 1232 of the camera module 1200 to a base feeder bottom connector 172 of the base feeder module 100, attaching the camera right fastener 1245 of the camera module 1200 to a base feeder right attachment point 145 of the base feeder module 100, and attaching the camera bottom fastener 1235 of the camera module 1200 to a base feeder attachment point 175 of the base feeder module 100. The battery module 1300 is connected to the base feeder module 100 by connecting the battery top connector 1392 of the battery module 1300 to a base feeder bottom connector 172 of the base feeder module 100. The speaker module 1400 is connected to the base feeder module 100 by connecting the speaker top connector 1492 of the speaker module 1400 to a base feeder bottom connector 172 of the base feeder module 100. The two generic modules 1500 are connected to the base feeder module 100 by connecting the generic top connectors 1592 of the generic modules 1500 to base feeder bottom connectors 172 of the base feeder module 100. The weight scale module 900 is connected to the food bowl module 700 by connecting the weight scale rear connector 952 of the weight scale module 900 to the food bowl front connector 722 of the food bowl module 700. The RFID reader module 1100 is connected to the weight scale module 900 by connecting the RFID reader left connector 1132 of the RFID reader module 1100 to the weight scale left connector 932 of the weight scale module 900, connecting the RFID reader right connector 1142 of the RFID reader module 1100 to the weight scale right connector 942 of the weight scale module 900, attaching the RFID reader left fastener 1135 of the RFID reader module 1100 to the weight scale left attachment point 934 of the weight scale module 900, and attaching the RFID reader right fastener 1145 of the RFID reader module 1100 to the weight scale right attachment point 944 of the weight scale module 900. The base feeder controller 180 of the base feeder module 100 coordinates power and communication to all modules shown in this example of a combined configuration.

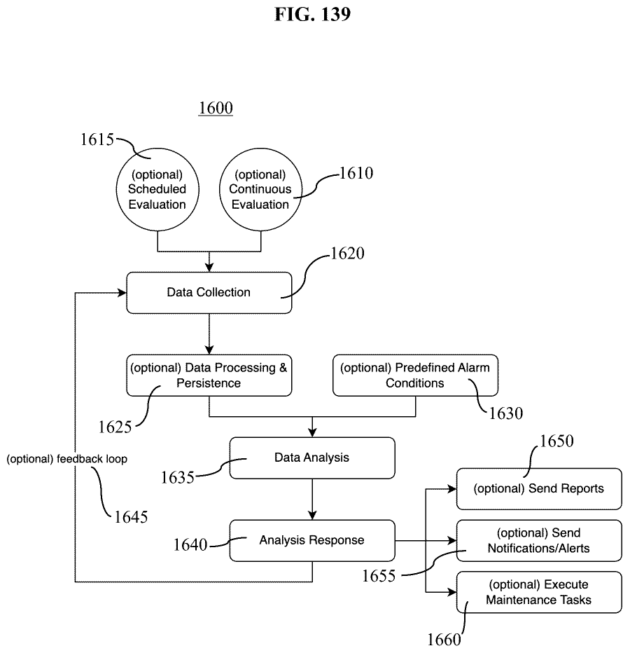

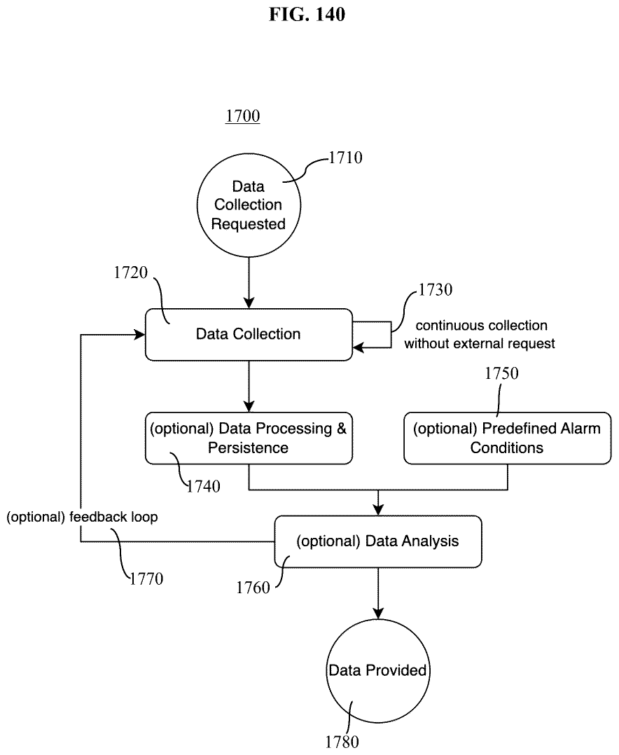

Referring now to FIG. 139 and FIG. 140, FIG. 139 shows a general modular smart pet feeder flowchart 1600, which describes the processes undergone by a Modular Smart Pet Feeder including its predictive maintenance system and preventative maintenance system, and FIG. 140 illustrates a pet feeder module flowchart 1700, which describes the processes undergone by individual modules of a Modular Smart Pet Feeder. A Modular Smart Pet Feeder of the present invention may be operated in at least two modes: scheduled operation, such as every hour or at some other regular preprogramed interval, or continuous operation. During use of a Modular Smart Pet Feeder, the first steps in the general modular smart pet feeder flowchart 1600 is to select an optional mode of operation. In the scheduled evaluation step 1615, the scheduled operation mode for a Modular Smart Pet Feeder is selected, wherein the Modular Smart Pet Feeder is programmed to operate at a regular interval, such as every hour, or at some other interval. In the continuous evaluation step 1610, the continuous operation mode for a Modular Smart Pet Feeder is selected, wherein the Modular Smart Pet Feeder is programmed to operate continuously. Whether scheduled operation or continuous operation is selected, next, in the data collection step 1620, data is gathered from the various modules combined in the Modular Smart Pet Feeder, depending on the desired configuration of the user. The data gathered includes, but is not limited to, the electrical current value of a component of a module; the expected value/limits of data that can be measured from a component of a module, such as from a sensor or the like; and suggested actions to be taken by the base feeder module 100 based on the information gathered from the modules. Some parameters from other connected modules can be monitored from the base feeder module 100, including, but not limit to, the following: the energy consumption of a module; the electric current level of components of various modules; a module's start-up time, which is the amount of time beginning at the moment that the module first receives power until the moment that the module is ready and operational; a module's response time for each command, such as the amount of time for a module to respond to a command to provide collected data, the amount of time for a module to respond to a command to start opening the lid, the amount of time for a module to respond to a command to make all LEDs red, or the like; the signal integrity of an analog module, such as the signal-to-noise level, the response frequency, the signal strength/voltage, or the like; the signal integrity of a digital module, such as the error rate, the number of malformed responses, the number of responses with an incorrect checksum; and/or the mean time between failures (MTBF). Next, the data processing and persistence step 1625 comprises an optional step for cleaning and/or preprocessing the data in order to prepare it for analysis. If needed, in the data processing and persistence step 1625, data persistence occurs in which further data analysis uses historical data from a Modular Smart Pet Feeder. Optionally, alarm conditions for various components of modules of a Modular Smart Pet Feeder may be entered into the process in the predefined alarm conditions step 1630. Next, in the data analysis step 1635, analysis is applied to current and past data gathered from a Modular Smart Pet Feeder including, but not limited to mathematical analysis, statistical analysis, Artificial Intelligence/Machine Learning (AI/ML) analysis, or the like, in order to detect patterns and anomalies. Optionally, the data analysis step 1635 can utilize alarm conditions, which are predefined by a module component's manufacturer or determined by a user and which were inputted in the predefined alarm conditions step 1630. In the data analysis step 1635, analysis may be performed on data from each individual module, such as analysis that indicates that the temperature of a motor is exceeding or approaching its upper limit or that the average temperature value is increasing substantially over a recent period of time. For example, during the data analysis step 1635, data analysis may show that the temperature of the rotating dispenser motor 287 of the rotating dispenser module 200, as measured by the rotating dispenser temperature sensor 286, is exceeding 100 F or is being measured at twice the average value measured over the previous 5 days. Additionally, in the data analysis step 1635, analysis may be performed on data across modules. For example, if a motor begins emitting an unexpected sound, such as a squeaky noise or grinding noise, the nonconforming sound may be detected by a module with a microphone module, analyzed in the data analysis step 1635, wherein it is identified as a prediction of imminent failure for predictive maintenance purposes so that corrective action may occur before the component fails, which could prevent a pet from feeding from the Modular Smart Pet Feeder when the owner is away. Next, in the analysis response step 1640, once anomalies are identified in the previous data analysis step 1635, corrective action is performed in order to ensure continual operation of Modular Smart Pet Feeder. Depending on the severity of an anomaly and the likelihood of a failure, the actions may involve no action, one action, or multiple actions. In the optional send reports step 1650, reports are sent to the user with past and/or current data to inform the pet owner about the status of their Modular Smart Pet Feeder. If there are no anomalies, the user is informed that the Modular Smart Pet Feeder is working as expected and no actions are necessary. If anomalies occur, any pending and/or detected anomalies are attached to the report to notify the user. In the send notification/alerts step 1655, if the predictive maintenance system of the Modular Smart Pet Feeder determines that there will likely be an eminent failure of the Modular Smart Pet Feeder, a module of the Modular Smart Pet Feeder, or a component of a module of the Modular Smart Pet Feeder, the user may be notified by SMS text message, phone call, email, and/or push notification. In the execute maintenance tasks step 1660, the Modular Smart Pet Feeder may take certain steps within its capabilities or notify the user of actions that they need to take to ensure the continual operation of the Modular Smart Pet Feeder, including, but not limited to, the following: automatically notifying the user of a malfunctioning module that requires replacement, turning off or hibernating a malfunctioning module if it is not critical for operation of the Modular Smart Pet Feeder, or altering a malfunctioning module's behavior. For example, the Modular Smart Pet Feeder may turn off LED lights in a module if the feeder detects too much energy consumption and predicts that an LED burnout is approaching. As another example, if a problem with the food bowl motor 787 of a food bowl module 700 is detected, the predictive maintenance system of the Modular Smart Pet Feeder may decide to keep the food bowl lid 791 open at all times to ensure that the pet continues to have access to dispensed food even if the food bowl motor 787 fails. Next, the predictive maintenance system of the Modular Smart Pet Feeder sends a pre-paid box to the user, so that the user may pack up the defective module for repair; the predictive maintenance system of the Modular Smart Pet Feeder sends a new feeder is sent to the user, as implementation of a warranty. Optionally, using the feedback loop 1645, the process undergone by a Modular Smart Pet Feeder may be started again, incorporating analysis responses from the analysis response step 1640 into new iterations, such that the predictive maintenance system of the Modular Smart Pet Feeder constantly and dynamically improves. All steps after the data collection step 1620 may be processed in the cloud or outside of the feeder, such as by a separate computer or server, which allows the analysis of data from multiple feeders in order to detect outliers. For example, if one weight scale module 900 on one Modular Smart Pet Feeder exhibits a higher signal-to-noise ratio than weight scale modules 900 in other feeders, it will provide inaccurate information and will be flagged for replacement. FIG. 140 shows a pet feeder module flowchart 1700, which describes the processes undergone by individual modules of a Modular Smart Pet Feeder data collection is requested in the data collection step 1620 of the general modular smart pet feeder flowchart 1600, as described above. First, in the data request step 1710 of the pet feeder module flowchart 1700, when data collection is requested in the data collection step 1620 of the general modular smart pet feeder flowchart 1600, the module to which the data request was sent gathers data about itself for delivery to the predictive maintenance system. Next, in the module data collection step 1720, the predictive maintenance system collects the requested data sent from the module, which received the data collection request in the data request step 1710. Data collection may also happen in the background, even if the base feeder module 100 is not requesting it as shown in the continuous collection loop 1730. Next, the module data processing and persistence step 1740 comprises an optional step for cleaning and/or preprocessing and storing the data within the individual module in order to prepare it for analysis by the predictive maintenance system of the Modular Smart Pet Feeder. For example, a module may calculate an average of the last ten (10) temperature readings and provide the average to the predictive maintenance system. Optionally, alarm conditions for various components of an individual module of a Modular Smart Pet Feeder may be entered into the process in the module predefined alarm conditions step 1750. Next, in the optional module data analysis step 1760, each module may evaluate its own status using its own specific analysis rules and/or algorithms depending on the particular components of each module and share it with the base feeder module 100, such as providing a current value of a parameter and its expected value, and suggested maintenance actions, if appropriate. Optionally, using the module feedback loop 1770, the process undergone by an individual module of a Modular Smart Pet Feeder may be started again, incorporating analysis responses from the module data analysis step 1760 into new iterations, such that the predictive maintenance system of the Modular Smart Pet Feeder constantly and dynamically improves. Finally, in the provide module data step 1780 the individual module provides collected, processed, and/or analyzed data to the base feeder module 100 or the predictive maintenance system of the Modular Smart Pet Feeder. There are three categories of data that the predictive maintenance system of the Modular Smart Pet Feeder collects and monitors: parameters monitored from the base feeder module 100, as described as part of general modular smart pet feeder flowchart 1600 above; generic parameters monitored in an individual module about itself, such as the voltage, electric current level, and/or energy consumption within the module as measured by the module itself, or, if a module contains its own processing unit, the memory utilization level, the processing utilization level, the time since last restart, the firmware version, or the like; and specific metrics monitored by each module, as described below. For the base feeder module 100, specific metrics include, but are not limited to, total energy consumption, electric current level, power supply voltage, voltage ripple, or the like. For the food dispensing modules, such as the rotating dispenser module 200 or the auger dispenser module 300, specific metrics include, but are not limited to, motor current, such as the current of the rotating dispenser motor 287 of the rotating dispenser module 200 or the current of the auger dispenser motor 387 of the rotating dispenser module 200; motor temperature using a temperature sensor, such as the rotating dispenser temperature sensor 286 of the rotating dispenser module 200 or the auger dispenser temperature sensor 386 of the rotating dispenser module 200; motor position using a position sensor, such as the rotating dispenser position sensor 281 of the rotating dispenser module 200 or the auger dispenser position sensor 381 of the rotating dispenser module 200; the amount of time needed to move the motor by 1 degree (motor speed); for stepper motors, the number of motor steps needed to move the motor by 1 degree; the delay between sending an electric signal to move the motor and motor movement; or the like. For the food container module 400, specific metrics include, but are not limited to, food level using the food container level sensor 480, ambient light level using the food container level sensor 480, whether the lid is on or off using the food container lid sensor 481, the amount of time since the lid was on or off using the food container lid sensor 481, or the like. For the LED ring module 600, specific metrics include, but are not limited to, parameters monitored from the base feeder module 100, as described as part of general modular smart pet feeder flowchart 1600 above; generic parameters monitored in the LED ring module 600 about itself, such as the voltage, electric current level, and/or energy consumption within the LED ring module 600 as measured by the LED ring module 600 itself, the memory utilization level, the processing utilization level, the time since last restart, the firmware version, or the like. For the food bowl module 700, specific metrics include, but are not limited to, the time, speed, steps (for stepper motors) of the food bowl lid 791 opening or closing using the food bowl lid switch 786; whether the food bowl lid 791 is opened or closed using the food bowl lid switch 786; data from a connected weight scale module 900, such as food weight scale readings, weight scale readings RMSE (root mean square error), weight scale readings signal-to-noise ratio (SNR), food weight scale temperature to implement temperature compensation, food weight scale response time and the amount of time it takes to get a reading from the weight scale; with coupled readings of the food bowl module 700 and a food dispenser module, such as the rotating dispenser module 200 or the auger dispenser module 300, the amount of time needed to dispense 1 gram of food to the food bowl module 700, the number of motor steps of number of motor degrees needed to dispense 1 gram of food, food weight scale stability including the stability of readings when no new food is added to the bowl, or the like. For the weight scale module 900, specific metrics include, but are not limited to, weight scale readings, weight scale readings RMSE (root mean square error), weight scale readings signal-to-noise ratio (SNR), weight scale temperature to implement temperature compensation, weight scale response time and the amount of time needed to get a reading from the weight scale, or the like. For the side wall module 1000, specific metrics include, but are not limited to, parameters monitored from the base feeder module 100, as described as part of general modular smart pet feeder flowchart 1600 above; generic parameters monitored in the side wall module 1000 about itself, such as the voltage, electric current level, and/or energy consumption within the side wall module 1000 as measured by the side wall module 1000 itself, the memory utilization level, the processing utilization level, the time since last restart, the firmware version, or the like. For the RFID reader module 1100, specific metrics include, but are not limited to, read data, read rate (the number of successful tag reads per unit of time), read failure rate (the number of reads that succeeded divided by all read attempts), signal strength, antenna noise level, read errors (collision errors, framing errors, CRC errors), buffer overflow errors, or the like. For the camera module 1200, specific metrics include, but are not limited to, images, frame rate, exposure time, focus metrics, signal-to-noise ratio, temperature using a built-in sensor, latency (the time between capturing an image and its availability), error rates, or the like. For the battery module 1300, specific metrics include, but are not limited to, battery state of charge (SoC), battery state of health (SoH), battery voltage including individual cells voltage, battery temperature using the battery temperature sensor 1382, battery charging current, charging voltage, charging time, battery charge/discharge cycles, or the like. For the speaker module 1400, specific metrics include, but are not limited to, parameters monitored from the base feeder module 100, as described as part of general modular smart pet feeder flowchart 1600 above; generic parameters monitored in the speaker module 1400 about itself, such as the voltage, electric current level, and/or energy consumption within the speaker module 1400 as measured by the speaker module 1400 itself, the memory utilization level, the processing utilization level, the time since last restart, the firmware version, or the like. For the generic module 1500 with a microphone, specific metrics include, but are not limited to, signal, signal-to-noise ratio (SNR), latency (the time between capturing sound and its availability as signal), clipping level/maximum sound pressure level (SPL), or the like. For storage and memory, specific metrics include, but are not limited to, read/write speed (throughput), read/write latency, read/write IOPS (input/output operations per second), capacity utilization, error rates, SMART data, temperature using a built-in sensor, queue depth, or the like. For WIFI, specific metrics include, but are not limited to, signal strength (RSSI), noise level, security protocol, frequency, connection uptime, data transmission rate, packet loss, or the like. For environmental sensors, such as temperature, humidity, and pressure sensors, specific metrics include, but are not limited to, read latency, calibration status (info when sensor was last calibrated and its calibration state), communication faults/errors, or the like. In some versions of the present invention, the predictive maintenance system uses a server to monitor many Modular Smart Pet Feeders and compares the system data of each one and monitors them for outliers, fliers, anomalies, aberrations, or the like, in order to predict when one of the Modular Smart Pet Feeders, a portion thereof, or one of its connectable modules, is in need of maintenance or replacement and notifies the user of an anomalous Modular Smart Pet Feeder of an identified problem with it. The predictive maintenance system of the Modular Smart Pet Feeder ensures continual functionality of the Modular Smart Pet Feeder and its various modules and critical components in order to ensure that feeding is always available when a cat owner is absent and so that failures, which could deprive a pet from food, can be avoided.

The advantages of the present invention include, without limitation, that it automatically feeds pets, even when the pet owner is away; that it provides optional modules, which may be assembled in customizable configurations; that its modularity allows for specific configurations to address a pet's particular needs; that the modularity allows adjustment to a pet owner's budget, such as by only using modules that the owner can afford; that its modularity allows for the system to be expanded over time; that it manages pet feeding in order to improve a pet's health; that it stores pet food; that it may measure the amount of pet food it stores; that it may dispense pet food periodically using a timing system, on demand, or based on measured metrics, such as a pet's weight; that it encourages pets to eat; that it provides entertainment for pets and their owners; that it provides customizable decoration and ornamentation; that it provides customizable lighting; that it may function as a night light; that the modules fit together in a compact, organized, and highly functional manner; that the modules communicate with each other for efficient module management; that it is capable of reporting metrics about pets and the system itself to a user and recommend actions based on those metrics; that it optionally has internet capabilities, which allow for remote monitoring and control; that it and its module optionally have WIFI capabilities, which allow from remote monitoring and control; that it is optionally capable of weighing a pet while it is eating in order to manage the pet's health and to measure the amount of food actually consumed; that it is capable of weighing the amount of pet food dispensed for precise portion control; that is optionally uses UV light to sterilize feeding areas; that it allows a pet owner to interact with their pet remotely; that it allows a pet owner to view their pet remotely; that it is optionally capable of generating sounds; that it is optionally capable of detecting sounds; that it is capable of operating using battery power if a power failure occurs in order to ensure continuous operation; that that it allows for the management of multiple pets; that it optionally uses pet identification systems to identify individual pets; that it is capable of monitoring environmental conditions to ensure a pet's health; that it gathers metrics about pets for use in improving their health; that it may automatically orders pet food when the pet food runs out; that it predicts failures so that parts of the base apparatus, modules, or parts of modules, may be replaced or repaired before failing in order to ensure continuous operation; that it may monitor multiple feeders for outliers; and that it may automatically orders parts that are predicted to fail. Overall, the present invention offers a provides a highly functional and data-driven device, which automatically feeds a pet or multiple pets, which monitors the health and feeding activity of the pets, as well as, monitoring its own the health, and which is capable of using numerous optional connectable modules for improved functionality and ornamentation.

In broad embodiment, the present invention relates generally to an apparatus for automatically feeding pets, which may be remotely controlled or monitored, and which includes optional “plug-and-play” connectable modules that provide additional functionality and relay important metrics concerning a pet's physical wellbeing or the condition or status of the various modules, as well as provide entertainment for the pet in a stylish manner. Additionally, the present invention may provide predictive maintenance capability for critical components of the apparatus so that failures that could deprive a pet from food can be avoided. These embodiments are not intended to limit the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

What is claimed is:

1. An automated modular apparatus for storing and dispensing pet food, said apparatus comprising:
a memory stored in non-transitory computer-readable medium, said memory comprising:
system data, said system data comprising one or more of the following:
user information entered into said memory by a user,
controller information measured by a main controller,
connector information measured by a connector system,
module information measured by a connectable module, and
the status of said connectable modules connected to said apparatus;
said main controller, said main controller being capable of accessing and interacting with said memory, including sending and receiving said system data, and comprising:
one or more processors;
said connector system, said connector system being controllable by and optionally capable of communicating with said main controller, including sending and receiving said system data, said connector system being capable of connecting said connectable modules to said controller; and
said connectable modules, said connectable modules being capable of connecting to said connector system in various combinations, or not at all; said connectable modules optionally comprising a module controller, which is controllable by and capable of communicating with said main controller, including sending and receiving said system data; and comprising:
a pet food storage compartment, said pet food storage compartment comprising:
a bin, said bin being capable of storing said pet food; and
an access door, said access door being capable of accessing said bin in order to fill said bin with said pet food;
a food dispensing mechanism, said food dispensing mechanism being controllable by and capable of communicating with said main controller, including sending and receiving said system data, and capable of dispensing said pet food from said pet food storage compartment on demand, by a programmable schedule, or based on said system data;
wherein said system data is used by said apparatus to recommend or control feeding times and amounts or to restrict feeding for a pet.

2. An automated modular apparatus for storing and dispensing pet food, said apparatus comprising:
a memory stored in a non-transitory computer-readable medium, said memory comprising:
system data, said system data comprising one or more of the following:
user information entered into said memory by a user,
controller information measured by a main controller,
connector information measured by a connector system,
module information measured by a connectable module, and
the status of said connectable modules connected to said apparatus;
said main controller, said main controller being capable of accessing and interacting with said memory, including sending and receiving said system data, and comprising:
one or more processors;
a pet food storage compartment, said pet food storage compartment comprising:
a bin, said bin being capable of storing said pet food; and
an access door, said access door being capable of accessing said bin in order to fill said bin with said pet food;
a food dispensing mechanism, said food dispensing mechanism being controllable by and capable of communicating with said main controller, including sending and receiving said system data, and capable of dispensing said pet food from said pet food storage compartment on demand, by a programmable schedule, or based on said system data;
said connector system, said connector system being controllable by and optionally capable of communicating with said main controller, including sending and receiving said system data, said connector system being capable of connecting said connectable modules to said controller; and
said connectable modules, said connectable modules being capable of connecting to said connector system in various combinations, or not at all; said connectable modules optionally comprising a module controller, which is controllable by and capable of communicating with said main controller, including sending and receiving said system data;
wherein said system data is used by said apparatus to recommend or control feeding times and amounts or to restrict feeding for a pet.

3. An apparatus of claim 1 or 2, wherein said apparatus further comprises internet connectivity.

4. An apparatus of claim 1 or 2, wherein said apparatus and said module controller further comprises wireless connectivity.

5. An apparatus of claim 1, wherein said pet food storage compartment is controllable by and capable of communicating with said main controller, including sending and receiving said system data, and further comprises a pet food level sensor, said pet food level sensor being capable of measuring the amount of said pet food in said pet food storage compartment and communicating said amount to said apparatus as said system data.

6. An apparatus of claim 1 or 2, wherein said connectable modules further comprise a feeding bowl, said feeding bowl being capable of receiving said pet food from said food dispensing mechanism, said feeding bowl being controllable by and capable of communicating with said apparatus or said connectable modules, including sending and receiving said system data.

7. An apparatus of claim 1 or 2, wherein said connectable modules further comprise a feeding bowl, said feeding bowl being capable of receiving said pet food from said food dispensing mechanism, said feeding bowl being controllable by and capable of communicating with said apparatus or said connectable modules, including sending and receiving said system data, and comprising:
a lid, said lid being capable of being opened and closed using said main controller on demand, by a programmable schedule, or based on said system data.

8. An apparatus of claim 1 or 2, wherein said connectable modules comprise a feeding bowl, said feeding bowl being capable of receiving said pet food from said food dispensing mechanism, said feeding bowl being controllable by and capable of communicating with said apparatus or said connectable modules, including sending and receiving said system data, and said feeding bowl comprising:
a lid, said lid being capable of being opened and closed using said main controller on demand, by a programmable schedule, or based on said system data; and
a food weight scale, said food weight scale being capable of measuring the weight of said pet food in said feeding bowl.

9. An apparatus of claim 1 or 2, wherein said connectable modules comprise a feeding bowl, said feeding bowl being capable of receiving said pet food from said food dispensing mechanism, said feeding bowl being controllable by and capable of communicating with said apparatus or said connectable modules, including sending and receiving said system data, and said feeding bowl, and said feeding bowl comprising:
a food weight scale, said food weight scale being capable of measuring the weight of said pet food in said feeding bowl.

10. An apparatus of claim 1 or 2, wherein said connectable modules further comprise a light ring, said light ring being controllable by and capable of communicating with said apparatus or said connectable modules, including sending and receiving said system data, and comprising:
an array of LED lights, said array being mounted in a ring around said apparatus;
wherein said LED lights of said array illuminate in a sequence to simulate a spinning effect or pattern, which appears to speed up as a feeding time approaches.

11. An apparatus of claim 1 or 2, wherein said connectable modules further comprise a light ring, said light ring being controllable by and capable of communicating with said apparatus or said connectable modules, including sending and receiving said system data, and comprising:
an array of LED lights, said array being mounted in a ring around said apparatus;
wherein said LED lights of said array comprise a customizable pattern, which changes as said feeding time approaches.

12. An apparatus of claim 1 or 2, wherein said connectable modules further comprise a light fixture, said light fixture being controllable by and capable of communicating with said apparatus or said connectable modules, including sending and receiving said system data, and comprising:
one or more light sources;
wherein said one or more light sources comprise a customizable pattern, which changes as said feeding time approaches.

13. An apparatus of claim 1 or 2, wherein said connectable modules further comprise a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data.

14. An apparatus of claim 1 or 2, wherein said connectable modules further comprise:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
a light ring, said light ring being controllable by and capable of communicating with said apparatus or said connectable modules, including sending and receiving said system data, and comprising:
an array of LED lights, said array being mounted in a ring around said apparatus;
wherein said LED lights of said array illuminate in a sequence to simulate a spinning effect or pattern, which appears to speed up as a feeding time approaches; and
wherein said pattern changes depending on said pet's weight as measured by said pet weight scale.

15. An apparatus of claim 1 or 2, wherein said connectable modules further comprise:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
a light ring, said light ring being controllable by and capable of communicating with said apparatus or said connectable modules, including sending and receiving said system data, and comprising:
an array of LED lights, said array being mounted in a ring around said apparatus;
wherein said LED lights of said array comprise a customizable pattern, which changes as said feeding time approaches; and
wherein said pattern changes depending on said pet's weight as measured by said pet weight scale.

16. An apparatus of claim 1 or 2, wherein said connectable modules further comprise:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
a light fixture, said light fixture being controllable by and capable of communicating with said apparatus or said connectable modules, including sending and receiving said system data, and comprising:
one or more light sources;
wherein said one or more light sources comprise a customizable pattern, which changes as said feeding time approaches; and
wherein said pattern changes depending on said pet's weight as measured by said pet weight scale.

17. An apparatus of claim 1 or 2, wherein said connectable modules further comprise a barrier to prevent other said pets from accessing said apparatus while one said pet is feeding, said barrier comprising:
one or more side walls,
a top cover,
a tunnel, or
an all-around cover, said all-around cover comprising a door.

18. An apparatus of claim 1 or 2, wherein said connectable modules further comprise an LED barrier, said LED barrier being controllable by and capable of communicating with said apparatus or said connectable modules, including sending and receiving said system data, and being capable of displaying customizable ornamentation, decorations, and animations, said LED barrier comprising:
one or more side walls,
a top cover,
a tunnel, or
an all-around cover, said all-around cover comprising a door.

19. An apparatus of claim 1 or 2, wherein said connectable modules further comprise a display screen, said display screen being controllable by and capable of communicating with said apparatus or said connectable modules, including sending and receiving said system data, and being capable of displaying said system data.

20. An apparatus of claim 1 or 2, wherein said connectable modules further comprise an RFID system, said an RFID system being controllable by and capable of communicating with said apparatus or said connectable modules, including sending and receiving said system data, and being capable of communicating identification data to said main controller as said system data, said identification data comprising:
unique identifying information for said pet, said RFID system comprising:
an RFID tag, said RFID tag being capable of being worn by said pet and communicating said identification data to an RFID reader; and
said RFID reader.

21. An apparatus of claim 1 or 2, wherein said connectable modules comprise:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
an RFID system, said an RFID system being controllable by and capable of communicating with said apparatus or said connectable modules, including sending and receiving said system data, and being capable of communicating identification data to said main controller as said system data, said identification data comprising:
unique identifying information for said pet,
said RFID system comprising:
an RFID tag, said RFID tag being capable of being worn by said pet and communicating said identification data to an RFID reader; and
said RFID reader;
wherein said RFID system is capable of being triggered when said pet is weighed by said pet weight scale.

22. An apparatus of claim 1 or 2, wherein said connectable modules further comprise a near field communication system, said near field communication system being controllable by and capable of communicating with said apparatus or said connectable modules, including sending and receiving said system data, and being capable of communicating identification data to said main controller as said system data, said identification data comprising:
unique identifying information for said pet,
said near field communication system comprising:
a near field tag, said near field tag being capable of being worn by said pet and communicating said identification data to a near field reader; and
said near field reader.

23. An apparatus of claim 1 or 2, wherein said connectable modules further comprise:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
a near field communication system, said near field communication system being controllable by and capable of communicating with said apparatus or said connectable modules, including sending and receiving said system data, and being capable of communicating identification data to said main controller as said system data, said identification data comprising:
unique identifying information for said pet,
said near field communication system comprising:
a near field tag, said near field tag being capable of being worn by said pet and communicating said identification data to a near field reader; and
said near field reader;
wherein said near field communication system is capable of being triggered when said pet is weighed by said pet weight scale.

24. An apparatus of claim 1 or 2, wherein said connectable modules further comprise a camera, said camera being controllable by and capable of communicating with said apparatus or said connectable modules, including sending and receiving said system data, and communicating images or video to said main controller as said system data.

25. An apparatus of claim 1 or 2, wherein said connectable modules further comprise a speaker, said speaker being controllable by and capable of communicating with said apparatus or said connectable modules, including sending and receiving said system data, and being capable of generating sounds received from said main controller.

26. An apparatus of claim 1 or 2, wherein said connectable modules further comprise a microphone, said microphone being controllable by and capable of communicating with said apparatus or said connectable modules, including sending and receiving said system data, and communicating detected sounds to said main controller as said system data.

27. An apparatus of claim 1 or 2, said apparatus further comprising a timing system, said timing system being controllable by and capable of communicating with said apparatus, including sending and receiving said system data and providing time data to said main controller as said system data.

28. An apparatus of claim 1 or 2, wherein said connectable modules further comprise an environmental sensor, said environmental sensor being controllable by and capable of communicating with said apparatus or said connectable modules, including sending and receiving said system data, and communicating temperature, humidity, air quality, and/or pressure information to said main controller as said system data.

29. An apparatus of claim 1 or 2, wherein said connectable modules further comprise a generic module, said generic module being controllable by and capable of communicating with said apparatus or said connectable modules.

30. An apparatus of claim 1 or 2, wherein said connectable modules further comprise a generic non-electric module.

31. An apparatus of claim 1 or 2, wherein said connectable modules further comprise a pet detection system, said pet detection system being capable of detecting and identifying said pet, in order to allow or restrict feeding time and amounts for different said pets, said detection system comprising:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
an RFID system, said an RFID system being controllable by and capable of communicating with said apparatus or said connectable modules, including sending and receiving said system data, and being capable of communicating identification data to said main controller as said system data, said identification data comprising:
unique identifying information for said pet,
said RFID system comprising:
an RFID tag, said RFID tag being capable of being worn by said pet and communicating said identification data to an RFID reader; and
said RFID reader;
said RFID system and said pet weight scale, wherein said RFID system is capable of being triggered when said pet is weighed by said pet weight scale;
a near field communication system, said near field communication system being controllable by and capable of communicating with said apparatus or said connectable modules, including sending and receiving said system data, and being capable of communicating identification data to said main controller as said system data, said identification data comprising:
unique identifying information for said pet,
said near field communication system comprising:
a near field tag, said near field tag being capable of being worn by said pet and communicating said identification data to a near field reader; and said near field reader;
said near field communication system and said pet weight scale, wherein said near field communication system is capable of being triggered when said pet is weighed by said pet weight scale;
a camera, said camera being controllable by and capable of communicating with said apparatus or said connectable modules, including sending and receiving said system data, and communicating images or video to said main controller as said system data; or
a microphone, said microphone being controllable by and capable of communicating with said apparatus or said connectable modules, including sending and receiving said system data, and communicating detected sounds to said main controller as said system data.

32. An apparatus of claim 1 or 2, wherein said connectable modules further comprise a light ring, said light ring being controllable by and capable of communicating with said apparatus or said connectable modules, including sending and receiving said system data, and comprising:
an array of LED lights, said array being mounted in a ring around said apparatus;
wherein said LED lights of said array illuminate in a sequence to simulate a spinning effect or pattern, which appears to speed up as a feeding time approaches; and
wherein said pattern changes depending on which said pet approaches said apparatus, or on which said pet is detected by a pet detection system in a multi-pet household, said pet detection system being capable of detecting and identifying said pet, in order to allow or restrict feeding time and amounts for different said pets, said detection system comprising:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
an RFID system, said an RFID system being controllable by and capable of communicating with said apparatus or said connectable modules, including sending and receiving said system data, and being capable of communicating identification data to said main controller as said system data, said identification data comprising:
unique identifying information for said pet,
said RFID system comprising:
an RFID tag, said RFID tag being capable of being worn by said pet and communicating said identification data to an RFID reader; and
said RFID reader;
said RFID system and said pet weight scale, wherein said RFID system is capable of being triggered when said pet is weighed by said pet weight scale;
a near field communication system, said near field communication system being controllable by and capable of communicating with said apparatus or said connectable modules, including sending and receiving said system data, and being capable of communicating identification data to said main controller as said system data, said identification data comprising:
unique identifying information for said pet,
said near field communication system comprising:
a near field tag, said near field tag being capable of being worn by said pet and communicating said identification data to a near field reader; and
said near field reader;
said near field communication system and said pet weight scale, wherein said near field communication system is capable of being triggered when said pet is weighed by said pet weight scale;
a camera, said camera being controllable by and capable of communicating with said apparatus or said connectable modules, including sending and receiving said system data, and communicating images or video to said main controller as said system data; or
a microphone, said microphone being controllable by and capable of communicating with said apparatus or said connectable modules, including sending and receiving said system data, and communicating detected sounds to said main controller as said system data.

33. An apparatus of claim 1 or 2, wherein said connectable modules further comprise a light ring, said light ring being controllable by and capable of communicating with said apparatus or said connectable modules, including sending and receiving said system data, and comprising:
an array of LED lights, said array being mounted in a ring around said apparatus;
wherein said LED lights of said array comprise a customizable pattern, which changes as said feeding time approaches; and
wherein said pattern changes depending on which said pet approaches said apparatus, or on which said pet is detected by a pet detection system in a multi-pet household, said pet detection system being capable of detecting and identifying said pet, in order to allow or restrict feeding time and amounts for different said pets, said detection system comprising:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
an RFID system, said an RFID system being controllable by and capable of communicating with said apparatus or said connectable modules, including sending and receiving said system data, and being capable of communicating identification data to said main controller as said system data, said identification data comprising:
unique identifying information for said pet,
said RFID system comprising:
an RFID tag, said RFID tag being capable of being worn by said pet and communicating said identification data to an RFID reader; and
said RFID reader;
said RFID system and said pet weight scale, wherein said RFID system is capable of being triggered when said pet is weighed by said pet weight scale;
a near field communication system, said near field communication system being controllable by and capable of communicating with said apparatus or said connectable modules, including sending and receiving said system data, and being capable of communicating identification data to said main controller as said system data, said identification data comprising:
unique identifying information for said pet,
said near field communication system comprising:
a near field tag, said near field tag being capable of being worn by said pet and communicating said identification data to a near field reader; and
said near field reader;
said near field communication system and said pet weight scale, wherein said near field communication system is capable of being triggered when said pet is weighed by said pet weight scale;
a camera, said camera being controllable by and capable of communicating with said apparatus or said connectable modules, including sending and receiving said system data, and communicating images or video to said main controller as said system data; or
a microphone, said microphone being controllable by and capable of communicating with said apparatus or said connectable modules, including sending and receiving said system data, and communicating detected sounds to said main controller as said system data.

34. An apparatus of claim 1 or 2, wherein said connectable modules further comprise a light fixture, said light fixture being controllable by and capable of communicating with said apparatus or said connectable modules, including sending and receiving said system data, and comprising:
one or more light sources;
wherein said one or more light sources comprise a customizable pattern, which changes as said feeding time approaches; and
wherein said pattern changes depending on which said pet approaches said apparatus, or on which said pet is detected by a pet detection system in a multi-pet household, said pet detection system being capable of detecting and identifying said pet, in order to allow or restrict feeding time and amounts for different said pets, said detection system comprising:
a pet weight scale, said pet weight scale being controllable by and capable of communicating with said apparatus or said connectable modules, including sending and receiving said system data, and being capable of weighing said pet's weight while said pet resides on said pet weight scale and communicating said pet's weight to said main controller as said system data;
an RFID system, said an RFID system being controllable by and capable of communicating with said apparatus or said connectable modules, including sending and receiving said system data, and being capable of communicating identification data to said main controller as said system data, said identification data comprising:
unique identifying information for said pet,
said RFID system comprising:
an RFID tag, said RFID tag being capable of being worn by said pet and communicating said identification data to an RFID reader; and
said RFID reader;
said RFID system and said pet weight scale, wherein said RFID system is capable of being triggered when said pet is weighed by said pet weight scale;
a near field communication system, said near field communication system being controllable by and capable of communicating with said apparatus or said connectable modules, including sending and receiving said system data, and being capable of communicating identification data to said main controller as said system data, said identification data comprising:
unique identifying information for said pet,
said near field communication system comprising:
a near field tag, said near field tag being capable of being worn by said pet and communicating said identification data to a near field reader; and
said near field reader;
said near field communication system and said pet weight scale, wherein said near field communication system is capable of being triggered when said pet is weighed by said pet weight scale;
a camera, said camera being controllable by and capable of communicating with said apparatus or said connectable modules, including sending and receiving said system data, and communicating images or video to said main controller as said system data; or
a microphone, said microphone being controllable by and capable of communicating with said apparatus or said connectable modules, including sending and receiving said system data, and communicating detected sounds to said main controller as said system data.

35. An apparatus of claim 1 or 2, wherein said apparatus further comprises a predictive maintenance system, said predictive maintenance system being controllable by and capable of communicating with said apparatus and said connectable modules, including sending and receiving said system data, and being capable of monitoring said system data, wherein said predictive maintenance system uses said system data for a prediction of when said apparatus, or portion thereof, or said connectable modules, need maintenance or replacement and communicates said prediction to said user.

36. An apparatus of claim 1 or 2, wherein said apparatus further comprises:
a predictive maintenance system, said predictive maintenance system being controllable by and capable of communicating with said apparatus and said connectable modules, including sending and receiving said system data, and being capable of monitoring said system data;
wherein said predictive maintenance system uses said system data for a prediction of when said apparatus, or portion thereof, or said connectable modules, need maintenance or replacement and communicates said prediction to said user; and
wherein said prediction is communicated to a web site or app.

37. An apparatus of claim 1 or 2, wherein said connectable modules further comprise:
a predictive maintenance system, said predictive maintenance system being controllable by and capable of communicating with said apparatus and said connectable modules, including sending and receiving said system data, and being capable of monitoring said system data, wherein said predictive maintenance system uses said system data for a prediction of when said apparatus, or portion thereof, or said connectable modules, need maintenance or replacement and communicates said prediction to said user; and
an ordering module, said ordering module being capable of ordering said pet food, said connectable modules, or a part of said apparatus, based on said prediction, and communicating said ordering to said main controller as said system data.

38. An apparatus of claim 1 or 2, wherein said connectable modules further comprise:
a predictive maintenance system, said predictive maintenance system being controllable by and capable of communicating with said apparatus and said connectable modules, including sending and receiving said system data, and being capable of monitoring said system data, wherein said predictive maintenance system uses said system data for a prediction of when said apparatus, or portion thereof, or said connectable modules, need maintenance or replacement and communicates said prediction to said user; and
an ordering module, said ordering module being capable of ordering said pet food, said connectable modules, or a part of said apparatus, based on said prediction, and communicating said ordering to said main controller as said system data;
wherein said ordering occurs using computing resources external to said apparatus.

39. A predictive maintenance system for a plurality of apparatuses of claim 1 or 2, said predictive maintenance system comprising:
a server, said server being capable of communicating with said plurality and said connectable modules, including sending and receiving said system data, and being capable of monitoring said system data;
wherein said predictive maintenance system:
compares said system data of said plurality, or portion thereof, or said connectable modules; and
predicts which of said plurality, or portion thereof, or said connectable modules, need maintenance or replacement.

40. An apparatus for storing and dispensing pet food, said apparatus comprising:
a memory stored in non-transitory computer-readable medium, said memory comprising:
system data, said system data comprising:
information entered into said memory by a user and/or stored in said memory, and;
a controller, said controller being capable of accessing and interacting with said memory, and comprising:
one or more processors;
a pet food storage compartment, said pet food storage compartment comprising:
a bin, said bin being capable of storing said pet food; and
an access door, said access door being capable of accessing said bin in order to fill said bin with said pet food;
a food dispensing mechanism, said food dispensing mechanism being controllable by and capable of communicating with said main controller, including sending and receiving said system data, and capable of dispensing said pet food from said pet food storage compartment on demand or by a programmable schedule, or based on said system data; and
a light ring, said light ring being controllable by and capable of communicating with said controller, and comprising:
an array of LED lights, said array being mounted in a ring around said apparatus;
wherein said system data is used by said apparatus to recommend or control feeding times and amounts or to restrict feeding for a pet.

41. An apparatus of claim 40, wherein said LED lights of said array illuminate in a sequence to simulate a spinning effect or pattern, which appears to speed up as a feeding time approaches.

42. An apparatus of claim 40, wherein said LED lights of said array comprise a customizable pattern, which changes as said feeding time approaches.
